(19) United States
(12) Patent Application Publication
(10) Pub. No.: US 2018/0318763 A1
(43) Pub. Date: Nov. 8, 2018

(54) Compositions for Passive NOx Adsorption PNA Systems and Methods of Making and Using Same

(71) Applicant: Umicore AG & Co. KG, Hanau-Wolfgang (DE)

(72) Inventors: Maximilian A. Biberger, Scottsdale, AZ (US); Bryant Kearl, Phoenix, AZ (US); Qinghua Yin, Tempe, AZ (US); Xiwang Qi, Scottsdale, AZ (US)

(21) Appl. No.: 15/770,267

(22) PCT Filed: Oct. 28, 2016
(86) PCT No.: PCT/US16/59540

§ 371 Date: Apr. 23, 2018

Related U.S. Application Data
(60) Provisional application No. 62/249,141, filed on Oct. 30, 2015.

(51) Int. Cl. B01D 53/94; B01J 20/18; F01N 3/08

(52) U.S. Cl. CPC B01D 53/9422; B01J 20/18; F01N 3/0814; B01D 2255/91; B01D 2255/1021; B01D 2255/1023; B01D 2255/2065; F01N 3/0842

(57) ABSTRACT

The present disclosure relates to a substrate containing passive NOₓ adsorption (PNA) materials for treatment of gases, and washcoats for use in preparing such a substrate. Also provided are methods of preparation of the PNA materials, as well as methods of preparation of the substrate containing the PNA materials. More specifically, the present disclosure relates to a coated substrate containing PNA materials for PNA systems, useful in the treatment of exhaust gases. Also disclosed are exhaust treatment systems, and vehicles, such as diesel or gasoline vehicles, particularly light-duty diesel or gasoline vehicles, using catalytic converters and exhaust treatment systems using the coated substrates.

### CROSS-REFERENCE TO RELATED APPLICATIONS

This application claims priority benefit of U.S. Provisional Patent Application No. 62/249,141, filed Oct. 30, 2015. The entire contents of that application are hereby incorporated by reference herein.

### FIELD OF THE INVENTION

The present disclosure relates to the field of catalysts. More specifically, the present disclosure relates to nanoparticle catalysts and storage materials for nitrogen oxides as part of a passive NOₓ adsorption (PNA) system for engines and vehicles.

### BACKGROUND OF THE INVENTION

Car exhaust primarily contains harmful gases such as carbon monoxide (CO), nitrogen oxides (NOₓ), and hydrocarbons (HC). Environmental concerns and government regulations have led efforts to remove these noxious combustion products from vehicle exhaust by conversion to more benign gases such as carbon dioxide (CO₂), nitrogen (N₂), and water (H₂O). In order to accomplish this conversion, the exhaust gases must pass through a treatment system that contains materials that can oxidize CO to CO₂, reduce NOₓ to N₂ and H₂O, and oxidize hydrocarbons to CO₂ and H₂O.

Emission regulations and standards are becoming more and more stringent worldwide, especially for NOₓ emissions. Two competing exhaust technologies to reduce the amount of NOₓ released into the atmosphere are Lean NOₓ Traps (LNT) and Selective Catalytic Reduction (SCR). LNTs absorb, store, or trap nitrogen oxides during lean-burn engine operation (i.e., when excess oxygen is present), and release and convert these gases when the oxygen content in the exhaust gas is reduced. An example of an LNT system can be found in International Patent Application WO2015/061482 and U.S. Provisional Application 61/894,346, which are hereby incorporated by reference in their entirety. On the other hand, SCR units reduce nitrogen oxides regardless of the amount of oxygen in the exhaust gas. However, SCR units cannot properly reduce NOₓ emissions at low operating temperatures, for example, temperatures below 200° C.

Unfortunately, a significant portion of pollutant gases emitted by internal combustion engines are produced when the engine is initially started (“cold-start”), but before the catalytic converters, LNTs, or SCR units in the emissions system have warmed up to their operating temperatures. In order to reduce harmful emissions during the cold-start phase, such as that of a light-duty diesel or gasoline vehicle (for example, an automobile or light truck), washcoats that contain temporary storage for pollutants can be used to coat the substrate used in the catalytic converter of the vehicle. After the catalytic converter heats up to its operating temperature, known as the light-off temperature (the temperature at which the conversion rate reaches 50% of the maximum rate), the stored gases are released and subsequently decomposed by the catalytic converter.

A high light-off temperature is undesirable, as many vehicular trips are of short duration, and during the time required for the catalytic converter to reach its operating temperature, pollutants must either be released untreated to the environment, or stored in the exhaust system until the light-off temperature is reached. Even if pollutants are trapped effectively prior to light-off, the catalytic converter may not reach operating temperature if multiple successive short trips are made. Thus, the washcoats used for storage may become saturated, resulting once again in the release of pollutants to the environment.

In addition, the exhaust temperature of an engine or vehicle can vary depending on the type of engine or vehicle. Thus, the operating temperature of the catalytic material or the operating temperature of the SCR unit can vary depending on the engine and vehicle. For example, large engines (e.g., greater than 2.5 Liters) typically run colder than small engines (e.g., less than 2 Liters). Accordingly a tunable material used for storage of pollutants, where the release temperature can be adjusted or tuned up or down to accommodate varying operating temperatures in engines or vehicles, is desirable.

Commercially available catalytic converters use platinum group metal (PGM) catalysts deposited on substrates by wet chemistry methods, such as precipitation of platinum ions, palladium ions, or platinum and palladium ions from solution onto a substrate. These PGM catalysts are a considerable portion of the cost of catalytic converters. Thus, any reduction in the amount of PGM catalysts used to produce a catalytic converter is desirable. Commercially available catalytic converters also display a phenomenon known as “aging.” in which they become less effective over time; the light-off temperature starts to rise as the catalytic converter ages, and emission levels also start to rise. Accordingly, reduction of the aging effect is also desirable, in order to prolong the efficacy of the catalytic converter for controlling emissions.

### SUMMARY OF THE INVENTION

Described herein are coated substrates for use as Passive NOₓ Absorbers (PNAs), washcoat formulations for preparing coated substrates for use as PNAs, methods for preparing coated substrates for use as PNAs, and systems incorporating coated substrates employed as PNAs in an emission-control system. The disclosed PNAs can adsorb NOₓ emissions at low start-up temperatures, and can release the adsorbed NOₓ at efficient operating temperatures (for example, at or above light-off temperature) and under lean conditions.

In addition, the disclosed PNAs can reduce the amount of platinum group metals used in catalytic converters. At lower temperatures (temperatures where the T₅₀ of NOₓ has not yet been reached), NOₓ emissions can block the oxidation of carbon monoxide and hydrocarbons. Thus, storing NOₓ emissions at lower temperatures and releasing them at higher temperatures (such as temperatures above the T₅₀ temperature of NOₓ), can decrease the amount of PGMs needed to oxidize car exhaust pollutants.

Furthermore, the PNA materials disclosed may also be able to store as many NOₓ emissions as possible at temperatures from ambient up to a maximum variable temperature. The maximum variable temperature can change depending on the type of engine and vehicle employed. Thus, the disclosed PNA materials can be tunable to store NOₓ emissions in some instance only up to about 100° C., in some cases up to about 150° C., and in some cases up to about 200° C. or higher. Regardless of the maximum variable temperature, the PNA materials can exhibit a “sharp” release temperature slightly above the maximum variable temperature.

In some embodiments, the Passive NOₓ Adsorber (PNA) composition (i.e., material) comprises nano-sized platinum group metal (PGM) on a plurality of support particles comprising cerium oxide. The plurality of support particles can be micron-sized and/or nano-sized. The plurality of support particles can include zirconium oxide, lanthanum oxide, yttrium oxide, or a combination thereof. Also, the support particles can be HSA5, HSA20, or a mixture thereof. The nano-sized PGM on the plurality of support particles can be produced by wet chemistry techniques and/or incipient wetness, followed by calcination. The nano-sized PGM on the plurality of support particles can comprise composite nano-particles that comprise a support nanoparticle and a PGM nanoparticle. These composite nanoparticles can be bonded to micron-sized carrier particles to form nano-on-nano-on micro particles and/or the composite nanoparticles can be embedded within carrier particles to form nano-on-nano-in-micro particles. The carrier particles can comprise cerium oxide, zirconium oxide, lanthanum oxide, yttrium oxide, or a combination thereof. The carrier particles can comprise 86 wt. % cerium oxide, 10 wt. % zirconium oxide, and 4 wt. % lanthanum oxide. Furthermore, the composite nano-particles can be plasma created. The PGM in the PNA material can include palladium and/or ruthenium. The PNA material can include 2 g/L to 4 g/L palladium including 3 g/L palladium. The PNA material can include 3 g/L to 15 g/L ruthenium and 5 g/L to 6 g/L ruthenium. The PNA material can include greater than or equal to about 150 g/L of the plurality of support particles or greater than or equal to about 300 g/L of the plurality of support particles.

In some embodiments, a coated substrate comprises a substrate and a Passive NOₓ Adsorber (“PNA”) layer comprising a PNA material. The variations described above for the previously described PNA material are also applicable to the PNA material recited in this coated substrate. The PNA layer can store NOₓ gas up to at least a first temperature and release the stored NOₓ gas at or above the first temperature. The first temperature can be 150° C. or 300° C. The coated substrate can be used in a greater than or equal to 2.5 L engine system or a less than or equal to 2.5 L engine system. The PNA layer can further include boehmite particles. The PNA material (including the nano-sized PGM on the plurality of support particles) can comprise 95% to 98% by weight of the mixture of the PNA material and boehmite particles in the PNA layer. The boehmite particles can include 2% to 5% by weight of the mixture of the PNA material and the boehmite particles in the PNA layer. The substrate can comprise cordierite and/or a honeycomb structure. The coated substrate can also include a corner-fill layer deposited directly on the substrate. The PNA layer can include 2 g/L to 4 g/L palladium including 3 g/L palladium. The PNA layer can include 3 g/L to 15 g/L ruthenium and 5 g/L to 6 g/L ruthenium. The PNA layer can include greater than or equal to about 150 g/L of the plurality of support particles or greater than or equal to about 300 g/L of the plurality of support particles.

In some embodiments, a washcoat composition comprises a solids content of 95% to 98% by weight PNA material and 2% to 5% by weight boehmite particles. The variations described above for the previously described PNA material are also applicable to the PNA material recited in this washcoat composition. The solids of the wash coat composition can be suspended in an aqueous medium at a pH between 3 and 5. The washcoat composition can include 2 g/L to 4 g/L palladium including 3 g/L palladium. The washcoat composition can include 3 g/L to 15 g/L ruthenium and 5 g/L to 6 g/L ruthenium. The washcoat composition can include greater than or equal to about 150 g/L of the plurality of support particles or greater than or equal to about 300 g/L of the plurality of support particles.

In some embodiments, a method of treating an exhaust gas comprises contacting a coated substrate with an exhaust gas comprising NOx emissions, wherein the coated substrate comprises a substrate and a PNA layer. The variations described above for the previously described coated substrates, PNA materials, and PNA layer are also applicable to the method of treating an exhaust gas.

In some embodiments, a method of forming a coated substrate comprises coating the substrate with a washcoat composition comprising a PNA material. The variations described above for the previously described coated substrates, PNA materials, PNA layer, and washcoat compositions are also applicable to the method of forming a coated substrate. The method of forming a coated substrate can include coating the substrate with a corner-fill washcoat prior to coating the substrate with the PNA washcoat.

In some embodiments, a catalytic converter comprises a coated substrate comprising a PNA layer comprising a PNA material. The variations described above for the previously described coated substrates, PNA materials, and PNA layers are also applicable to the method of forming a coated substrate.

In some embodiments, a vehicle comprises a catalytic converter comprising a PNA layer comprising a PNA material, wherein the vehicle complies with the European emission standard Euro 5. The variations described above for the previously described catalytic converter, PNA materials, and PNA layers are also applicable to the vehicle. The vehicle can include an SCR unit downstream the catalytic converter. Also, the vehicle can include an LNT.

In some embodiments, an exhaust treatment system comprises a conduit for exhaust gas comprising NOₓ emissions and a catalytic converter comprising a coated substrate comprising a PNA layer comprising a PNA material. The variations described above for the previously described coated substrates, PNA materials, and PNA layers are also applicable to the method of forming a coated substrate. The exhaust treatment system can include an SCR unit downstream the catalytic converter. Also, the vehicle can include an LNT. Furthermore, the exhaust treatment system can comply with European emission standard Euro 5 and Euro 6.

In the disclosed embodiments, when a layer (layer Y) is said to be formed “on top of” another layer (layer X), either no additional layers, or any number of additional layers (layer(s) A, B, C, etc.) can be formed between the two layers X and Y. For example, if layer Y is said to be formed on top of layer X, this can refer to a situation where layer X can be formed, then layer A can be formed immediately atop layer X, then layer B can be formed immediately atop layer A, then layer Y can be formed immediately atop layer B. Alternatively, if layer Y is said to be formed on top of layer X, this can refer to a situation where layer Y can be deposited directly on top of layer X with no intervening layers between X and Y. For the specific situation where no intervening layers are present between layer X and layer Y, layer Y is said to be formed immediately atop layer X, or equivalently, layer Y is said to be formed directly on top of layer X.

In some embodiments, a method of treating an exhaust gas comprises contacting the coated substrate according to any one of the disclosed or foregoing embodiments of the coated substrate with the exhaust gas. In some embodiments, a method of treating an exhaust gas comprises contacting the coated substrate according to any one of the disclosed or foregoing embodiments of the coated substrate with the exhaust gas, wherein the substrate is housed within a catalytic converter configured to receive the exhaust gas.

In some embodiments, a coated substrate comprises a washcoat according to any of the disclosed embodiments of the washcoat compositions.

In some embodiments, a catalytic converter comprises a coated substrate according to any one of the disclosed or foregoing embodiments of the coated substrate. In some embodiments, an exhaust treatment system comprises a conduit for exhaust gas and a catalytic converter according to any one of the disclosed or foregoing embodiments of the catalytic converter. In some embodiments, a vehicle comprises a catalytic converter according to any one of the disclosed or foregoing embodiments of the catalytic converter. In any of the disclosed embodiments, including the foregoing, the vehicle can comply with European emission standard Euro 5. In any of the disclosed embodiments, including the foregoing, the vehicle can comply with European emission standard Euro 6. In any of the disclosed or foregoing embodiments the vehicle can be a diesel vehicle, a gasoline vehicle, a light-duty diesel vehicle, or a light-duty gasoline vehicle.

It is understood that aspects and embodiments of the invention described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

The systems, compositions, substrates, and methods described herein, including any embodiment of the invention as described herein, may be used alone or may be used in combination with other systems, compositions, substrates, and methods.

### BRIEF DESCRIPTION OF THE DRAWINGS

FIG. 1 illustrates a catalytic converter in accordance with some embodiments of the present disclosure.

FIG. 1A is a magnified view of a portion of the drawing of FIG. 1 in accordance with some embodiments of the present disclosure.

FIG. 2 is a flow chart illustrating a preparation method of a coated substrate containing catalytic particles, zeolites, and PNA material contained in separate washcoat layers, in accordance with some embodiments of the present disclosure.

FIG. 3 is a flow chart illustrating a preparation method of a coated substrate containing catalytic particles contained in a washcoat layers, and the zeolites and PNA material contained in a single washcoat layer, in accordance with some embodiments of the present disclosure.

FIG. 4 shows a single rectangular channel in a coated substrate prepared according to one embodiment of the present disclosure.

FIG. 5 is a graph demonstrating the NOₓ emission adsorption and release for manganese based PNA material across an operating temperature spectrum.

FIG. 6 is a graph demonstrating the NOₓ emission adsorption and release for magnesium based PNA material across an operating temperature spectrum.

FIG. 7 is a graph demonstrating the NOₓ emission adsorption and release for calcium based PNA material across an operating temperature spectrum.

FIG. 8 is a graph demonstrating NOₓ emission storage comparison performance of a catalytic converter employing PNA material as described herein to a commercially available catalytic converter.

FIG. 9 is a graph demonstrating tailpipe emission comparison performance of a catalytic converter employing PNA material as described herein to a commercially available catalytic converter.

### DETAILED DESCRIPTION OF THE INVENTION

Described are PNA systems and methods of making PNA systems which can include combining washcoat layers of catalytic particles, zeolites, and PNA materials. Also described are composite nanoparticle catalysts, washcoat formulations, coated substrates, catalytic converters, and methods of making and using these composite nanoparticle catalysts, washcoat formulations, coated substrates, and catalytic converters. The described PNA systems may use a reduced amount of precious metal relative to typical catalytic converter systems including light duty diesel systems. Accordingly, these PNA systems may provide a more economical alternative to commercially available systems.

Furthermore, the PNA materials may be able to store NOₓ emissions at temperatures from ambient to about 100° C., 150° C., 200° C., 250° C., or 300° C., for example. The PNA materials may exhibit a “sharp” release temperature under lean conditions (i.e., releases all of the stored NOₓ emissions at slightly above about 100° C., 150° C., 200° C., 250° C., or 300° C., for example). High release temperatures and/or long release “tails” are not desirable because these high temperatures may not be reached prior to the engine being turned off. Thus, all the initially adsorbed NOₓ emissions may not be released from the PNA materials before the engine is running again, therefore prohibiting adsorption repeatability in the PNA materials. In addition, the PNA material may be cost efficient, may be able to handle sulfur rich fuels (i.e., can be sulfurized and de-sulfurized), and can be introduced independently to the oxidation material.

The PNA materials may also be able to store NOₓ emissions at temperatures from ambient up to a maximum variable temperature. The maximum variable temperature can change depending on the type of engine and vehicle employed. Thus, the disclosed PNA materials can be tunable to store NOₓ emissions in some instance only up to about 100° C. in some cases up to about 150° C., in some cases up to about 200° C., and in some cases up to about 300° C. Regardless of the maximum variable temperature, the PNA materials may exhibit a “sharp” release temperature slightly above the maximum variable temperature.

In addition, the described substrates, composite nanoparticle catalysts, and washcoat solutions may provide for comparable or increased performance relative to prior PNA systems when used to produce catalytic converters, allowing for the production of catalytic converters having reduced light-off temperatures and reduced emissions using reduced platinum group metal loading requirements. The described coated substrates include washcoat layers in which the PNA material can be composed entirely of non-PGMs, or a combination of PGM and non-PGM. These coated substrates can be used to make an effective catalytic converter in a more economical fashion than has been previously possible.

Catalytic materials described herein can be formed prior to formulating a washcoat composition or the component parts of the catalytic materials described herein can be combined to formulate the washcoat composition. That is, in some embodiments, the materials are provided as “loose ingredients,” wherein the material components are separately provided.

As used herein, the term “loose ingredient” materials refers to separately provided catalytic material components. In some embodiments, however, a portion of the “loose ingredient” materials may become attached or deposited, for example after mixing or calcining a washcoat composition. In some embodiments, for example, catalytic components may attach to other catalytic particles or support particles.

The catalytic washcoat composition can comprise catalytic components as “loose ingredients.” For example, in some embodiments, a catalytic washcoat composition comprises composite nanoparticles (such as oxidative composite nanoparticles) and aluminum oxide support particles, wherein the composite nanoparticles are not attached to the aluminum oxide support particles. In some embodiments, the catalytic washcoat composition further comprises boehmite or thickeners. The oxidative composite nanoparticles generally comprise an oxidative nanoparticle (which comprises PGM, such as platinum, palladium, or a mixture of platinum and palladium) and a support nanoparticle (such as an aluminum oxide nanoparticle). In some embodiments, the oxidative composite nanoparticle is formed, for example, using a plasma process.

The catalytic layers of the coated substrates can be formed using either “loose ingredient” washcoat formulations or washcoat formulations comprising NNm or NNiM particles, as described herein. However, the loose ingredient formulation provides significant benefits in producing the washcoat formulations and coated substrates formed therefrom. In washcoats utilizing NNm or NNiM particles, the NNm particles or NNiM particles are separately prepared prior to formulating the washcoat. For example, in producing a washcoat comprising NNm particles, composite nanoparticles are added to micron-sized particles by incipient wetness, dried, and calcined prior to being suspended and formulating the washcoat. In contrast, it has now been discovered that the micron-sized particle and the composite nanoparticles can be provided directly to the washcoat formulation without the added steps of drying and calcining the particles prior to formulating the washcoat. By skipping these steps, the manufacturing process utilizing the loose ingredient formulations is simplified, increasing scale-up capacity, limits the risk of lost materials, and lowers cost relative to previous washcoat formulations.

The composite nanoparticles described herein include catalytic nanoparticles and support nanoparticles that are bonded together to form nano-on-nano composite nanoparticles. The composite nanoparticles may be produced, for example, in a plasma reactor so that consistent and tightly bonded nano-on-nano composite particles are produced. In some embodiments, these composite nanoparticles are included in the washcoat compositions, for example as a component of the “loose ingredient” formulations. In some embodiments, these composite nanoparticles are bonded to a micron-sized carrier particle to form micron-sized catalytic particles (“nano-on-nano-on-micro” particles or NNm particles). The nano-on-nano composite particles are predominantly located at or near the surface of the resulting micron-sized particles. Alternatively, in some embodiments, the composite nanoparticles can be embedded within a porous carrier to produce micron-sized catalytic particles (“nano-on-nano-in-micro” particles or NNiM particles). In this configuration, the nano-on-nano composite nanoparticles are distributed throughout the micron-sized carrier particles. In addition, hybrid NNm/wet-chemistry particles can be formed. Use of the composite nanoparticles in a loose ingredient, NNm, NNiM, or hybrid NNm/wet-chemistry particles offers better initial engine start-up performance, better performance over the lifetime of the catalyst and/or NOₓ storage material, and/or less decrease in performance over the life of the catalyst and/or NOₓ storage material, as compared to previous catalysts and NOₓ storage materials used in catalytic converters.

Further, the washcoat formulations may be formulated in order to provide one or more layers on a catalyst substrate, such as a catalytic converter substrate. In some embodiments, the washcoat formulations may form two or more layers in which catalytic material, such as micron-sized catalytic particles bearing composite nano particles, are in a separate layer than a layer containing the PNA material. One embodiment, for example, is a multi-layer washcoat in which a first washcoat layer includes the PNA material and a second, distinct washcoat layer includes a catalytic material (i.e., oxidative and/or reductive material). The layer with the PNA material may include no catalytic material, and the second layer with the catalytic material may include no PNA material. The order and placement of these two layers on a substrate may be changed in different embodiments and, in further embodiments, additional washcoat formulations/layers may also be used over, under, or between the washcoats, for example, a corner-fill washcoat layer which is initially deposited on the substrate to be coated or a washcoat layer containing zeolites which is deposited on the PNA washcoat layer. In other embodiments, the two layers can be directly disposed on each other, that is, there are no intervening layers between the first and second washcoat layers. The described washcoat formulations may include a lower amount of platinum group metals. In addition, the described washcoat may offer better performance when compared to previous washcoat formulations, particularly when these washcoat formulations utilize the micron-sized particles bearing composite nano-particles.

The coated substrates, catalytic converters, and exhaust treatment systems described herein are useful for vehicles employing a selective catalytic reduction (SCR) system, a lean NOₓ trap (LNT) system, or other NOₓ storage catalyst (NSC) system. It is understood that the coated substrates described herein, catalytic converters using the coated substrates described herein, and exhaust treatment systems using the coated substrates described herein useful for either gasoline or diesel engines, and either gasoline or diesel vehicles. These coated substrates, catalytic converters, and exhaust treatment systems are especially useful for light-duty engines and light-duty vehicles, including but not limited to light-duty diesel vehicles.

Various aspects of the disclosure can be described through the use of flowcharts. Often, a single instance of an aspect of the present disclosure is shown. As is appreciated by those of ordinary skill in the art, however, the protocols, processes, and procedures described herein can be repeated continuously or as often as necessary to satisfy the needs described herein. In addition, it is contemplated that certain method steps can be performed in alternative sequences to those disclosed in the flowcharts.

When numerical values are expressed herein using the term “about” or the term “approximately” or the symbol “˜,” it is understood that both the value specified, as well as values reasonably close to the value specified, are included. For example, the description “50° C.” or “approximately 50° C.” or “˜50° C.” includes both the disclosure of 50° C. itself, as well as values close to 50° C. Thus, the phrases “about X” or “approximately X” or “˜X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

As used herein, the term “embedded” when describing nanoparticles embedded in a porous carrier includes the term “bridged together by” when describing nanoparticles bridged together by a porous carrier, and refers to the configuration of the nanoparticles in the porous carrier resulting when the porous carrier is formed around or surrounds the nanoparticles, generally by using the methods described herein. That is, the resulting structure contains nanoparticles with a scaffolding of porous carrier between the nanoparticles, for example built up around or surrounding the nanoparticles. The porous carrier encompasses the nanoparticles, while at the same time, by virtue of its porosity, the porous carrier permits external gases to contact the embedded nanoparticles. Nanoparticles “embedded” within a porous carrier may include a configuration wherein nanoparticles are connected together (i.e., bridged together) by a carrier material.

It is generally understood by one of skill in the art that the unit of measure “g/l” or “grams per liter” is used as a measure of density of a substance in terms of the mass of the substance in any given volume containing that substance. In some embodiments, the “g/l” is used to refer to the loading density of a substance into, for example, a coated substrate. In some embodiments, the “g/l” is used to refer to the loading density of a substance into, for example, a layer of a coated substrate. In some embodiments, the “g/l” is used to refer to the loading density of a substance into, for example, a washcoat composition. The loading density of a substance into a layer of a coated substrate can be different then the loading density of a substance into the coated substrate. For example, if a PNA layer on the substrate is loaded with 4 g/l PGM but the layer only covers half of the substrate, then the loading density of PGM on the substrate would be 2 g/l.

By “substantial absence of any platinum group metals” is meant that less than about 5%, less than about 2%, less than about 1%, less than about 0.5%, less than about 0.1%, less than about 0.05%, less than about 0.025%, or less than about 0.01% of platinum group metals are present by weight. Preferably, substantial absence of any platinum group metals indicates that less than about 1% of platinum group metals are present by weight.

By “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

It should be noted that, during fabrication or during operation (particularly over long periods of time), small amounts of materials present in one washcoat layer may diffuse, migrate, or otherwise move into other washcoat layers. Accordingly, use of the terms “substantial absence of” and “substantially free of” is not to be construed as absolutely excluding minor amounts of the materials referenced.

By “substantially each” of a specific component, a specific composition, a specific compound, or a specific ingredient in various embodiments, is meant that at least about 95%, at least about 98%, at least about 99%, at least about 99.5%, at least about 99.9%, at least about 99.95%, at least about 99.975%, or at least about 99.99% of the specific component, the specific composition, the specific compound, or the specific ingredient is present by number or by weight. Preferably, “substantially each” of a specific component, a specific composition, a specific compound, or a specific ingredient is meant that at least about 99% of the specific component, the specific composition, the specific compound, or the specific ingredient is present by number or by weight.

This disclosure provides several embodiments. It is contemplated that any features from any embodiment can be combined with any features from any other embodiment. In this fashion, hybrid configurations of the disclosed features are within the scope of the present invention.

It is understood that reference to relative weight percentages in a composition assumes that the combined total weight percentages of all components in the composition add up to 100. It is further understood that relative weight percentages of one or more components may be adjusted upwards or downwards such that the weight percent of the components in the composition combine to a total of 100, provided that the weight percent of any particular component does not fall outside the limits of the range specified for that component.

This disclosure refers to both particles and powders. These two terms are equivalent, except for the caveat that a singular “powder” refers to a collection of particles. The present disclosure can apply to a wide variety of powders and particles. The terms “nanoparticle” and “nano-sized particle” are generally understood by those of ordinary skill in the art to encompass a particle on the order of nanometers in diameter, typically between about 0.5 nm to 500 nm, about 1 nm to 500 nm, about 1 nm to 100 nm, or about 1 nm to 50 nm. The nanoparticles can have an average grain size less than 250 nanometers and an aspect ratio between one and one million. In some embodiments, the nanoparticles have an average grain size of about 50 nm or less, about 30 nm or less, about 20 nm or less, about 10 nm or less, or about 5 nm or less. In additional embodiments, the nanoparticles have an average diameter of about 50 nm or less, about 30 nm or less, about 20 nm or less, about 10 nm or less, or about 5 nm or less. The aspect ratio of the particles, defined as the longest dimension of the particle divided by the shortest dimension of the particle, is preferably between one and one hundred, more preferably between one and ten, yet more preferably between one and two. “Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art.

In additional embodiments, the nanoparticles have a grain size of about 50 nm or less, about 30 nm or less, about 20 nm or less, about 10 nm or less, or about 5 nm or less. In additional embodiments, the nanoparticles have a diameter of about 50 nm or less, about 30 nm or less, about 20 nm or less, about 10 nm or less, or about 5 nm or less.

The terms “micro-particle,” “micro-sized particle,” “micron-particle,” and “micron-sized particle” are generally understood to encompass a particle on the order of micrometers in diameter, typically between about 0.5 μm to 1000 μm, about 1 μm to 1000 μm, about 1 μm to 100 μm, or about 1 μm to 50 μm. Additionally, the term “platinum group metals” (abbreviated “PGM”) used in this disclosure refers to the collective name used for six metallic elements clustered together in the periodic table. The six platinum group metals are ruthenium, rhodium, palladium, osmium, iridium, and platinum.

### Composite Nanoparticles

PNA systems may include many different types of composite nanoparticles. One type of composite nanoparticle is an oxidative composite nanoparticle. A second type of composite nanoparticle is a PNA composite nanoparticle. The PNA systems can also include reductive composite nanoparticles as well. In some embodiments, the composite nanoparticles are directly used in a catalytic washcoat compositions as components of a “loose ingredient” catalytic washcoat formulation. In other embodiments, the composite nanoparticles are used to form NNm particles or NNiM particles, as further described herein, and then used in washcoat compositions.

A composite nanoparticle may include a catalytic nanoparticle attached to a support nanoparticle to form a “nano-on-nano” composite nanoparticle. Multiple nano-on-nano particles may then be bonded to or embedded within a micron-sized carrier particle to form a composite micro/nanoparticle, that is, a micro-particle bearing composite nanoparticles. These composite micro/nanoparticles may be used in washcoat formulations and catalytic converters as described herein. Alternatively, the composite nanoparticles are provided directly into the washcoat compositions, for example as a “loose ingredient” washcoat composition. The use of these composite nanoparticles, particularly in a catalytic washcoat, can reduce requirements for platinum group metal content and significantly enhance performance, particularly in terms of reduced light-off temperature and NOₓ storage, as compared with currently available commercial catalytic converters prepared by wet-chemistry methods. The wet-chemistry methods generally involve use of a solution of platinum group metal ions or metal salts, which are impregnated into supports (typically micron-sized particles), and reduced to platinum group metal in elemental form for use as the catalyst. For example, a solution of chloroplatinic acid, H₂PtCl₆, can be applied to micron-sized support particles (such as aluminum oxide support particles), followed by drying and calcining, resulting in precipitation of platinum onto the alumina. In any embodiment, the drying and/or calcining can be done under reducing conditions as compared to atmospheric conditions in order to limit the amount of oxide formation (specifically, with regard to the PGM metal). Accordingly, the drying and/or calcining can be done using argon and/or helium. The platinum group metals deposited by wet-chemical methods onto metal oxide supports, such as alumina and cerium oxide, are mobile at high temperatures, such as temperatures encountered in catalytic converters. That is, at elevated temperatures, the PGM atoms can migrate over the surface on which they are deposited, and will clump together with other PGM atoms. The finely-divided portions of PGM combine into larger and larger agglomerations of platinum group metal as the time of exposure to high temperature increases. This agglomeration leads to reduced catalyst surface area and degrades the performance of the catalytic converter. This phenomenon is referred to as “aging” of the catalytic converter.

In contrast, the composite platinum group metal particles are prepared by plasma-based methods. In one embodiment, the platinum group nano-sized metal particle is deposited on a nano-sized metal oxide support, which has much lower mobility than PGM deposited by wet chemistry methods. The resulting plasma-produced catalysts age at a much slower rate than the catalysts produced by wet-chemistry. Thus, catalytic converters using plasma-produced catalysts can maintain a larger surface area of exposed catalyst to gases emitted by the engine over a longer period of time, leading to better emissions performance.

### Oxidative Composite Nanoparticle (Oxidative “Nano-On-Nano” Particle)

One type of composite nanoparticle useful in the catalytic washcoat formulation either as a loose ingredient or attached to or embedded within a micron-sized particle is an oxidative composite nanoparticle. An oxidative composite nanoparticle includes one or more oxidative catalyst nanoparticles attached to a first support nanoparticle to form an oxidative “nano-on-nano” composite nanoparticle. Platinum (Pt) and palladium (Pd) are exemplary catalytic materials for an oxidative nanoparticle. In certain embodiments, the oxidative nanoparticle is platinum. In other embodiments, the oxidative nanoparticle is palladium. In some embodiments, the oxidative nanoparticle is a mixture of platinum and palladium. A suitable support nanoparticle for the oxidative catalyst nanoparticle includes, but is not limited to, nano-sized aluminum oxide (alumina or Al₂O₃).

Each oxidative catalyst nanoparticle may be supported on a first support nanoparticle. The first support nanoparticle may include one or more oxidative nanoparticles. The oxidative catalyst nanoparticles on the first support nanoparticle may include platinum, palladium, or a mixture thereof. At the high temperatures involved in gasoline or diesel exhaust engines, both palladium and platinum are effective oxidative catalysts. Accordingly, in some embodiments, the oxidative catalyst is palladium alone. In other embodiments, platinum may be used alone. In further embodiments, platinum may be used in combination with palladium. For example, the first support nanoparticle may contain a mixture of about 1:2 to about 100:1 platinum to palladium. In some embodiments, the first support nanoparticle may contain a mixture of about 1:2 to about 75:1 platinum to palladium. In some embodiments, the first support nanoparticle may contain a mixture of about 1:2 to about 50:1 platinum to palladium. In some embodiments, the first support nanoparticle may contain a mixture of about 1:2 to about 25:1 platinum to palladium. In some embodiments, the first support nanoparticle may contain a mixture of about 1:1 to about 15:1 platinum to palladium. In some embodiments, the first support nanoparticle may contain a mixture of about 1:1 to about 10:1 platinum to palladium. In some embodiments, the first support nanoparticle may contain a mixture of about 1:1 to about 5:1 platinum to palladium. In some embodiments, the first support nanoparticle may contain a mixture of about 2:1 platinum to palladium.

The oxidative composite nanoparticle includes both an oxidative nanoparticle and a support nanoparticle. In some embodiments, the weight ratio of catalytic nanoparticle (for example, platinum, palladium, or a mixture of platinum and palladium) to support nanoparticle (for example, aluminum oxide) is about 5:95 to about 80:20 (such as about 10:90 to about 70:30, about 20:80 to about 60:40, about 30:70 to about 50:50, or about 40:60).

### Reductive Composite Nanoparticle (Reductive “Nano-On-Nano” Particle)

As discussed above, another type of composite nanoparticle is a reductive composite nanoparticle catalyst. A reductive composite nanoparticle may include one or more reductive catalyst nanoparticles attached to a second support nanoparticle to form a reductive “nano-on-nano” composite nanoparticle. Rhodium (Rh) is reductive to the nitrogen oxides in fuel-rich conditions. In certain embodiments, the reductive catalyst nanoparticle is rhodium. The second support may be the same or different than the first support. A suitable second support nanoparticle for the reductive nanoparticle includes, but is not limited to, nano-sized cerium oxide (CeO₂). The nano-sized cerium oxide particles may further comprise zirconium oxide. The nano-sized cerium oxide particles can also be substantially free of zirconium oxide. In other embodiments, the nano-sized cerium oxide particles may contain up to 60% zirconium oxide. In some embodiments, the nano-sized cerium oxide particles may further comprise both zirconium oxide and lanthanum and/or lanthanum oxide. In some embodiments, the nano-sized cerium oxide particles may further comprise yttrium oxide. Accordingly, in addition to, or instead of, cerium oxide particles, particles comprising cerium-zirconium oxide, cerium-lanthanum oxide, cerium-yttrium oxide, cerium-zirconium oxide, cerium-zirconium-yttrium oxide, cerium-lanthanum-yttrium oxide, and/or cerium-zirconium-lanthanum-yttrium oxide can be used. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the nano-sized cerium oxide particles contain 80 wt % cerium oxide, 10 wt % zirconium oxide, and 10 wt % lanthanum and/or lanthanum oxide. In another embodiment, the nano-sized cerium oxide particles contain 86 wt % cerium oxide, 10 wt % zirconium oxide, and 4 wt % lanthanum oxide. In another embodiment, the nano-sized cerium oxide particles contain 40 wt % cerium oxide, 50 wt % zirconium oxide, and 10 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

Each reductive catalyst nanoparticle may be supported on a second support nanoparticle. The second support nanoparticle may include one or more reductive catalyst nanoparticles. The ratios of rhodium to cerium oxide and sizes of the reductive composite nanoparticle catalyst are further discussed below in the sections describing production of composite nanoparticles by plasma-based methods and production of micron-sized carrier particles bearing composite nanoparticles.

### PNA Composite Nanoparticle (PNA “Nano-On-Nano” Particle)

As discussed above, another type of composite nanoparticle is a PNA composite nanoparticle. A PNA composite nanoparticle may include one or more PGM nanoparticles attached to a second support nanoparticle to form a PGM “nano-on-nano” composite nanoparticle. Palladium (Pd) and Ruthenium (Ru) can hold NOₓ gases during low temperature engine operation and release the gases when the temperature rises to a threshold temperature. In certain embodiments, the PGM nanoparticle is palladium. In some embodiments, palladium can be used when employed in a large engine system (e.g., greater than 2.5 L). In other embodiments, the PGM nanoparticle is ruthenium. In some embodiments, ruthenium can be used when employed in a small engine system (e.g., less than 2 L). The ruthenium can be ruthenium oxide. A suitable second support nanoparticle for the PGM nanoparticle includes, but is not limited to, nano-sized cerium oxide. The nano-sized cerium oxide particles may further comprise zirconium oxide. The nano-sized cerium oxide particles can also be substantially free of zirconium oxide. In addition, the nano-sized cerium oxide may further comprise lanthanum and/or lanthanum oxide. In some embodiments, the nano-sized cerium oxide particles may further comprise both zirconium oxide and lanthanum oxide. In some embodiments, the nano-sized cerium oxide particles may further comprise yttrium oxide. Accordingly, in addition to, or instead of, cerium oxide particles, particles comprising cerium-zirconium oxide, cerium-lanthanum oxide, cerium-yttrium oxide, cerium-zirconium oxide, cerium-zirconium-yttrium oxide, cerium-lanthanum-yttrium oxide, and/or cerium-zirconium-lanthanum-yttrium oxide can be used. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the nano-sized cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

Each PGM nanoparticle may be supported on a second support nanoparticle. The second support nanoparticle may include one or more PGM nanoparticles. The ratios of PGM to cerium oxide and sizes of the PNA composite nanoparticle catalyst are further discussed below in the sections describing production of composite nanoparticles by plasma-based methods and production of micron-sized carrier particles bearing composite nanoparticles.

### Production of Composite Nanoparticles by Plasma-Based Methods (“Nano-On-Nano” Particles or “NN” Particles)

The initial step in producing suitable catalysts may involve producing composite nano-particles. The composite nano-particles comprise a catalytic nano-particle comprising one or more platinum group metals, and a support nano-particle, typically a metal oxide such as aluminum oxide or cerium oxide. As the name “nano-particle” implies, the nano-particles have sizes on the order of nanometers.

The composite nano-particles may be formed by plasma reactor methods, by feeding platinum group metal(s) and support material into a plasma gun, where the materials are vaporized. Plasma guns such as those disclosed in US 2011/0143041 can be used, and techniques such as those disclosed in U.S. Pat. No. 5,989,648, U.S. Pat. No. 6,689,192, U.S. Pat. No. 6,755,886, and US 2005/0233380 can be used to generate plasma, the disclosures of which are hereby incorporated by reference in their entireties. A working gas, such as argon, is supplied to the plasma gun for the generation of plasma; in one embodiment, an argon/hydrogen mixture (in the ratio of 10:2 Ar/H₂) is used as the working gas.

The platinum group metal or metals, such as platinum, palladium, or ruthenium, and which are generally in the form of metal particles of about 0.5 to 6 microns in diameter, can be introduced into the plasma reactor as a fluidized powder in a carrier gas stream such as argon. Metal oxide, typically aluminum oxide or cerium oxide in a particle size of about 15 to 25 microns diameter, is also introduced as a fluidized powder in carrier gas. However, other methods of introducing the materials into the reactor can be used, such as in a liquid slurry. A composition of about 1% to about 40% platinum group metal(s) and about 99% to about 60% metal oxide (by weight) can be used. Furthermore, a composition of about 40% to about 60% platinum group metal(s) and about 60% to about 40% metal oxide (by weight) can be used. Examples of ranges of materials that can be used for oxidative composite nanoparticles are from about 0% to about 40% platinum, about 0% to about 40% palladium, and about 55% to about 65% aluminum oxide; in some embodiments, from about 20% to about 30% platinum, about 10% to about 15% palladium, and about 50% to about 65% aluminum oxide are used; in further embodiments, from about 23.3% to about 30% platinum, about 11.7% to about 15% palladium, and about 55% to about 65% aluminum oxide are used. An exemplary composition contains about 26.7% platinum, about 13.3% palladium, and about 60% aluminum oxide.

The oxidative composite nanoparticles may contain a mixture of 2:1 to 100:1 platinum to palladium. In some embodiments, the oxidative composite nanoparticles may contain a mixture of 2:1 to 75:1 platinum to palladium. In some embodiments, the oxidative composite nanoparticles may contain a mixture of 2:1 to 50:1 platinum to palladium. In some embodiments, the oxidative composite nanoparticles may contain a mixture of 2:1 to 25:1 platinum to palladium. In some embodiments, the oxidative composite nanoparticles may contain a mixture of 2:1 to 15:1 platinum to palladium. In some embodiments, the oxidative composite nanoparticles may contain a mixture of 2:1 to 10:1 platinum to palladium. In some embodiments, the oxidative composite nanoparticles may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

Examples of ranges of materials that can be used for reductive composite nanoparticles are from about 1% to about 10% rhodium and 90% to 99% cerium oxide. In one embodiment, the composition contains about 5% rhodium and 95% cerium oxide.

Examples of ranges of materials that can be used for PNA composite nanoparticles are from about 1% to about 40% palladium and about 99% to about 60% cerium oxide, from about 5% to about 20% palladium and about 95% to about 80% cerium oxide, and from about 8% to about 12% palladium and about 92% to about 88% cerium oxide. These examples can be for PNA material to be used in large engine systems. In one embodiment, the composition contains about 10% palladium and about 90% cerium oxide. Other Examples of ranges of materials that can be used for PNA composite nanoparticles are from about 1% to about 40% ruthenium and about 99% to about 60% cerium oxide, from about 5% to about 20% ruthenium and about 95% to about 80% cerium oxide, and from about 8% to about 12% ruthenium and about 92% to about 88% cerium oxide. These examples can be for PNA material to be used in small engine systems. In one embodiment, the composition contains about 10% ruthenium and about 90% cerium oxide. As discussed below, in all embodiments, the cerium oxide can include cerium-zirconium oxide, cerium-zirconium-lanthanum oxide, and cerium-zirconium-lanthanum-yttrium oxide among others.

In a plasma reactor, any solid or liquid materials are rapidly vaporized or turned into plasma. The kinetic energy of the superheated material, which can reach temperatures of 20,000 to 30,000 Kelvin, ensures extremely thorough mixture of all components.

The superheated material of the plasma stream is then rapidly quenched, using methods such as the turbulent quench chamber disclosed in U.S. Publication No. 2008/0277267, the disclosure of which is hereby incorporated by reference in their entireties. Argon quench gas at high flow rates, such as 2400 to 2600 liters per minute, may be injected into the superheated material. The material may be further cooled in a cool-down tube, and collected and analyzed to ensure proper size ranges of material.

The plasma production method described above produces highly uniform composite nanoparticles, where the composite nanoparticles comprise a catalytic nanoparticle bonded to a support nanoparticle. The catalytic nanoparticle comprises the platinum group metal or metals, such as Pt:Pd in a 2:1 ratio by weight. In some embodiments, the catalytic nanoparticles have an average diameter or average grain size between approximately 0.3 nm and approximately 10 nm, preferably between approximately 1 nm to approximately 5 nm, that is, approximately 3 nm±2 nm. These size of catalytic nanoparticles can be the size of the catalytic nanoparticles employed when using wet chemistry methods. In some embodiments, the support nanoparticles, comprising the metal oxide such as aluminum oxide or cerium oxide, have an average diameter of approximately 20 nm or less, or approximately 15 nm or less, or between approximately 10 nm and approximately 20 nm, that is, approximately 15 nm±5 nm, or between approximately nm and approximately 15 nm, that is, approximately 12.5 nm±2.5 nm, or between approximately 5 nm and approximately 10 nm, that is, approximately 7.5 nm±2.5 nm.

The composite nanoparticles, when produced under reducing conditions, such as by using argon/hydrogen working gas, results in a partially reduced surface on the support nanoparticle to which the PGM nanoparticle is bonded, as described in U.S. Publication No. 2011/0143915 at paragraphs 0014-0022. For example, when palladium is present in the plasma, the particles produced under reducing conditions can be a palladium aluminate. The partially reduced surface inhibits migration of the platinum group metal on the support surface at high temperatures. This, in turn, limits the agglomeration of platinum group metal when the particles are exposed to prolonged elevated temperatures. Such agglomeration is undesirable for many catalytic applications, as it reduces the surface area of PGM catalyst available for reaction.

The composite nanoparticles comprising two nanoparticles (catalytic or support) are referred to as “nano-on-nano” particles or “NN” particles.

### Production of Micron-Sized Carrier Particles Bearing Composite Nanoparticles (“Nano-on-Nano-on-Micro” Particles or “NNm” ™ Particles)

The composite nanoparticles (nano-on-nano particles) may be further bonded to micron-sized carrier particles to produce composite micro/nanoparticles, referred to as “nano-on-nano-on-micro” particles or “NNm”™ particles, which are catalytic particles.

The micron-sized particles can have an average size between about 1 micron and about 100 microns, such as between about 1 micron and about 10 microns, between about 3 microns and about 7 microns, or between about 4 microns and about 6 microns. In one embodiment, the micron-sized particles have an average size of 5 microns. These sizes of micron-sized particles can be the size of the micron-sized particles employed when using wet chemistry methods.

In general, the nano-on-nano-on-micro particles are produced by a process of suspending the composite nanoparticles (nano-on-nano particles) in water, adjusting the pH of the suspension to between about 2 and about 7, between about 3 and about 5, or about 4, adding one or more surfactants to the suspension (or, alternatively, adding the surfactants to the water before suspending the composite nanoparticles in the water) to form a first solution. The process includes sonicating the composite nanoparticle suspension and applying the suspension to micron-sized metal oxide particles until the point of incipient wetness, thereby impregnating the micron-sized particles with composite nanoparticles and nano-sized metal oxide. This process of drying and calcining can also be applied to producing nanoparticles on support particles (either micron-sized or on nano-sized) via incipient wetness in general.

In some embodiments, the micron-sized metal oxide particles are pre-treated with a gas at high temperature. The pre-treatment of the micron-sized metal oxide particles allows the nano-on-nano-on-micro particles to withstand the high temperatures of an engine. Without pre-treatment, the nano-on-nano-on-micro particles would more likely change phase on exposure to high temperature, compared to the nano-on-nano-on-micro particles that have been pretreated. In some embodiments, pre-treatment includes exposure of the micron-sized metal oxide particles at temperatures, such as about 700° C. to about 1500° C.; 700° C. to about 1400° C. 700° C. to about 1300° C.; and 700° C. to about 1200° C. In some embodiments, pre-treatment includes exposure of the micron-sized metal oxide particles at temperatures, such as about 700° C., 1110° C., 1120° C., 1130° C. 1140° C., 1150° C. 1155° C., 1160° C., 1165° C., 1170° C., 1175° C., 1180° C., 1190° C., and 1200° C.

The process includes drying the micron-sized metal oxide particles which have been impregnated with composite nanoparticles and nano-sized metal oxide, and calcining the micron-sized metal oxide particles which have been impregnated with composite nanoparticles and nano-sized metal oxide.

Typically, the composite nanoparticles and nano-sized metal oxide are suspended in water, and the suspension is adjusted to have a pH of between about 2 and about 7, preferably between about 3 and about 5, more preferably a pH of about 4 (the pH is adjusted with acetic acid or another organic acid). Dispersants, surfactants, or mixtures thereof may be added to the composite nanoparticles and nano-sized metal oxide. Surfactants suitable for use include Jeffsperse® X3202 (Chemical Abstracts Registry No. 68123-18-2, described as 4,4′-(1-methylethylidene)bis-phenol polymer with 2-(chloromethyl)oxirane, 2-methyloxirane, and oxirane), Jeffsperse® X3204, and Jeffsperse® X3503 surfactants from Huntsman (JEFFSPERSE is a registered trademark of Huntsman Corporation, The Woodlands, Tex., United States of America for chemicals for use as dispersants and stabilizers), which are non-ionic polymeric dispersants. Other suitable surfactants include Solsperse® 24000 and Solsperse® 46000 from Lubrizol (SOLSPERSE is a registered trademark of Lubrizol Corporation, Derbyshire, United Kingdom for chemical dispersing agents). The Jeffsperse® X3202 surfactant, Chemical Abstracts Registry No. 68123-18-2 (described as 4,4′-(1-methylethylidene)bis-phenol polymer with 2-(chloromethyl)oxirane, 2-methyloxirane, and oxirane), is preferred. The surfactant may be added in a range, for example, of about 0.5% to about 5%, with about 2% being a typical value.

The mixture of aqueous surfactants, composite nanoparticles, and nano-sized metal oxide may be sonicated to disperse the composite nanoparticles and nano-sized metal oxide. The quantity of composite nanoparticles and nano-sized metal oxide in the dispersion may be in the range of about 2% to about 15% (by mass). The dispersion is then applied to porous, micron sized metal oxides, such as Al₂O₃ which may be purchased from companies such as Rhodia or Sasol or cerium oxide. The porous, micron sized, metal oxide powders may be stabilized with a small percentage of lanthanum and/or lanthanum oxide (about 2% to about 4% La). In addition, the porous, micron sized, metal oxide powder may include a percentage of zirconium oxide (about 5% to about 15%, preferably 10%). In some embodiments, the porous, micron sized, metal oxide powders may further comprise yttrium oxide. Accordingly, the porous, micron sized, metal oxide powders can include cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the micron-sized cerium oxide particles contain 86 wt % cerium oxide, 10 wt % zirconium oxide, and 4 wt % lanthanum and/or lanthanum oxide. In another embodiment, the cerium oxide particles contain 40% wt % cerium oxide, 50 wt % zirconium oxide, 5 wt % lanthanum oxide, and 5 wt % yttrium oxide. One commercial alumina powder suitable for use is MI-386, purchased from Grace Davison or Rhodia. The usable surface for this powder, defined by pore sizes greater than 0.28 μm, is approximately 2.8 m²/g. One commercial cerium oxide powder suitable for use is HSA5, HSA20, or a mixture thereof, purchased from Rhodia-Solvay.

The ratio of composite nano-particles used to micron-sized carrier particles used may be from about 3:100 to about 10:100, about 5:100 to about 8:100, or about 6.5:100, in terms of (weight of composite nanoparticle):(weight of micron carrier particle). In some embodiments, about 8 grams of composite nano-particles may be used with about 122 grams of carrier micro-particles. The aqueous dispersion of composite nano-particles is applied in small portions (such as by dripping or other methods) to the micron-sized powder until the point of incipient wetness, producing a material similar to damp sand.

The micron-sized carrier particles, impregnated with the composite nano-particles, may then be dried (for example, at about 30° C. to about 95° C., preferably about 60° C. to about 70° C., at atmospheric pressure or at reduced pressure such as from about 1 pascal to about 90,000 pascal). After drying, the particles may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nano-particles, also referred to as nano-on-nano-on-micron particles, or NNm particles. The drying step may be performed before the calcining step to remove the water before heating at the higher calcining temperatures; this avoids boiling of the water, which would disrupt the impregnated nano-particles which are lodged in the pores of the micron-sized carrier. In any embodiment, the drying and/or calcining can be done under reducing conditions as compared to atmospheric conditions in order to limit the amount of oxide formation (specifically, with regard to the PGM metal). Accordingly, the drying and/or calcining can be done using argon and/or helium.

The NNm particles may contain from about 0.1% to about 6% PGM by weight, or in another embodiment from about 0.5% to 3.5% by weight, or in another embodiment about 1% to 2.5% by weight, or in another embodiment about 2% to about 3% by weight, or in another embodiment, about 2.5% by weight, of the total mass of the NNm particle. The NNm particles can then be used for formulations for coating substrates, where the coated substrates may be used in catalytic converters.

Examples of production of NNm material are described in the following patents and patent applications the disclosures of which are hereby incorporated by reference in their entireties: U.S. Patent Publication No. 2005/0233380, U.S. Patent Publication No. 2006/0096393, U.S. patent application Ser. No. 12/151,810, U.S. patent application Ser. No. 12/152,084, U.S. patent application Ser. No. 12/151,809, U.S. Pat. No. 7,905,942, U.S. patent application Ser. No. 12/152,111, U.S. Patent Publication 2008/0280756, U.S. Patent Publication 2008/0277270, U.S. patent application Ser. No. 12/001,643, U.S. patent application Ser. No. 12/474,081, U.S. patent application Ser. No. 12/001,602, U.S. patent application Ser. No. 12/001,644, U.S. patent application Ser. No. 12/962,518, U.S. patent application Ser. No. 12/962,473, U.S. patent application Ser. No. 12/962,490, U.S. patent application Ser. No. 12/969,264, U.S. patent application Ser. No. 12/962,508, U.S. patent application Ser. No. 12/965,745, U.S. patent application Ser. No. 12/969,503, and U.S. patent application Ser. No. 13/033,514, WO 2011/081834 (PCT/US2010/59763) and US 2011/0143915 (U.S. patent application Ser. No. 12/962,473).

Production of Hybrid Micron-Sized Carrier Particles Bearing Composite Nanoparticles (“nano-on-nano-on-micro” particles or “NNm”™ particles) and also Impregnated with Platinum Group Metal(s) Using Wet Chemistry Methods-“Hybrid NNm/Wet-Chemistry Particles” or “Hybrid Composite/Wet-Chemistry Particles”

Furthermore, the micron-sized particles which bear the composite nanoparticles can additionally be impregnated with platinum group metals using wet-chemistry methods, so that PGM is present on the micron-sized particle due to the nano-on-nano composite nanoparticles and also due to the deposition via wet chemistry. The micron-sized particles can be impregnated with PGM before or after the composite nanoparticles (nano-on-nano) are bonded to the micron-sized particles. When the nano-on-nano particles are added to the micron-sized carrier particles, the nano-on-nano particles tend to stay near the surface of the micron particle, as they are too large to penetrate into the smaller pores of the micron particle. Therefore, impregnating these micron-sized particles via wet-chemistry methods allows for PGM to penetrate deeper into the micron-sized particles than the corresponding nano-on-nano particles. In addition, because the nano-on-nano particles of these hybrid NNm/wet-chemistry particles contain PGM, lower amounts of PGM can be impregnated by wet-chemistry on the micron-sized particles to achieve the total desired loading. For example, if a final loading of 5 g/l of PGM is desired on the final catalyst or PNA material, loading 3 g/l of PGM as nano-on-nano (NN) particles requires only 2 g/l of PGM to be loaded via wet-chemistry methods. A lower amount of wet-chemistry impregnated PGM can reduce the agglomeration rate of these wet-chemistry impregnated catalytic particles when the catalyst or PNA material is exposed to prolonged elevated temperatures since there is less PGM to agglomerate. That is, the rate of aging of the catalyst will be reduced, since the rate of collision and agglomeration of mobile wet-chemistry-deposited PGM is reduced at a lower concentration of the wet-chemistry-deposited PGM, but without lowering the overall loading of PGM due to the contribution of PGM from the nano-on-nano particles. Thus, employing the nano-on-nano-on-micro configuration and using a micron-sized particle with wet-chemistry deposited platinum group metal can enhance catalyst performance and NOₓ storage while avoiding an excessive aging rate.

Methods for impregnation of carriers and production of catalysts by wet chemistry methods are discussed in Heck, Ronald M.; Robert J. Farrauto; and Suresh T. Gulati, Catalytic Air Pollution Control: Commercial Technology, Third Edition, Hoboken, N.J.: John Wiley & Sons, 2009, at Chapter 2, pages 24-40 (see especially pages 30-32) and references disclosed therein, and also in Marceau, Eric; Xavier Carrier, and Michel Che, “Impregnation and Drying,” Chapter 4 of Synthesis of Solid Catalysts (Editor: de Jong, Krijn) Weinheim, Germany: Wiley-VCH, 2009, at pages 59-82 and references disclosed therein.

For wet chemistry impregnation, typically a solution of a platinum group metal salt is added to the micron sized carrier particle to the point of incipient wetness, followed by drying, calcination, and reduction as necessary to elemental metal. Platinum can be deposited on carriers such as alumina by using Pt salts such as chloroplatinic acid H₂PtCl₆), followed by drying, calcining, and reduction to elemental metal. Palladium can be deposited on carriers such as alumina using salts such as palladium nitrate (Pd(NO₃)₂), palladium chloride (PdCl₂), palladium(II) acetylacetonate (Pd(acac)₂), followed by drying, calcining, and reduction to elemental metal (see, e.g., Toebes et al., “Synthesis of supported palladium catalysts,” Journal of Molecular Catalysis A: Chemical 173 (2001) 75-98).

### General Procedures for Preparation of Catalysts for Oxidation Reaction (Oxidative “Nano-On-Nano-On-Micro” Particles or “NNm”™ Particles)

To prepare an oxidative catalytic particle, a dispersion of oxidative composite nanoparticles may be applied to porous, micron-sized Al₂O₃, which may be purchased, for example, from companies such as Rhodia or Sasol. The porous, micron-sized, Al₂O₃ powders may be stabilized with a small percentage of lanthanum and/or lanthanum oxide (about 2% to about 4% La). One commercial alumina powder suitable for use is MI-386, which may be purchased from Grace Davison or Rhodia. The usable surface for this powder, defined by pore sizes greater than 0.28 μm, is approximately 2.8 m²/g. The ratio of composite nanoparticles used to micron-sized carrier particles used may be from about 3:100 to about 10:100, about 5:100 to about 8:100, or about 6.5:100, in terms of (weight of composite nanoparticle):(weight of micron carrier particle). In some embodiments, about 8 grams of composite nanoparticles may be used with about 122 grams of carrier micro-particles. The aqueous dispersion of composite nanoparticles may be applied in small portions (such as by dripping or other methods) to the micron-sized powder until the point of incipient wetness, producing a material similar to damp sand as described below.

In some instances, the sizes of the nano-sized oxidative catalysts, for example Pd, Pt, or Pt/Pd are about 1 nm and the sizes of the nano-sized Al₂O₃ are about 10 nm. In some instances, the sizes of the nano-sized oxidative catalysts are approximately 1 nm or less and the sizes of the nano-sized Al₂O₃ are approximately 10 nm or less. In some instances, Pd is used as the oxidative catalyst and the weight ratio of nano-sized Pd:nano-sized aluminum oxide is about 5%:95%. In some instances, the weight percentage of nano-sized Pd is between about 5% to about 20% of nano-sized Pd on nano-sized aluminum oxide. The nano-on-nano material that contains nano-sized Pd on nano-sized Al₂O₃ shows a dark black color. In some instances, Pt is used as the oxidative catalyst and the weight ratio of nano-sized Pt:nano-sized aluminum oxide is about 40%:60%. In some instances, a mixture of Pt and Pd is used as the oxidative catalyst. In some embodiments, the weight ratio of nano-sized Pt/Pd:nano-sized aluminum oxide is about 5%:95%. In some embodiments, the weight ratio of nano-sized Pt/Pd:nano-sized aluminum oxide is about 10%:90%. In some embodiments, the weight ratio of nano-sized Pt/Pd:nano-sized aluminum oxide is about 20%:80%. In some embodiments, the weight ratio of nano-sized Pt/Pd:nano-sized aluminum oxide is about 30%:70%. In some embodiments, the weight ratio of nano-sized Pt/Pd:nano-sized aluminum oxide is about 40%:60%.

A solution containing dispersed nano-on-nano material can be prepared using a sonication process to disperse nano-on-nano particles into water with pH ˜4. Subsequently, 100 g of micron-sized MI-386 Al₂O₃ is put into a mixer, and a 100 g dispersion containing the nano-on-nano material is injected into the mixing aluminum oxide. This process is referred to as the incipient wetness process or method.

Next, the wet powder is dried at 60° C. in a convection oven overnight until it is fully dried. Once the powder is dried, calcination is performed. The dried powder from the previous step, that is, the nanomaterials on the micron-sized material, is baked at 550° C. for two hours under ambient air conditions. During the calcination, the surfactant is burned off and the nanomaterials are glued or fixed onto the surface of the micron-sized materials or onto the surface of the pores of the micron-materials. One explanation for why the nanomaterials can be glued or fixed more permanently onto the micron-sized material during the calcination is because oxygen-oxygen (O—O) bonds, oxide-oxide bonds, or covalent bonds are formed during the calcination step. The oxide-oxide bonds can be formed between the nanomaterials (nano-on-nano with nano-on-nano, nano-on-nano with nano-sized aluminum oxide, and nano-sized aluminum oxide with nano-sized aluminum oxide), between the nanomaterials and the micron-sized materials, and between the micron-sized materials themselves. The oxide-oxide bond formation is sometimes referred to as a solid state reaction. At this stage, the material produced contains a micron-sized particle having nano-on-nano and nano-sized Al₂O₃ randomly distributed on the surface.

The oxidative NNm™ particles may contain from about 0.5% to about 5% palladium by weight, or in another embodiment from about 1% to 3% by weight, or in another embodiment, about 1.2% to 2.5% by weight, of the total mass of the NNm™ particle. The oxidative NNm™ particles may contain from about 1% to about 6% platinum by weight, of the total mass of the NNm™ particle. The oxidative NNmM™ particles may contain from about 1% to about 6% platinum/palladium by weight, or in another embodiment, about 2% to 3% by weight, of the total mass of the NNm™ particle.

### General Procedures for Preparation of Catalysts for Reduction Reaction (Reductive “Nano-On-Nano-On-Micro” Particles or “NNm” ™ Particles)

To prepare a reductive catalytic particle, a dispersion of reductive composite nanoparticles may be applied to porous, micron-sized cerium oxide, which may be purchased, for example, from companies such as Rhodia-Solvay. One commercial cerium oxide powder suitable for use is HSA5, HSA20, or a mixture thereof, available from Rhodia-Solvay. The micron-sized cerium oxide may contain zirconium oxide. In some embodiments, the micron-sized cerium oxide is substantially free of zirconium oxide. In other embodiments, the micron-sized cerium oxide contains up to 100% zirconium oxide. In one embodiment, the reductive composite nanoparticle is rhodium.

The micron-sized carrier particles, impregnated with the composite reductive nanoparticles and nano-sized metal oxide, may then be dried (for example, at about 30° C. to about 95° C., preferably about 60° C. to about 70° C., at atmospheric pressure or at reduced pressure, such as from about 1 pascal to about 90,000 pascal). After drying, the particles may be calcined (at elevated temperatures, such as from 400° C. to about 700° C., preferably about 500° C. to about 600° C. more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nanoparticles, also referred to as nano-on-nano-on-micro particles, or NNm™ particles. The drying step may be performed before the calcining step to remove water prior to heating at the higher calcining temperatures; this avoids boiling of the water, which would disrupt the impregnated nanoparticles, which are lodged in the pores of the micron-sized carrier.

The catalyst for reduction reactions can be made using a procedure similar to that employed for production of the catalyst for oxidation reactions. The nano-on-nano materials, for example nano-sized Rh on nano-sized cerium oxide, can be prepared using the method described above. In some instances, the sizes of the nano-sized Rh are about 1 nm and the sizes of the nano-sized cerium oxide are about 10 nm. In some instances, the sizes of the nano-sized Rh are approximately 1 nm or less and the sizes of the nano-sized cerium oxide are approximately 10 nm or less. In some embodiments, the weight ratio of nano-sized Rh:nano-sized cerium oxide is from 1%:99% to 20%:80%. In some embodiments, the weight ratio of nano-sized Rh:nano-sized cerium oxide is from 2%:98% to 15%:85%. In some embodiments, the weight ratio of nano-sized Rh:nano-sized cerium oxide is from 3%:97% to 10%:90%. In some embodiments, the weight ratio of nano-sized Rh:nano-sized cerium oxide is from 4%:96% to 6%:94%. In some embodiments, the weight ratio of nano-sized Rh:nano-sized cerium oxide is about 5%:95%.

Next, calcination can be performed. The dried powder from the previous step, that is, the nanomaterials on the micron-sized material, can be baked at 550° C. for two hours under ambient air conditions. During the calcination step, the surfactant is evaporated and the nanomaterials are glued or fixed onto the surface of the micron-sized materials or the surface of the pores of the micron-sized materials. At this stage, the material produced (a catalytic active material) contains a micron-sized particle (micron-sized cerium oxide) having nano-on-nano (such as nano-sized Rh on nano-sized cerium oxide) and nano-sized cerium oxide randomly distributed on the surface.

The reductive NNm™ particles may contain from about 0.1% to 1.0% rhodium by weight, or in another embodiment from about 0.2% to 0.5% by weight, or in another embodiment, about 0.3% by weight, or in another embodiment, about 0.4% by weight, of the total mass of the NNm™ particle. The NNm™ particles can then be used for formulations for coating substrates, where the coated substrates may be used in catalytic converters.

### General Procedures for Preparation of Catalysts for PNA Material (PNA “Nano-On-Nano-On-Micro” Particles or “NNm” ™ Particles)

To prepare a PNA particle, a dispersion of PNA composite nanoparticles may be applied to porous, micron-sized cerium oxide, which may be purchased, for example, from companies such as Rhodia-Solvay. One commercial cerium oxide powder suitable for use is HSA5, HSA20, or a mixture thereof, available from Rhodia-Solvay. The micron-sized cerium oxide may further comprise zirconium oxide. In some embodiments, the micron-sized cerium oxide is substantially free of zirconium oxide. In other embodiments, the micron-sized cerium oxide contains up to 100% zirconium oxide. In addition, the micron-sized cerium oxide may further comprise lanthanum and/or lanthanum oxide. In some embodiments, the micro-sized cerium oxide may further comprise both zirconium oxide and lanthanum oxide. In some embodiments, the micron-sized cerium oxide may further comprise yttrium oxide. Accordingly, the micron-sized cerium oxide can be cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the micro-sized cerium oxide contains 86 wt. % cerium oxide, 10 wt. % zirconium oxide; and 4 wt. % lanthanum and/or lanthanum oxide. In another embodiment, the cerium oxide particles contain 40 wt %/o cerium oxide, 50 wt % zirconium oxide, 5 wt % lanthanum oxide, and 5 wt % yttrium oxide. In one embodiment, the PGM of the PNA composite nanoparticle is palladium. In one embodiment, the PGM of the PNA composite nanoparticle is ruthenium. The ruthenium of the PNA composite nanoparticle can be ruthenium oxide.

The micron-sized carrier particles, impregnated with the composite PNA nanoparticles and nano-sized metal oxide, may then be dried (for example, at about 30° C. to about 95° C., preferably about 60° C. to about 70° C., at atmospheric pressure or at reduced pressure, such as from about 1 pascal to about 90,000 pascal). After drying, the particles may be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nanoparticles, also referred to as nano-on-nano-on-micro particles, or NNm™ particles. The drying step may be performed before the calcining step to remove water prior to heating at the higher calcining temperatures; this avoids boiling of the water, which would disrupt the impregnated nanoparticles, which are lodged in the pores of the micron-sized carrier.

The PNA material can be made using a procedure similar to that employed for production of the catalyst for oxidation reactions. The nano-on-nano materials, for example nano-sized Pd, Ru, or ruthenium oxide on nano-sized cerium oxide, can be prepared using the method described above. In some instances, the sizes of the nano-sized Pd, Ru, or ruthenium oxide are from about 1 nm to about 5 nm and the sizes of the nano-sized cerium oxide are from about 5 nm to about 10 nm. In some instances, the sizes of the nano-sized Pd, Ru, or ruthenium oxide are approximately 1 nm or less and the sizes of the nano-sized cerium oxide are approximately 10 nm or less. In some embodiments, the weight ratio of nano-sized Pd, Ru, or ruthenium oxide:nano-sized cerium oxide is from 1%:99% to 40%:60%. In some embodiments, the weight ratio of nano-sized Pd, Ru, or ruthenium oxide:nano-sized cerium oxide is from 5%:95% to 20%:80%. In some embodiments, the weight ratio of nano-sized Pd, Ru, or ruthenium oxide:nano-sized cerium oxide is from 8%:92% to 12%:88%. In some embodiments, the weight ratio of nano-sized Pd, Ru, or ruthenium oxide:nano-sized cerium oxide is from 9%:91% to 11%:89%. In some embodiments, the weight ratio of nano-sized Pd, Ru, or ruthenium oxide:nano-sized cerium oxide is about 10%:90%.

Next, calcination can be performed. The dried powder from the previous step, that is, the nanomaterials on the micron-sized material, can be baked at 550° C. for two hours under ambient air conditions. During the calcination step, the surfactant is evaporated and the nanomaterials are glued or fixed onto the surface of the micron-sized materials or the surface of the pores of the micron-sized materials. At this stage, the material produced (a catalytic active material) contains a micron-sized particle (micron-sized cerium oxide) having nano-on-nano (such as nano-sized Pd, Ru, or ruthenium oxide on nano-sized cerium oxide) and nano-sized cerium oxide randomly distributed on the surface.

The PNA NNm™ particles may contain from about 0.1% to 6% Pd, Ru, or ruthenium oxide by weight, or in another embodiment from about 0.5% to 3.5% by weight, or in another embodiment, about 1% to about 2.5% by weight, or in another embodiment about 2% to about 3% by weight, or in another embodiment, about 2.5% by weight, of the total mass of the NNm™ particle. The NNm™ particles can then be used for formulations for coating substrates, where the coated substrates may be used in catalytic converters.

### Porous Materials for Use in “Nano-On-Nano-in-Micro” Particles (“NNiM” Particles)

Porous materials, production of porous materials, micron-sized particles comprising composite nanoparticles and a porous carrier (“Nano-on-Nano-in-Micro” particles or “NNiM” particles), and production of micron-sized particles comprising composite nanoparticles and a porous carrier (“Nano-on-Nano-in-Micro” particles or “NNiM” particles) are described in the co-owned U.S. Provisional Patent Application No. 61/881,337, filed on Sep. 23, 2013, U.S. patent application Ser. No. 14/494,156, and International Patent Application No. PCT/US2014/057036, the disclosures of which are hereby incorporated by reference in their entirety.

Generally, a preferred porous material is a material that contains a large number of interconnected pores, holes, channels, or pits, with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous material has a mean pore, hole, channel, or pit width (diameter) of less than about 1 nm, while in some embodiments, a porous carrier has a mean pore, hole, channel, or pit width (diameter) of greater than about 100 nm. In some embodiments, the porous material has an average pore surface area in a range of about 50 m²/g to about 500 m²/g. In some embodiments, the porous material has an average pore surface area in a range of about 100 m²/g to about 400 m²/g. In some embodiments, a porous material has an average pore surface area in a range of about 150 m²/g to about 300 m²/g. In some embodiments, the porous material has an average pore surface area of less than about 50 m²/g. In some embodiments, the porous material has an average pore surface area of greater than about 200 m²/g. In some embodiments, the porous material has an average pore surface area of greater than about 300 m²/g. In some embodiments, a porous material has an average pore surface area of about 200 m²/g. In some embodiments, a porous material has an average pore surface area of about 300 m²/g.

In some embodiments, the porous material may comprise porous metal oxide, such as aluminum oxide or cerium oxide. In some embodiments, a porous material may comprise an organic polymer, such as polymerized resorcinol. In some embodiments, the porous material may comprise amorphous carbon. In some embodiments, the porous material may comprise silica. In some embodiments, a porous material may be porous ceramic. In some embodiments, the porous material may comprise a mixture of two or more different types of interspersed porous materials, for example, a mixture of aluminum oxide and polymerized resorcinol. In some embodiments, the porous carrier may comprise aluminum oxide after a spacer material has been removed. For example, in some embodiments, a composite material may be formed with interspersed aluminum oxide and polymerized resorcinol, and the polymerized resorcinol is removed, for example, by calcination, resulting in a porous carrier. In another embodiment, a composite material may be formed with interspersed aluminum oxide and carbon black, and the carbon black is removed, for example, by calcination, resulting in a porous carrier.

In some embodiments, the porous material is a micron-sized particle, with an average size between about 1 micron and about 100 microns, between about 1 micron and about 10 microns, between about 3 microns and about 7 microns, or between about 4 microns and about 6 microns. In other embodiments, the porous material may be particles larger than about 7 microns. In some embodiments, the porous material may not be in the form of particles, but a continuous material.

The porous materials may allow gases and fluids to slowly flow throughout the porous material via the interconnected channels, being exposed to the high surface area of the porous material. The porous materials can therefore serve as an excellent carrier material for embedding particles in which high surface area exposure is desirable, such as catalytic nanoparticles, as described below.

### Production of Porous Materials for Use in “Nano-On-Nano-in-Micro” Particles (“NNiM” Particles)

A catalyst or PNA material may be formed using a porous material. This porous material includes, for example, nanoparticles embedded within the porous structure of the material. This can include nano-on-nano particles (composite nanoparticles) embedded into a porous carrier formed around the nano-on-nano particles. Nanoparticles embedded in a porous carrier can refer to the configuration of the nanoparticles in the porous carrier resulting when the porous carrier is formed around the nanoparticles, generally by using the methods described herein. That is, the resulting structure contains nanoparticles with a scaffolding of porous carrier built up around or surrounding the nanoparticles. The porous carrier encompasses the nanoparticles, while at the same time, by virtue of its porosity, the porous carrier permits external gases to contact the embedded nanoparticles.

PNA nano-on-nano particles can be produced, where the PGM can comprise palladium, ruthenium, or ruthenium oxide, and the support nanoparticles can comprise cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide. Oxidative nano-on-nano particles can be produced, where the catalytic nanoparticle can comprise platinum, palladium, or platinum/palladium alloy, and the support nanoparticle can comprise aluminum oxide. Reductive nano-on-nano particles can be produced, where the catalytic nanoparticle can comprise rhodium, and the support nanoparticle can comprise cerium oxide. The support nanoparticle can comprise cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide.

In some embodiments, the porous structure comprises alumina or cerium oxide. In some embodiments, the cerium oxide can include zirconium oxide, lanthanum, lanthanum oxide, yttrium oxide or a combination thereof. In some embodiments, the nano-sized cerium oxide particles contain 40-90 wt %/o cerium oxide, 5-60 wt %, zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

The porous materials with embedded nano-on-nano particles within the porous structure of the material, where the porous structure comprises alumina, or where the porous structure comprises ceria, or where the porous structure comprises cerium-zirconium oxide, cerium-zirconium-lanthanum oxide, or cerium-zirconium-lanthanum-yttrium oxide, can be prepared as follows. Alumina porous structures may be formed, for example, by the methods described in U.S. Pat. No. 3,520,654, the disclosure of which is hereby incorporated by reference in its entirety. In some embodiments, a sodium aluminate solution, prepared by dissolving sodium oxide and aluminum oxide in water, can be treated with sulfuric acid or aluminum sulfate to reduce the pH to a range of about 4.5 to about 7. The decrease in pH results in a precipitation of porous hydrous alumina which may be spray dried, washed, and flash dried, resulting in a porous alumina material. Optionally, the porous alumina material may be stabilized with silica, as described in EP0105435 A2, the disclosure of which is hereby incorporated by reference in its entirety. A sodium aluminate solution can be added to an aluminum sulfate solution, forming a mixture with a pH of about 8.0. An alkaline metal silicate solution, such as a sodium silicate solution, can be slowly added to the mixture, resulting in the precipitation of a silica-stabilized porous alumina material.

A porous material may also be generated by co-precipitating aluminum oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the aluminum oxide nanoparticles to sinter together, resulting in pores throughout the precipitated aluminum oxide where the carbon black once appeared in the structure. In some embodiments, aluminum oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the aluminum oxide nanoparticle suspension. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90.000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide material.

In other embodiments, a porous material may also be generated by co-precipitating cerium oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the cerium oxide nanoparticles to sinter together, resulting in pores throughout the precipitated cerium oxide where the carbon black once appeared in the structure. In some embodiments, cerium oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the cerium oxide nanoparticle suspension. Carbon black with an average grain size ranging from about 1 nm to about 200 nm, or about 20 nm to about 100 nm, or about 20 nm to about 50 nm, or about 35 nm, may be added to the cerium oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90,000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the cerium oxide nanoparticles sinter together, yielding a porous cerium oxide material.

In some embodiments, a porous material may be made using the sol-gel process. For example, a sol-gel precursor to an alumina porous material may be formed by reacting aluminum chloride with propylene oxide. Propylene oxide can be added to a solution of aluminum chloride dissolved in a mixture of ethanol and water, which forms a porous material that may be dried and calcined. In some embodiments, epichlorohydrin may be used in place of propylene oxide. As another example, a sol-gel precursor to a ceria porous material may be formed by reacting cerium nitrate with resorcinol and formaldehyde. Other methods of producing a porous material using the sol-gel method known in the art may also be used, for example, a porous material formed using the sol-gel process may be also be formed using tetraethyl orthosilicate.

In some embodiments, the porous material may be formed by mixing the precursors of a combustible gel with the precursors of a metal oxide material prior to polymerization of the gel, allowing the polymerization of the gel, drying the composite material, and calcining the composite material, thereby exhausting the organic gel components. In some embodiments, a gel activation solution comprising a mixture of formaldehyde and propylene oxide can be mixed with a gel monomer solution comprising a mixture of aluminum chloride and resorcinol. Upon mixing of the gel activation solution and the gel monomer solution, a combustible organic gel component forms as a result of the mixing of formaldehyde and resorcinol, and a non-combustible inorganic metal oxide material forms as a result of mixing the propylene oxide and aluminum chloride. The resulting composite material can be dried and calcined, causing the combustible organic gel component to burn away, resulting in a porous metal oxide material (aluminum oxide). In another embodiment, a solution of formaldehyde can be reacted with a solution of resorcinol and cerium nitrate. The resulting material can be dried and calcined, causing the combustible organic gel component to burn away, resulting in a porous metal oxide material (cerium oxide). The resulting material can be dried and calcined, causing the combustible organic gel component to burn away, resulting in a porous metal oxide material (cerium oxide). In yet further embodiments, a solution of formaldehyde can be reacted with a solution of resorcinol, cerium nitrate, and one or more of zirconium oxynitrate, lanthanum acetate, and/or yttrium nitrate as appropriate to form cerium-zirconium oxide, cerium-zirconium-lanthanum oxide, or cerium-zirconium-lanthanum-yttrium oxide. The resulting material can be dried and calcined, causing the combustible organic gel component to burn away, resulting in a porous metal oxide material (cerium-zirconium oxide, cerium-zirconium-lanthanum oxide, or cerium-zirconium-lanthanum-yttrium oxide).

In some embodiments, the gel activation solution may be prepared by mixing aqueous formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the gel activation solution, a gel monomer solution may be produced by dissolving aluminum chloride in a mixture of resorcinol and ethanol. Resorcinol can be added at a range of about 2 wt % to about 10 wt %, with about 5 wt % being a typical value. Aluminum chloride can be added at a range of about 0.8 wt % to about 5 wt %/o, with about 1.6 wt % being a typical value.

The gel activation solution and gel monomer solution can be mixed together at a ratio at about 1:1 in terms of (weight of gel activation solution):(weight of gel monomer solution). The final mixture may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere, for about 12 hours to about 2 days, or about 16 hours to about 24 hours) to burn off the combustible organic gel component and yield a porous aluminum oxide carrier.

Gel monomer solutions can be prepared with cerium nitrate, zirconium oxynitrate, lanthanum acetate, and/or yttrium nitrate in a process similar to that described above, for preparation of porous cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide carrier.

The porous materials prepared above are then ground or milled into micron-sized particles.

Nano-on-nano-in-micro (“NNiM”™) materials are prepared by mixing nano-on-nano (NN) particles into the precursors to the porous materials, for example, by using a portion of NN particles when mixing together nanoparticles with amorphous carbon, or by mixing NN particles into the sol-gel solution, followed by preparation of the porous material as described above. After grinding or milling the porous material with embedded NN particles into micron-sized particles (to form “NNiM”™ materials), the resulting material can then be used in an oxidative washcoat, a reductive washcoat, a PNA washcoat, or a combined washcoat of any of the oxidative, reductive, and PNA washcoats. The amount of NN particles added is guided by the desired loading of PGM metal in the final NNiM material.

Oxidative NNiM material can be formed, where the nano-on-nano composite nanoparticles comprise a platinum catalytic nanoparticle disposed on an aluminum oxide support particle; where the nano-on-nano composite nanoparticles comprise a palladium catalytic nanoparticle disposed on an aluminum oxide support particle; or where the nano-on-nano composite nanoparticles comprise a platinum/palladium alloy catalytic nanoparticle disposed on an aluminum oxide support particle; and one or more of those NN particles is then embedded in a porous carrier formed of aluminum oxide, which is ground or milled into micron-sized particles. Reductive NNiM material can be formed, where the nano-on-nano composite nanoparticles comprise a rhodium catalytic nanoparticle disposed on a cerium oxide support particle; where the nano-on-nano composite nanoparticles comprise a rhodium catalytic nanoparticle disposed on a cerium-zirconium oxide support particle; where the nano-on-nano composite nanoparticles comprise a rhodium catalytic nanoparticle disposed on a cerium-zirconium-lanthanum oxide support particle; or where the nano-on-nano composite nanoparticles comprise a rhodium catalytic nanoparticle disposed on a cerium-zirconium-lanthanum-yttrium oxide support particle; and one or more of those NN particles is then embedded in a porous carrier formed of porous cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide carrier, which is ground or milled into micron-sized particles. PNA NNiM material can be formed, where the nano-on-nano composite nanoparticles comprise a palladium nanoparticle disposed on a cerium oxide support particle; where the nano-on-nano composite nanoparticles comprise a palladium nanoparticle disposed on a cerium-zirconium oxide support particle; where the nano-on-nano composite nanoparticles comprise a palladium nanoparticle disposed on a cerium-zirconium-lanthanum oxide support particle; or where the nano-on-nano composite nanoparticles comprise a palladium nanoparticle disposed on a cerium-zirconium-lanthanum-yttrium oxide support particle; and one or more of those NN particles is then embedded in a porous carrier formed of aluminum oxide, cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide, which is ground or milled into micron-sized particles. PNA NNiM material can be formed, where the nano-on-nano composite nanoparticles comprise a ruthenium or ruthenium oxide nanoparticle disposed on a cerium oxide support particle; where the nano-on-nano composite nanoparticles comprise a ruthenium or ruthenium oxide nanoparticle disposed on a cerium-zirconium oxide support particle; where the nano-on-nano composite nanoparticles comprise a ruthenium or ruthenium oxide nanoparticle disposed on a cerium-zirconium-lanthanum oxide support particle; or where the nano-on-nano composite nanoparticles comprise a ruthenium or ruthenium oxide nanoparticle disposed on a cerium-zirconium-lanthanum-yttrium oxide support particle; and one or more of those NN particles is then embedded in a porous carrier formed of aluminum oxide, cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide, which is ground or milled into micron-sized particles Aluminum oxide porous material can also be used as the porous material in which any of the foregoing rhodium-containing composite NN nanoparticles can be embedded. The weight ratios of the NN particles used can be those described in the above NNm section. For example, the weight ratio of nano-sized Pd, Ru, or ruthenium oxide:nano-sized cerium oxide can be from 1%:99% to 40%:60%, from 5%:95% to 20%:80%, from 8%:92% to 12%:88%, from 9%:91% to 11%:89%, and 10%:90%.

### Micron-Sized Particles Comprising Composite Nanoparticles and a Porous Carrier (“Nano-on-Nano-in-Micro” Particles or “NNiM” Particles)

Nanoparticles or composite nanoparticles produced by plasma production or other methods may be embedded within a porous material to enhance the surface area of catalytic components (this includes PNA components because PNA components include PGM which by its very nature is catalytic). The porous material may then serve as a carrier for the composite nanoparticles, allowing gasses and fluids to slowly flow throughout the porous material via the interconnected channels. The high porosity of the carrier results in a high surface area within the carrier allowing increased contact of the gasses and fluids with the embedded catalytic components, such as composite nanoparticles. Embedding the composite nanoparticles within the porous carrier results in a distinct advantage over those technologies where catalytic nanoparticles are positioned on the surface of carrier micro-particles or do not penetrate as effectively into the pores of the support. When catalytic nanoparticles are position on the surface of carrier micro-particles, some catalytic nanoparticles can become buried by other catalytic nanoparticles, causing them to be inaccessible to target gases because of the limited exposed surface area. When the composite nanoparticles are embedded within the porous carrier, however, gases can flow through the pores of the carrier to catalytic components.

The porous carrier may contain any large number of interconnected pores, holes, channels, or pits, preferably with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous carrier has a mean pore, hole, channel, or pit width (diameter) of less than about 1 nm, while in some embodiments, a porous carrier has a mean pore, hole, channel, or pit width (diameter) of greater than about 100 nm. In some embodiments, a porous material has an average pore surface area in a range of about 50 m²/g to about 500 m²/g. In some embodiments, a porous material has an average pore surface area in a range of about 100 m²/g to about 400 m²/g. In some embodiments, a porous material has an average pore surface area in a range of about 150 m²/g to about 300 m²/g. In some embodiments, a porous material has an average pore surface area of less than about 50 m²/g. In some embodiments, a porous material has an average pore surface area of greater than about 200 m²/g. In some embodiments, a porous material has an average pore surface area of greater than about 300 m²/g. In some embodiments, a porous material has an average pore surface area of about 200 m²/g. In some embodiments, a porous material has an average pore surface area of about 300 m²/g.

A porous carrier embedded with nanoparticles can be formed with any porous material. A porous carrier may include, but is not limited to, any gel produced by the sol-gel method, for example, alumina (Al₂O₃), cerium oxide, or silica aerogels as described herein. In some embodiments, the porous carrier may comprise a porous metal oxide, such as aluminum oxide or cerium oxide. In some embodiments, a porous carrier may comprise an organic polymer, such as polymerized resorcinol. In some embodiments, the porous carrier may comprise amorphous carbon. In some embodiments, the porous carrier may comprise silica. In some embodiments, a porous carrier may be porous ceramic. In some embodiments, the porous carrier may comprise a mixture of two or more different types of interspersed porous materials, for example, a mixture of aluminum oxide and polymerized resorcinol.

In some embodiments, a carrier may comprise a combustible component, for example amorphous carbon or a polymerized organic gel such as polymerized resorcinol, and a non-combustible component, for example a metal oxide such as aluminum oxide. A catalytic material can include composite nanoparticles embedded in a carrier comprising a combustible component and a non-combustible component.

Catalytic and/or PNA particles, such as the catalytic nanoparticles or catalytic and/or PNA composite nanoparticles described herein, are embedded within the porous carrier. This can be accomplished by including the catalytic and/or PNA particles in the mixture used to form the porous carrier. In some embodiments, the catalytic and/or PNA particles are evenly distributed throughout the porous carrier. In other embodiments, the catalytic and/or PNA particles are clustered throughout the porous carrier. In some embodiments, platinum group metals comprise about 0.001 wt % to about 10 wt % of the total catalytic and/or PNA material (catalytic and/or PNA particles and porous carrier). For example, platinum group metals may comprise about 1 wt % to about 8 wt % of the total catalytic and/or PNA material (catalytic and/or PNA particles and porous carrier). In some embodiments, platinum group metals may comprise less than about 10 wt %, less than about 8 wt %, less than about 6 wt %, less than about 4 wt %, less than about 2 wt %, or less than about 1 wt % of the total catalytic and/or PNA material (catalytic and/or PNA particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total catalytic and/or PNA material (catalytic and/or PNA particles and porous carrier).

In some embodiments, the catalytic and/or PNA nanoparticles comprise one or more platinum group metals. In embodiments with two or more platinum group metals, the metals may be in any ratio. In some embodiments, the catalytic nanoparticles comprise platinum group metal or metals, such as Pt:Pd in about a 2:1 ratio to about 100:1 ratio by weight, or about 2:1 to about 75:1 ratio by weight, or about 2:1 to about 50:1 ratio by weight, or about 2:1 to about 25:1 ratio by weight, or about 2:1 to about 15:1 ratio by weight. In one embodiment, the catalytic nanoparticles comprise platinum group metal or metals, such as Pt:Pd in about 2:1 ratio by weight.

The composite nanoparticles (nano-on-nano particles) embedded within a porous carrier may take the form of a powder to produce composite catalytic micro-particles, referred to as “nano-on-nano-in-micron” particles or “NNiM” particles. In typical NNiM particles, a porous material (or matrix) may be formed around and surround nanoparticles or composite nanoparticle produced by plasma production or other methods. The porous material can bridge together the surrounded nanoparticles or composite nanoparticles, thereby embedding the particles within the matrix. The porous material may then serve as a carrier for the composite nanoparticles, allowing gases and fluids to slowly flow throughout the porous material (i.e., the interconnected bridges) via the interconnected channels. The high porosity of the carrier results in a high surface area within the carrier allowing increased contact of the gases and fluids with the contained catalytic components, such as composite nanoparticles.

The micron-sized NNiM particles can have an average size between about 1 micron and about 100 microns, such as between about 1 micron and about 10 microns, between about 3 microns and about 7 microns, or between about 4 microns and about 6 microns. The PGM particles may comprise about 0.001 wt % to about 10 wt % of the total mass of the NNiM particle (catalytic and/or PNA particles and porous carrier). For example, platinum group metals may comprise about 1 wt % to about 8 wt % of the total mass of the NNiM particle (catalytic and/or PNA particles and porous carrier). In some embodiments, platinum group metals may comprise less than about 10 wt %, less than about 8 wt %, less than about 6 wt %, less than about 4 wt %, less than about 2 wt %, or less than about 1 wt % of the total mass of the NNiM particle (catalytic and/or PNA particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total mass of the NNiM particle (catalytic and/or PNA particles and porous carrier).

NNiM particles may be used for any catalytic purpose or NOₓ storage purpose. For example, NNiM particles may be suspended in a liquid, for example ethanol or water, which may catalyze dissolved compounds. Alternatively, the NNiM particles may be used as a solid state catalyst. For example, the NNiM particles can then be used in catalytic converters.

### Production of Micron-Sized Particles Comprising Composite Nanoparticles and a Porous Carrier (“Nano-On-Nano-in-Micro” Particles or “NNiM” Particles)

In some embodiments, catalytic nanoparticles or composite nanoparticles can be embedded in a porous carrier by forming a suspension or colloid of nanoparticles, and mixing the suspension or colloid of nanoparticles with a porous material precursor solution. Upon solidification of the porous material with the mixture, such as by polymerization, precipitation, or freeze-drying, the porous material will form around the nanoparticles, resulting in a catalytic material comprising nanoparticles embedded in a porous carrier. In some embodiments, the catalytic and/or PNA material is then processed, such as by grinding or milling, into a micron-sized powder, resulting in NNiM particles.

Described below is the production of NNiM particles using a porous aluminum oxide carrier formed using a composite carrier comprising a combustible organic gel component and an aluminum oxide component, followed by drying and calcination. However, one skilled in the art would understand any manner of porous carrier (such as cerium oxide) originating from soluble precursors may be used to produce catalytic (including PNA) material comprising composite nanoparticles embedded within a porous carrier using the methods described herein.

For typical NNiM particles produced using a porous aluminum oxide carrier formed using a composite carrier comprising a combustible organic gel component and an aluminum oxide component, the composite nanoparticles are initially dispersed in ethanol. In some embodiments, at least 95 vol % ethanol is used. In some embodiments, at least 99 vol % ethanol is used. In some embodiments, at least 99.9 vol % ethanol is used. Dispersants, surfactants, or mixtures thereof are typically added to the ethanol before suspension of the composite nanoparticles. A suitable surfactant includes DisperBYK®-145 from BYK-Chemie GmbH LLC, Wesel, which can be added in a range of about 2 wt % to about 12 wt %, with about 7 wt % being a typical value, and dodecylamine, which can be added in a range of about 0.25 wt % to about 3 wt %, with about 1 wt % being a typical value. Preferably, both DisperBYK®-145 and dodecylamine are used at about 7 wt % and 1 wt %, respectively. In some embodiments, the mixture of ethanol, composite nanoparticles, and surfactants, dispersants, or mixtures thereof is sonicated to uniformly disperse the composite nanoparticles. The quantity of composite nanoparticles particles in the dispersion may be in the range of about 5 wt % to about 20 wt %.

Separately from the composite nanoparticle suspension, a gel activation solution is prepared by mixing formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde solution can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the composite nanoparticle suspension and gel activation solution, an aluminum chloride solution is produced by dissolving aluminum chloride in a mixture of resorcinol and ethanol. Resorcinol can be added at a range of about 10 wt % to about 30 wt %, with about 23 wt % being a typical value. Aluminum chloride can be added at a range of about 2 wt % to about 12 wt %, with about 7 wt % being a typical value.

The composite nanoparticle suspension, gel activation solution, and aluminum chloride solution can be mixed together at a ratio from of about 100:10:10 to about 100:40:40, or about 100:20:20 to about 100:30:30, or about 100:25:25, in terms of (weight of composite nanoparticle suspension):(weight of gel activation solution):(weight of aluminum chloride solution). The final mixture will begin to polymerize into a carrier embedded with composite nanoparticles. The carrier comprises a combustible component, an organic gel, and a non-combustible component, aluminum oxide. The resulting carrier may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the resulting carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon), to yield a porous carrier comprising composite catalytic nanoparticles and aluminate. When the composite carrier is calcined under ambient atmosphere or other oxygenated conditions, organic material, such as polymerized resorcinol, formaldehyde, or propylene oxide, is burnt off, resulting in a substantially pure aluminum oxide porous carrier embedded with composite nanoparticles. If the composite carrier is calcined under an inert atmosphere, such as argon or nitrogen, the organic materials may become substantially porous amorphous carbon interspersed with the porous aluminum oxide embedded with composite nanoparticles. The resulting porous carrier can be processed, such as by grinding or milling, into a micro-sized powder of NNiM particles.

In another embodiment, a composite catalytic nanoparticles may be mixed with a dispersion comprising metal oxide nanoparticles, such as aluminum oxide nanoparticles, and amorphous carbon, such as carbon black. The dispersed solid particles from resulting dispersed colloid may be separated from the liquid by co-precipitation, dried, and calcined. Upon calcination of the solid material in an ambient or oxygenated environment, the amorphous carbon is exhausted. Simultaneously, the heat from the calcination process causes the aluminum oxide nanoparticles to sinter together, resulting in pores throughout the precipitated aluminum oxide.

In some embodiments, aluminum oxide nanoparticles can be suspended in ethanol, water, or a mix of ethanol and water. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. Composite nanoparticles may be mixed into the dispersion comprising aluminum oxide nanoparticles and carbon black. In some embodiments, the composite nanoparticles are dispersed in a separate colloid, optionally with dispersants or surfactants, before being mixed with the dispersion comprising aluminum oxide nanoparticles and carbon black. The pH of the resulting mixture can be adjusted to a range of about 2 to about 7, such as a pH of between about 3 and about 5, preferably a pH of about 4, allowing the particles to precipitate. The precipitant can be dried (for example, at about 30° C. to about 95° C., preferably about 50° C. to about 70° C., at atmospheric pressure or at reduced pressure such as from about 1 pascal to about 90.000 pascal, for about one day to about 5 days, or for about 2 days to about 3 days). After drying, the carrier may then be calcined (at elevated temperatures, such as from 400° C. to about 700° C., preferably about 500° C. to about 600° C. more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide carrier embedded with composite nanoparticles.

The resulting carrier may be further processed, for example by grinding or milling, into micron-sized NNiM particles.

NNm™ and NNiM Particles with Inhibited Migration of Platinum Grout Metals

The NNm™ particles including micron-sized carrier particle bearing composite nanoparticles, where the composite nanoparticles are produced by methods described herein, are particularly advantageous for use in catalytic converter applications. The NNiM particles, including those made using a porous carrier and composite nanoparticles, where the carrier is produced by methods described herein and composite nanoparticles produced under reducing conditions, are also particularly advantageous for use in catalytic converter applications. The platinum group metal of the catalytic and/or PNA nanoparticle has a greater affinity for the partially reduced surface of the support nanoparticle than for the surface of the micron-sized carrier particles. Thus, at elevated temperatures, neighboring PGM nanoparticles bound to neighboring support nano-particles are less likely to migrate on the micron-sized carrier particle surface and agglomerate into larger catalyst and/or PNA clumps. Since the larger agglomerations of catalyst and/or PNA have less surface area and are less effective as catalysts and NOₓ adsorbers, the inhibition of migration and agglomeration provides a significant advantage for the NNm™ and NNiM particles. In contrast, PGM particles deposited solely by wet-chemical precipitation onto alumina support demonstrate higher mobility and migration, forming agglomerations of PGM and leading to decreased catalytic efficacy over time (that is, catalyst aging).

### PNA Material

A PNA material is a material that holds NOₓ gases during low temperature engine operation and releases the gases when the temperature rises to a threshold temperature. PNA material can be made up of a single type of particle or multiple types of particles. PNA material can also refer to a PNA washcoat composition or a PNA layer on a substrate.

The PNA material can comprise PGM on support particles; alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of PGM on support particles; alkali oxides and alkaline earth oxides on support particles; and alkali oxides and alkaline earth oxides and PGM on support particles in any ratio can be employed. These PGM particles can refer to any of the above mentioned catalytic particles.

The alkali oxides or alkaline earth oxides can include, for example, magnesium oxide, calcium oxide, manganese oxide, barium oxide, and strontium oxide. The PGM can include, for example, palladium, ruthenium, or mixtures thereof. In addition, the PGM can include their oxides, such as ruthenium oxide.

In some embodiments, the PNA material can comprise palladium on support particles; ruthenium or ruthenium oxide on support particles; manganese oxide (preferably Mn₃O₄) on support particles; magnesium oxide on support particles; calcium oxide on support particles; a combination of manganese oxide on support particles and magnesium oxide on support particles in any ratio; a combination of manganese oxide on support particles and calcium oxide on support particles in any ratio; a combination of magnesium oxide on support particles and calcium oxide on support particles in any ratio; or a combination of manganese oxide on support particles, magnesium oxide on support particles, and calcium oxide on support particles in any ratio. Other embodiments include PNA material comprising a combination of manganese oxide on support particles and PGM on support particles in any ratio; a combination of magnesium oxide on support particles and PGM on support particles in any ratio; a combination of calcium oxide on support particles and PGM on support particles in any ratio; a combination of manganese oxide on support particles, magnesium oxide on support particles, and PGM on support particles in any ratio; a combination of manganese oxide on support particles, calcium oxide on support particles, and PGM on support particles in any ratio; a combination of magnesium oxide on support particles, calcium oxide on support particles, and PGM on support particles in any ratio; or a combination of manganese oxide on support particles, magnesium oxide on support particles, calcium oxide on support particles, and PGM on support particles in any ratio.

Support particles can include, for example, bulk refractory oxides such as alumina or cerium oxide. The cerium oxide particles may further comprise zirconium oxide. The cerium oxide particles may further comprise lanthanum and/or lanthanum oxide. In addition, the cerium oxide particles may further comprise both zirconium oxide and lanthanum oxide. In some embodiments, the cerium oxide particles may further comprise yttrium oxide. Accordingly, the cerium oxide particles can be cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide particles, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

The support particles can be micron-sized, nano-sized, or a mixture thereof. An example of micron-sized support particles include micron-sized cerium oxide particles including, but not limited to, HSA5, HSA20, or a mixture thereof from Rhodia-Solvay.

In some embodiments, the support particles may include PGM, alkali oxides, and/or alkaline earth oxides. For example, the micron-sized cerium oxide particles may include palladium, ruthenium, or a mixture thereof in addition to alkali oxide or alkaline earth oxide or mixtures thereof.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

The PNA materials are adsorbers that hold NOₓ compounds during low temperature engine operation. These gases are then released and reduced by the catalysts during high temperature engine operation. During low temperature engine operation, PNA particles physisorbs the NOₓ via non-covalent adsorption. Subsequently, during high temperature engine operation, the NOₓ sharply releases from the PNA particles. In this way, the released NOₓ can then be reduced to the benign gases N₂ and H₂O.

### PGM, Alkali Oxide, and Alkaline Earth Oxide Nanoparticles and Micron-Particles

Alkali oxide, alkaline earth oxide, and PGM nanoparticles may be included in a catalytic layer (such as an oxidative washcoat layer and/or a reductive washcoat layer), a PNA layer, a zeolite layer, or any combination of the catalytic layer (including an oxidative layer or a reductive layer), PNA, and zeolite washcoat layers. As an alternative embodiment, micron-sized alkali oxide, alkaline earth oxide, and PGM particles may be included in any combination of the oxidative, reductive, PNA, and zeolite washcoat layers. In another alternative embodiment, both nanoparticles and micron particles of alkali oxide, alkaline earth oxide, and PGM may be included in any combination of the oxidative, reductive, PNA, and zeolite washcoat layers.

Alkali oxides, alkaline earth oxides, and PGM particles are adsorbers that hold NOₓ compounds during low temperature engine operation. The NOₓ compounds are then released and reduced by catalysts during high temperature engine operation. The temperature at which the NOₓ compounds are released varies depending on the oxide, PGM, combination of oxides, or combination of oxides and PGM, among other factors. For example, alkali oxides or alkaline earth oxides can be used to release NOₓ compounds at temperatures lower than PGM particles. In addition, the alkali oxides or alkaline earth oxides can be magnesium oxide, calcium oxide, manganese oxide, barium oxide, and/or strontium oxide. Furthermore, the PGM can be palladium, ruthenium, or mixtures thereof. When used alone or in combination with other NOₓ adsorbing materials, such as those described herein, the amount of PGM needed to store NOₓ gases can be substantially reduced or even eliminated.

Alkali oxide, alkaline earth oxide, and PGM nanoparticles and micron particles on support particles may be produced via wet chemistry techniques or by the plasma-based methods described above. The PNA nanoparticles can include the composite nanoparticles described above. As such, the alkali oxide, alkaline earth oxide, and PGM nanoparticles on support particles can include PNA nano-on-nano particles, PNA NNm particles, PNA NNiM particles, or PNA hybrid NNm/wet-chemistry particles described above.

In some embodiments, the alkali oxide, alkaline earth oxide, and PGM nanoparticles have an average diameter of approximately 20 nm or less, or approximately 15 nm or less, or approximately 10 nm or less, or approximately 5 nm or less, or between approximately 1 nm and approximately 20 nm, that is, approximately 10.5 nm±9.5 nm, or between approximately 1 nm and approximately 15 nm, that is, approximately 8 nm±7 nm, or between approximately 1 nm and approximately 10 nm, that is, approximately 5.5 nm±4.5 nm, or between approximately 1 nm and approximately 5 nm, that is, approximately 3 nm±2 nm. In some embodiments, the alkali oxide, alkaline earth oxide, and PGM nanoparticles have a diameter of approximately 20 nm or less, or approximately 15 nm or less, or approximately 10 nm or less, or approximately 5 nm or less, or between approximately 1 nm and approximately 10 nm, that is, approximately 5.5 nm±4.5 nm, or between approximately 1 nm and approximately 5 nm, that is, approximately 3 nm±2 nm.

In some embodiments, the alkali oxide, alkaline earth oxide, and PGM micron particles may have an average diameter of approximately 10 μm or less, or approximately 8 μm or less, or approximately 5 μm or less, or approximately 2 μm or less, or approximately 1.5 μm or less, or approximately 1 μm or less, or approximately 0.5 μm or less. In some embodiments, the alkali oxide, alkaline earth oxide, and PGM micron particles have an average diameter between approximately 6 μm and approximately 10 μm, that is, approximately 8 μm±2 μm, or between approximately 7 μm and approximately 9 μm, that is, approximately 8 μm±1 μm. In some embodiments, the alkali oxide, alkaline earth oxide, and PGM micron particles have an average diameter between approximately 0.5 μm and approximately 2 μm, that is, approximately 1.25 μm±0.75 μm, or between approximately 1.0 μm and approximately 1.5 μm, that is, approximately 1.25 μm±0.25 μm.

The alkali oxide, alkaline earth oxide, and PGM particles can be applied to support particles by any of the processes described above with respect to applying nanoparticles to support and/or carrier particles including wet chemistry, incipient wetness, and plasma nano-on-nano methods. These support particles can be nano-sized or micron-sized. In addition, these support particles can be, for example, refractory oxides including cerium oxide. As discussed above, the cerium oxide particles may contain zirconium oxide, lanthanum, lanthanum oxide, yttrium oxide, or a combination thereof.

In one embodiment, the oxide and PGM nanoparticles can be impregnated into micron-sized cerium oxide supports. The procedure for impregnating these supports may be similar to the process described above with respect to impregnating the composite nanoparticles into micron-sized cerium oxide supports. One of ordinary skill in the art would understand that the support particles can be impregnated one at a time or simultaneously co-impregnated with the alkali and/or alkaline earth oxides and PGM. In some embodiments, the alkali oxide, alkaline earth oxide, and PGM nanoparticles on supports can be prepared by applying a dispersion of alkali oxide, alkaline earth oxide, or PGM nanoparticles to porous, micron-sized cerium oxide, as described with respect to incipient wetness techniques described above, including subsequent drying and calcination. In some embodiments, the alkali oxide, alkaline earth oxide, and PGM nanoparticles on supports can be prepared using wet chemistry techniques described above, including subsequent drying and calcination. The porous, micron-sized cerium oxide powders may contain zirconium oxide, lanthanum, yttrium oxide, and/or lanthanum oxide. In some embodiments, the cerium oxide is substantially free of zirconium oxide. In other embodiments, the cerium oxide contains up to 50 mole % zirconium oxide (at exactly 50 mole %, the material is cerium-zirconium oxide, CeZrO₄). One commercial cerium oxide powder suitable for use is HSA5, HSA20, or a mixture thereof. These nanoparticles may also be impregnated into micron-sized aluminum oxide supports.

In one embodiment, palladium is used in an amount of from about 0.01% to about 5% (by weight) of the amount of cerium oxide used in the PNA material (i.e., composition). (As described above, in all embodiments, the cerium oxide can include zirconium oxide, lanthanum, lanthanum oxide, yttrium oxide, or a combination thereof). In one embodiment, palladium is used in an amount of from about 0.5% to about 3% (by weight) of the amount of cerium oxide used in the PNA material. In one embodiment, palladium is used in an amount of from about 0.67% to about 2.67% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment. Pd is used in an amount of from about 1.5% to about 2.5% (by weight) of the amount of cerium oxide used in the PNA material, and the amount of cerium oxide used is from about 100 g/L to about 200 g/L. In another embodiment, Pd is used in an amount of from about 0.5% to about 1.5% (by weight) of the amount of cerium oxide used in the PNA material, and the amount of cerium oxide used is from about 250 g/L to about 350 g/L. In another embodiment, Pd is used in an amount of from about 1% to about 2% (by weight) of the amount of cerium oxide used in the PNA material, and the amount of cerium oxide used is greater than or equal to about 150 g/L. In another embodiment, Pd is used in an amount of about 2% (by weight) of the amount of cerium oxide used in the PNA material, and the amount of cerium oxide used is greater than or equal to about 150 g/L. In another embodiment, Pd is used in an amount of about 1% (by weight) of the amount of cerium oxide used in the PNA material, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA material is from about 100 g/L to about 350 g/L. In another embodiment. Pd is used in an amount of about 2 g/L to about 4 g/L. and the amount of cerium oxide used in the PNA material is from about 100 g/L to about 350 g/L. In another embodiment, Pd is used in an amount of about 3 g/L, and the amount of cerium oxide used in the PNA material is from about 150 g/L to about 300 g/L. In another embodiment, Pd is used in an amount of about 1 g/L to about 5 g/L, and the amount of cerium oxide used in the PNA material is from greater than or equal to about 150 g/L. In another embodiment, Pd is used in an amount of about 2 g/L to about 4 g/L, and the amount of cerium oxide used in the PNA material is from greater than or equal to about 150 g/L. In another embodiment, Pd is used in an amount of about 3 g/L, and the amount of cerium oxide used in the PNA material is from greater than or equal to about 150 g/L. The PNA material can include Pd in larger (cooler) engine systems (e.g., greater than 2.5 Liters).

In one embodiment, ruthenium is used in an amount of from about 0.01% to about 15% (by weight) of the amount of cerium oxide used in the PNA material (i.e., composition). (As described above, in all embodiments, the cerium oxide can include zirconium oxide, lanthanum, lanthanum oxide, yttrium oxide, or a combination thereof). In one embodiment, ruthenium is used in an amount of from about 0.5% to about 12% (by weight) of the amount of cerium oxide used in the PNA material. In one embodiment, ruthenium is used in an amount of from about 1% to about 10% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment, the amount of cerium oxide used in the PNA material is greater than or equal to about 300 g/L. In another embodiment. Ru is used in an amount of from about 3% to about 4.5% (by weight) of the amount of cerium oxide used in the PNA material, and the amount of cerium oxide used is from about 100 g/L to about 200 g/L. In another embodiment. Ru is used in an amount of from about 1% to about 2.5% (by weight) of the amount of cerium oxide used in the PNA material, and the amount of cerium oxide used is from about 250 g/L to about 350 g/L. In another embodiment, Ru is used in an amount of from about 1.67% to about 4% (by weight) of the amount of cerium oxide used in the PNA material, and the amount of cerium oxide used is greater than or equal to about 150 g/L. In another embodiment, Ru is used in an amount of from about 1.67% to about 4% (by weight) of the amount of cerium oxide used in the PNA material, and the amount of cerium oxide used is greater than or equal to about 300 g/L. In another embodiment, Ru is used in an amount of about 3.33% to about 4% (by weight) of the amount of cerium oxide used in the PNA material, and the amount of cerium oxide used is greater than or equal to about 150 g/L. In another embodiment, Ru is used in an amount of about 1.67% to about 2% (by weight) of the amount of cerium oxide used in the PNA material, and the amount of cerium oxide used is greater than or equal to about 300 g/L. In another embodiment. Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment. Ru is used in an amount of about 1 g/L to about 20 g/L, and the amount of cerium oxide used in the PNA material is from about 100 g/L to about 350 g/L. In another embodiment, Ru is used in an amount of about 3 g/L to about 15 g/L, and the amount of cerium oxide used in the PNA material is from about 100 g/L to about 350 g/L. In another embodiment, Ru is used in an amount of about 4 g/L to about 8 g/L, and the amount of cerium oxide used in the PNA material is from about 100 g/L to about 350 g/L. In another embodiment, Ru is used in an amount of about 5 g/L to about 6 g/L, and the amount of cerium oxide used in the PNA material is from about 150 g/L to about 350 g/L. In another embodiment, Ru is used in an amount of about 1 g/L to about 20 g/L, and the amount of cerium oxide used in the PNA material is from greater than or equal to about 150 g/L. In another embodiment, Ru is used in an amount of about 3 g/L to about 15 g/L, and the amount of cerium oxide used in the PNA material is from greater than or equal to about 150 g/L. In another embodiment, Ru is used in an amount of about 4 g/L to about 8 g/L, and the amount of cerium oxide used in the PNA material is from greater than or equal to about 150 g/L. In another embodiment, Ru is used in an amount of about 5 g/L to about 6 g/L, and the amount of cerium oxide used in the PNA material is from greater than or equal to about 150 g/L. In another embodiment, Ru is used in an amount of about 1 g/L to about 20 g/L, and the amount of cerium oxide used in the PNA material is from greater than or equal to about 300 g/L. In another embodiment. Ru is used in an amount of about 3 g/L to about 15 g/L, and the amount of cerium oxide used in the PNA material is from greater than or equal to about 300 g/L. In another embodiment, Ru is used in an amount of about 4 g/L to about 8 g/L, and the amount of cerium oxide used in the PNA material is from greater than or equal to about 300 g/L. In another embodiment, Ru is used in an amount of about 5 g/L to about 6 g/L, and the amount of cerium oxide used in the PNA material is from greater than or equal to about 300 g/L. The PNA material can include Ru in small (hotter) engine systems (e.g., less than 2 Liters).

In one embodiment, MgO is used in an amount of from about 1% to about 20% (by weight) of the amount of the cerium oxide used in the PNA material (i.e., composition). In one embodiment, MgO is used in an amount of from about 1% to about 15% (by weight) of the amount of the cerium oxide used in the PNA material. In one embodiment, MgO is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, MgO is used in an amount of from about 2% to about 8% (by weight) of the amount of the cerium oxide used in the PNA material, and the amount of cerium oxide used is from about 150 g/L to about 350 g/L. In another embodiment, MgO is used in an amount of from about 2% to about 4% (by weight) of the amount of the cerium oxide used in the PNA material, and the amount of cerium oxide used is from about 250 g/L to about 350 g/L. In another embodiment, MgO is used in an amount of from about 6% to about 8% (by weight) of the amount of the cerium oxide used in the PNA material, and the amount of cerium oxide used is from about 150 g/L to about 250 g/L. In another embodiment, MgO is used in an amount of about 3% (by weight) of the amount of the cerium oxide used in the PNA material, and the amount of cerium oxide used in the PNA material is about 350 g/L. In another embodiment, MgO is used in an amount of about 7% (by weight) of the amount of the cerium oxide used in the PNA material, and the amount of cerium oxide used is about 150 g/L. In another embodiment, MgO is used in an amount of about 10.5 g/L, and the amount of cerium oxide used in the PNA material is from about 150 g/L to about 350 g/L.

In one embodiment, Mn₃O₄ is used in an amount of from about 1% to about 30% (by weight) of the amount of the cerium oxide used in the PNA material (i.e., composition). In one embodiment, Mn₃O₄ is used in an amount of from about 1% to about 25% (by weight) of the amount of the cerium oxide used in the PNA material. In one embodiment, Mn₃O₄ is used in an amount of from about 1% to about 20% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, Mn₃O₄ is used in an amount of from about 5% to about 20% (by weight) of the amount of the cerium oxide used in the PNA material, and the amount of cerium oxide used is from about 150 g/L to about 350 g/L. In another embodiment, Mn₃O₄ is used in an amount of from about 5% to about 10% (by weight) of the amount of the cerium oxide used in the PNA material, and the amount of cerium oxide used is from about 250 g/L to about 350 g/L. In another embodiment, Mn₃O₄ is used in an amount of from about 15% to about 20% (by weight) of the amount of the cerium oxide used in the PNA material, and the amount of cerium oxide used is from about 150 g/L to about 250 g/L. In another embodiment, Mn₃O₄ is used in an amount of about 8% (by weight) of the amount of the cerium oxide used in the PNA material, and the amount of cerium oxide used is about 350 g/L. In another embodiment, Mn₃O₄ is used in an amount of about 18.67% (by weight) of the amount of the cerium oxide used in the PNA material, and the amount of cerium oxide used is about 150 g/L. In another embodiment, Mn₃O₄ is used in an amount of about 28 g/L, and the amount of cerium oxide used in the PNA material is from about 150 g/L to about 350 g/L.

In one embodiment, calcium oxide is used in an amount of from about 1% to about 20% (by weight) of the amount of the cerium oxide used in the PNA material (i.e., composition). In one embodiment, calcium oxide is used in an amount of from about 1% to about 15% (by weight) of the amount of the cerium oxide used in the PNA material. In one embodiment, calcium oxide is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, calcium oxide is used in an amount of from about 2% to about 8% (by weight) of the amount of the cerium oxide used in the PNA material, and the amount of cerium oxide used is from about 150 g/L to about 350 g/L. In another embodiment, calcium oxide is used in an amount of from about 2% to about 4% (by weight) of the amount of the cerium oxide used in the PNA material, and the amount of cerium oxide used is from about 250 g/L to about 350 g/L. In another embodiment, calcium oxide is used in an amount of from about 6% to about 8% (by weight) of the amount of the cerium oxide used in the PNA material, and the amount of cerium oxide used is from about 150 g/L to about 250 g/L. In another embodiment, calcium oxide is used in an amount of about 3% (by weight) of the amount of the cerium oxide used in the PNA material, and the amount of cerium oxide used is about 350 g/L. In another embodiment, calcium oxide is used in an amount of about 7% (by weight) of the amount of the cerium oxide used in the PNA material, and the amount of cerium oxide used is about 150 g/L. In another embodiment, calcium oxide is used in an amount of about 10.5 g/L, and the amount of cerium oxide used in the PNA material is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the PNA material (i.e., composition) is from about 150 g/L to about 350 g/L.

The PNA material can be used to store NOₓ emissions from ambient temperatures to a variety of operating temperatures. For example, the PNA material can store NOₓ emissions from ambient to about 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C. 240° C., 245° C., 250° C., 255° C., 260° C., 265° C., 270° C. 275° C., 280° C., 285° C., 290° C., 295° C., 300° C., 305° C. 310° C., 315° C., 320° C., 325° C., 330° C., 335° C., 340° C., 345° C., 350° C., 355° C., 375° C., or 400° C.

In one embodiment, palladium based PNA material can be used for storing NOₓ emissions from ambient temperature to greater than or equal to about 200° C. In another embodiment, Pd based PNA material can be used for storing NOₓ emissions from ambient temperature to greater than or equal to about 190° C. In another embodiment. Pd based PNA material can be used for storing NOₓ emissions from ambient temperature to greater than or equal to about 180° C. In another embodiment, Pd based PNA material can be used for storing NOₓ emissions from ambient temperature to greater than or equal to about 170° C. In another embodiment. Pd based PNA material can be used for storing NOₓ emissions from ambient temperature to greater than or equal to about 160° C. In another embodiment, Pd based PNA material can be used for storing NOₓ emissions from ambient temperature to greater than or equal to about 150° C. In another embodiment, Pd based PNA material can be used for storing NOₓ emissions from ambient temperature to greater than or equal to about 140° C. Once the temperature surpasses the upper storage temperature, the PNA material can “cross over” (i.e., can stop adsorbing NOₓ emissions and can start releasing the NOₓ emissions). The cross over range for Pd based PNA material can be from about 130° C. to about 180° C., from about 140° C. to about 170° C., from about 145° C. to about 165° C. or from about 150° C. to about 160° C.

The NOₓ desorption temperature range depends on a variety of factors including the amount of PGM in the PNA material. In one embodiment, the desorption temperature range can be greater than or equal to the cross over temperature. At a certain temperature, the PNA material may no longer be storing any NOₓ emissions. At this point, the PNA material can be said to have fully released all NOₓ emissions. In one embodiment, the full release temperature of the Pd based PNA material is greater than about 150° C. In one embodiment, the full release temperature of the Pd based PNA material is greater than about 200° C. In another embodiment, the full release temperature of the Pd based PNA material is between about 200° C. and about 240° C. In another embodiment, the full release temperature of the Pd based PNA material is about 240° C. In another embodiment, the full release temperature of the Pd based PNA material is greater than about 240° C. In another embodiment, the Pd based PNA material no longer has any NOₓ emissions stored at temperatures greater than or equal to about 200° C. In another embodiment, the Pd based PNA material no longer has any NOₓ emissions stored at temperatures greater than or equal to about 240° C. In another embodiment, the Pd based PNA material no longer has any NOₓ emissions stored at temperatures from about 200° C. to about 300° C. In another embodiment, the Pd based PNA material no longer has any NOₓ emissions stored at about greater than or equal to 300° C.

In one embodiment, ruthenium based PNA material can be used for storing NOₓ emissions from ambient temperature to greater than or equal to about 300° C. In another embodiment, Ru based PNA material can be used for storing NOₓ emissions from ambient temperature to greater than or equal to about 275° C. In another embodiment, Ru based PNA material can be used for storing NOₓ emissions from ambient temperature to greater than or equal to about 250° C. In another embodiment, Ru based PNA material can be used for storing NOₓ emissions from ambient temperature to greater than or equal to about 225° C. In another embodiment, Ru based PNA material can be used for storing NOₓ emissions from ambient temperature to greater than or equal to about 200° C. In another embodiment, Ru based PNA material can be used for storing NOₓ emissions from ambient temperature to greater than or equal to about 190° C. Once the temperature surpasses the upper storage temperature, the PNA material can “cross over” (i.e., can stop adsorbing NOₓ emissions and can start releasing the NOₓ emissions). The cross over range for Ru based PNA material can be from about 170° C. to about 220° C., from about 180° C. to about 210° C., from about 185° C. to about 205° C., or from about 190° C. to about 200° C.

The NOₓ desorption temperature depends on a variety of factors including the amount of PGM and/or oxide in the PNA material. In one embodiment, the desorption temperature range can be greater than or equal to the cross over temperature. At a certain temperature, the PNA material may no longer be storing any NOₓ emissions. At this point, the PNA material can be said to have fully released all NOₓ emissions. In one embodiment, the full release temperature of the Ru based PNA material is greater than about 200° C. In one embodiment, the full release temperature of the Ru based PNA material is greater than about 250° C. In one embodiment, the full release temperature of the Ru based PNA material is greater than or equal to about 300° C. In one embodiment, the full release temperature of the Ru based PNA material is greater than or equal to about 340° C. In another embodiment, the full release temperature of the Ru based PNA material is between about 300° C. and about 350° C. In another embodiment, the full release temperature of the Ru based PNA material is about 340° C. In another embodiment, the Ru based PNA material no longer has any NOₓ emissions stored at temperatures greater than or equal to about 200° C. In another embodiment, the Ru based PNA material no longer has any NOₓ emissions stored at temperatures greater than or equal to about 250° C. In another embodiment, the Ru based PNA material no longer has any NOₓ emissions stored at temperatures greater than or equal to about 300° C. In another embodiment, the Ru based PNA material no longer has any NOₓ emissions stored at temperatures greater than or equal to about 340° C. In another embodiment, the Ru based PNA material no longer has any NOₓ emissions stored at temperatures from about 300° C. to about 400° C. In another embodiment, the Ru based PNA material no longer has any NOₓ emissions stored at temperatures greater than or equal to about 400° C.

In one embodiment, manganese oxide based PNA material can be used for storing NOₓ emissions from ambient temperature to about 150° C. In another embodiment, manganese oxide based PNA material can be used for storing NOₓ emissions from ambient temperature to about 125° C. In another embodiment, manganese oxide based PNA material can be used for storing NOₓ emissions from ambient temperature to about 110° C. In another embodiment, manganese oxide based PNA material can be used for storing NOₓ emissions from ambient temperature to about 100° C. In another embodiment, manganese oxide based PNA material can be used for storing NOₓ emissions from ambient temperature to less than about 100° C. Once the temperature surpasses the upper storage temperature, the PNA material can “cross over” (i.e., can stop adsorbing NOₓ emissions and can start releasing the NOₓ emissions).

In one embodiment, the manganese oxide based PNA material no longer has any NOₓ emissions stored at temperatures from about 200° C. to about 250° C. In another embodiment, the manganese oxide based PNA material no longer has any NOₓ emissions stored at temperatures from about 210° C. to about 240° C. In another embodiment, the manganese based PNA material no longer has any NOₓ emissions stored at temperatures from about 215° C. to about 225° C. In another embodiment, the manganese based PNA material no longer has any NOₓ emissions stored at about 220° C.

In one embodiment, magnesium oxide based PNA material can be used for storing NOₓ emissions from ambient temperature to about 200° C. In another embodiment, magnesium oxide based PNA material can be used for storing NOₓ emissions from ambient temperature to about 175° C. In another embodiment, magnesium oxide based PNA material can be used for storing NOₓ emissions from ambient temperature to about 150° C. In another embodiment, magnesium oxide based PNA material can be used for storing NOₓ emissions from ambient temperature to less than about 150° C. Once the temperature surpasses the upper storage temperature, the PNA material can “cross over” (i.e., can stop adsorbing NOₓ emissions and can start releasing the NOₓ emissions).

In one embodiment, the magnesium oxide based PNA material no longer has any NOₓ emissions stored at temperatures from about 210° C. to about 260° C. In another embodiment, the magnesium oxide based PNA material no longer has any NOₓ emissions stored at temperatures from about 220° C. to about 250° C. In another embodiment, the magnesium based PNA material no longer has any NOₓ emissions stored at temperatures from about 235° C. to about 245° C. In another embodiment, the magnesium based PNA material no longer has any NOₓ emissions stored at about 240° C.

In one embodiment, calcium oxide based PNA material can be used for storing NOₓ emissions from ambient temperature to about 250° C. In another embodiment, calcium oxide based PNA material can be used for storing NOₓ emissions from ambient temperature to about 225° C. In another embodiment, calcium oxide based PNA material can be used for storing NOₓ emissions from ambient temperature to about 200° C. In another embodiment, calcium oxide based PNA material can be used for storing NOₓ emissions from ambient temperature to less than about 200° C. In another embodiment, calcium oxide based PNA material can be used for storing NOₓ emissions from ambient temperature to about 180° C. In another embodiment, calcium oxide based PNA material can be used for storing NOₓ emissions from ambient temperature to less than about 180° C. Once the temperature surpasses the upper storage temperature, the PNA material can “cross over” (i.e., can stop adsorbing NOₓ emissions and can start releasing the NOₓ emissions).

In one embodiment, the calcium oxide based PNA material no longer has any NOₓ emissions stored at temperatures from about 290° C. to about 340° C. In another embodiment, the calcium oxide based PNA material no longer has any NOₓ emissions stored at temperatures from about 300° C. to about 330° C. In another embodiment, the calcium based PNA material no longer has any NOₓ emissions stored at temperatures from about 305° C. to about 315° C. In another embodiment, the calcium based PNA material no longer has any NOₓ emissions stored at about 310° C.

In some embodiments, the support particles are impregnated with alkali oxide, alkaline earth oxide, and PGM using wet chemistry techniques. In some embodiments, the PNA material may be prepared by incipient wetness techniques. In some embodiments, the PNA material is prepared by plasma based methods. In some embodiments, the PNA material includes NNm particles, NNiM particles, and/or hybrid NNm/wet-chemistry particles. In another embodiment, alkali oxide, alkaline earth oxide, and PGM nano or micron particles can be used simply by adding them to the washcoat when desired, in the amount desired, along with the other solid ingredients.

### PNA Material

The PNA material can comprise PGM on support particles, alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of alkali oxides and alkaline earth oxides on support particles; PGM on support particles; and alkali oxides and alkaline earth oxides and PGM on support particles in any ratio can be employed, as discussed above. The PGM can include, for example, palladium, ruthenium, or mixtures thereof. In addition, the PGM can include their oxides, such as ruthenium oxide.

In some embodiments, the PNA material can comprise palladium on support particles; ruthenium on support particles; manganese oxide (preferably Mn₃O₄) on support particles; magnesium oxide on support particles; calcium oxide on support particles; a combination of manganese oxide on support particles and magnesium oxide on support particles in any ratio; a combination of manganese oxide on support particles and calcium oxide on support particles in any ratio; a combination of magnesium oxide on support particles and calcium oxide on support particles in any ratio; or a combination of manganese oxide on support particles, magnesium oxide on support particles, and calcium oxide on support particles in any ratio. Other embodiments include PNA material comprising a combination of manganese oxide on support particles and PGM on support particles in any ratio; a combination of magnesium oxide on support particles and PGM on support particles in any ratio; a combination of calcium oxide on support particles and PGM on support particles in any ratio; a combination of manganese oxide on support particles, magnesium oxide on support particles, and PGM on support particles in any ratio; a combination of manganese oxide on support particles, calcium oxide on support particles, and PGM on support particles in any ratio; a combination of magnesium oxide on support particles, calcium oxide on support particles, and PGM on support particles in any ratio; or a combination of manganese oxide on support particles, magnesium oxide on support particles, calcium oxide on support particles, and PGM on support particles in any ratio, which are discussed above.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

In one embodiment, palladium is used in an amount of from about 0.01% to about 5% (by weight) of the amount of cerium oxide used in the PNA material. (As described above, in all embodiments, the cerium oxide can include zirconium oxide, lanthanum, lanthanum oxide, yttrium oxide, or a combination thereof). In one embodiment, palladium is used in an amount of from about 0.5% to about 3% (by weight) of the amount of cerium oxide used in the PNA material. In one embodiment, palladium is used in an amount of from about 0.67% to about 2.67% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment, Pd is used in an amount of from about 1.5% to about 2.5% (by weight) of the amount of cerium oxide used in the PNA material, and the amount of cerium oxide used is from about 100 g/L to about 200 g/L. In another embodiment. Pd is used in an amount of from about 0.5% to about 1.5% (by weight) of the amount of cerium oxide used in the PNA material, and the amount of cerium oxide used is from about 250 g/L to about 350 g/L. In another embodiment, Pd is used in an amount of from about 1% to about 2% (by weight) of the amount of cerium oxide used in the PNA material, and the amount of cerium oxide used is greater than or equal to about 150 g/L. In another embodiment, Pd is used in an amount of about 2% (by weight) of the amount of cerium oxide used in the PNA material, and the amount of cerium oxide used is greater than or equal to about 150 g/L. In another embodiment, Pd is used in an amount of about 1% (by weight) of the amount of cerium oxide used in the PNA material, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA material is from about 100 g/L to about 350 g/L. In another embodiment. Pd is used in an amount of about 2 g/L to about 4 g/L. and the amount of cerium oxide used in the PNA material is from about 100 g/L to about 350 g/L. In another embodiment, Pd is used in an amount of about 3 g/L, and the amount of cerium oxide used in the PNA material is from about 150 g/L to about 300 g/L. In another embodiment, Pd is used in an amount of about 1 g/L to about 5 g/L, and the amount of cerium oxide used in the PNA material is from greater than or equal to about 150 g/L. In another embodiment, Pd is used in an amount of about 2 g/L to about 4 g/L, and the amount of cerium oxide used in the PNA material is from greater than or equal to about 150 g/L. In another embodiment, Pd is used in an amount of about 3 g/L, and the amount of cerium oxide used in the PNA material is from greater than or equal to about 150 g/L. The PNA material can include Pd in larger (cooler) engine systems (e.g., greater than 2.5 Liters).

In one embodiment, ruthenium is used in an amount of from about 0.01% to about 15% (by weight) of the amount of cerium oxide used in the PNA material. (As described above, in all embodiments, the cerium oxide can include zirconium oxide, lanthanum, lanthanum oxide, yttrium oxide, or a combination thereof). In one embodiment, ruthenium is used in an amount of from about 0.5% to about 12% (by weight) of the amount of cerium oxide used in the PNA material. In one embodiment, ruthenium is used in an amount of from about 1% to about 10% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment, the amount of cerium oxide used in the PNA material is greater than or equal to about 300 g/L. In another embodiment, Ru is used in an amount of from about 3% to about 4.5% (by weight) of the amount of cerium oxide used in the PNA material, and the amount of cerium oxide used is from about 100 g/L to about 200 g/L. In another embodiment, Ru is used in an amount of from about 1% to about 2.5% (by weight) of the amount of cerium oxide used in the PNA material, and the amount of cerium oxide used is from about 250 g/L to about 350 g/L. In another embodiment, Ru is used in an amount of from about 1.67% to about 4% (by weight) of the amount of cerium oxide used in the PNA material, and the amount of cerium oxide used is greater than or equal to about 150 g/L. In another embodiment, Ru is used in an amount of from about 1.67% to about 4% (by weight) of the amount of cerium oxide used in the PNA material, and the amount of cerium oxide used is greater than or equal to about 300 g/L. In another embodiment, Ru is used in an amount of about 3.33% to about 4% (by weight) of the amount of cerium oxide used in the PNA material, and the amount of cerium oxide used is greater than or equal to about 150 g/L. In another embodiment, Ru is used in an amount of about 1.67% to about 2% (by weight) of the amount of cerium oxide used in the PNA material, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment. Ru is used in an amount of about 5 g/L to about 6 g/L. In another embodiment. Ru is used in an amount of about 1 g/L to about 20 g/L, and the amount of cerium oxide used in the PNA material is from about 100 g/L to about 350 g/L. In another embodiment, Ru is used in an amount of about 3 g/L to about 15 g/L, and the amount of cerium oxide used in the PNA material is from about 100 g/L to about 350 g/L. In another embodiment, Ru is used in an amount of about 4 g/L to about 8 g/L, and the amount of cerium oxide used in the PNA material is from about 100 g/L to about 350 g/L. In another embodiment, Ru is used in an amount of about 5 g/L to about 6 g/L, and the amount of cerium oxide used in the PNA material is from about 150 g/L to about 350 g/L. In another embodiment, Ru is used in an amount of about 1 g/L to about 20 g/L, and the amount of cerium oxide used in the PNA material is from greater than or equal to about 150 g/L. In another embodiment, Ru is used in an amount of about 3 g/L to about 15 g/L, and the amount of cerium oxide used in the PNA material is from greater than or equal to about 150 g/L. In another embodiment, Ru is used in an amount of about 4 g/L to about 8 g/L, and the amount of cerium oxide used in the PNA material is from greater than or equal to about 150 g/L. In another embodiment, Ru is used in an amount of about 5 g/L to about 6 g/L, and the amount of cerium oxide used in the PNA material is from greater than or equal to about 150 g/L. In another embodiment, Ru is used in an amount of about 1 g/L to about 20 g/L, and the amount of cerium oxide used in the PNA material is from greater than or equal to about 300 g/L. In another embodiment, Ru is used in an amount of about 3 g/L to about 15 g/L, and the amount of cerium oxide used in the PNA material is from greater than or equal to about 300 g/L. In another embodiment, Ru is used in an amount of about 4 g/L to about 8 g/L, and the amount of cerium oxide used in the PNA material is from greater than or equal to about 300 g/L. In another embodiment. Ru is used in an amount of about 5 g/L to about 6 g/L, and the amount of cerium oxide used in the PNA material is from greater than or equal to about 300 g/L. The PNA material can include Ru in small (hotter) engine systems (e.g., less than 2 Liters).

In one embodiment, MgO is used in an amount of from about 1% to about 20% (by weight) of the amount of the cerium oxide used in the PNA material. In one embodiment, MgO is used in an amount of from about 1% to about 15% (by weight) of the amount of the cerium oxide used in the PNA material. In one embodiment, MgO is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, MgO is used in an amount of from about 2% to about 8% (by weight) of the amount of the cerium oxide used in the PNA material, and the amount of cerium oxide used is from about 150 g/L to about 350 g/L. In another embodiment, MgO is used in an amount of from about 2% to about 4% (by weight) of the amount of the cerium oxide used in the PNA material, and the amount of cerium oxide used is from about 250 g/L to about 350 g/L. In another embodiment, MgO is used in an amount of from about 6% to about 8% (by weight) of the amount of the cerium oxide used in the PNA material, and the amount of cerium oxide used is from about 150 g/L to about 250 g/L. In another embodiment, MgO is used in an amount of about 3% (by weight) of the amount of the cerium oxide used in the PNA material, and the amount of cerium oxide used is about 350 g/L. In another embodiment, MgO is used in an amount of about 7% (by weight) of the amount of the cerium oxide used in the PNA material, and the amount of cerium oxide used is about 150 g/L. In another embodiment, MgO is used in an amount of about 10.5 g/L, and the amount of cerium oxide used in the PNA material is from about 150 g/L to about 350 g/L.

In one embodiment, Mn₃O₄ is used in an amount of from about 1% to about 30% (by weight) of the amount of the cerium oxide used in the PNA material. In one embodiment, Mn₃O₄ is used in an amount of from about 1% to about 25% (by weight) of the amount of the cerium oxide used in the PNA material. In one embodiment, Mn₃O₄ is used in an amount of from about 1% to about 20% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, Mn₃O₄ is used in an amount of from about 5% to about 20% (by weight) of the amount of the cerium oxide used in the PNA material, and the amount of cerium oxide used is from about 150 g/L to about 350 g/L. In another embodiment, Mn₃O₄ is used in an amount of from about 5% to about 10% (by weight) of the amount of the cerium oxide used in the PNA material, and the amount of cerium oxide used is from about 250 g/L to about 350 g/L. In another embodiment, Mn₃O₄ is used in an amount of from about 15% to about 20% (by weight) of the amount of the cerium oxide used in the PNA material, and the amount of cerium oxide used is from about 150 g/L to about 250 g/L. In another embodiment, Mn₃O₄ is used in an amount of about 8% (by weight) of the amount of the cerium oxide used in the PNA material, and the amount of cerium oxide used is about 350 g/L. In another embodiment, Mn₃O₄ is used in an amount of about 18.67% (by weight) of the amount of the cerium oxide used in the PNA material, and the amount of cerium oxide used is about 150 g/L. In another embodiment, Mn₃O₄ is used in an amount of about 28 g/L, and the amount of cerium oxide used in the PNA material is from about 150 g/L to about 350 g/L.

In one embodiment, calcium oxide is used in an amount of from about 1% to about 20% (by weight) of the amount of the cerium oxide used in the PNA material. In one embodiment, calcium oxide is used in an amount of from about 1% to about 15% (by weight) of the amount of the cerium oxide used in the PNA material. In one embodiment, calcium oxide is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, calcium oxide is used in an amount of from about 2% to about 8% (by weight) of the amount of the cerium oxide used in the PNA material, and the amount of cerium oxide used is from about 150 g/L to about 350 g/L. In another embodiment, calcium oxide is used in an amount of from about 2% to about 4% (by weight) of the amount of the cerium oxide used in the PNA material, and the amount of cerium oxide used in the PNA material is from about 250 g/L to about 350 g/L. In another embodiment, calcium oxide is used in an amount of from about 6% to about 8% (by weight) of the amount of the cerium oxide used in the PNA material, and the amount of cerium oxide used is from about 150 g/L to about 250 g/L. In another embodiment, calcium oxide is used in an amount of about 3% (by weight) of the amount of the cerium oxide used in the PNA material, and the amount of cerium oxide used is about 350 g/L. In another embodiment, calcium oxide is used in an amount of about 7% (by weight) of the amount of the cerium oxide used in the PNA material, and the amount of cerium oxide used is about 150 g/L. In another embodiment, calcium oxide is used in an amount of about 10.5 g/L. and the amount of cerium oxide used in the PNA material is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the PNA material is from about 150 g/L to about 350 g/L.

The amount of cerium oxide can correspond to the total amount of cerium oxide used to form the alkali oxide or alkaline earth oxide/cerium oxide; PGM/cerium oxide (including if NNm or NNiM particles are employed); the alkali oxide or alkaline earth oxide/cerium oxide and PGM/cerium oxide; the alkali oxide or alkaline earth oxide/cerium oxide and other alkali oxide(s) or alkaline earth oxide(s)/cerium oxide; or the alkali oxide or alkaline earth oxide/cerium oxide, other alkali oxide(s) or alkaline earth oxide(s)/cerium oxide, and PGM/cerium oxide.

PNA Material with PGM

In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

The PNA material can include support particles impregnated with PGM. In some embodiments, PGM may be added to support particles using wet chemistry techniques. In some embodiments, PGM may be added to support particles using incipient wetness. In some embodiments, PGM may be added to support particles using plasma based methods such as nano-on-nano to form PNA composite nanoparticles. In some embodiments, these PNA composite nanoparticles are added to carrier particles to form NNm PNA particles or are embedded within carrier particles to form NNiM PNA particles. As such, the PGM on support particles can include micro-PGM on micron support particles, nano-PGM on micron support particles, PNA nano-on-nano particles, PNA NNm particles, PNA NNiM particles, or PNA hybrid NNm/wet-chemistry particles described above. In some embodiments, the micron-sized particles of the PGM NNm particles can be the micron-sized supports impregnated with the alkali oxides or alkaline earth oxides. In some embodiments, the micron-sized particles of the PGM NNm particles can be impregnated with alkali oxides or alkaline earth oxides. In some embodiments, the alkali oxides or alkaline earth oxides and PGM are on the same support particle. In other embodiments, the alkali oxides or alkaline earth oxides and PGM are on different support particles.

In some embodiments, the support particles of the PNA material may contain platinum. In some embodiments, the support particles of the PNA material may contain rhodium. In some embodiments, the support particles of the PNA material may contain palladium. In some embodiments, the support particles of the PNA material may contain ruthenium. In some embodiments, the support particles of the PNA material may contain a mixture of platinum and palladium. For example, the support particles of the PNA material may contain a mixture of 2:1 to 100:1 platinum to palladium. In some embodiments, the support particles of the PNA material may contain a mixture of 2:1 to 75:1 platinum to palladium. In some embodiments, the support particles of the PNA material may contain a mixture of 2:1 to 50:1 platinum to palladium. In some embodiments, the support particles of the PNA material may contain a mixture of 2:1 to 25:1 platinum to palladium. In some embodiments, the support particles of the PNA material may contain a mixture of 2:1 to 15:1 platinum to palladium. In some embodiments, the support particles of the PNA material may contain a mixture of 2:1 to 10:1 platinum to palladium. In some embodiments, the support particles of the PNA material may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the PNA material can include NNm™ particles comprising composite PNA nanoparticles. In other embodiments, the PNA material can include NNiM particle comprising composite PNA nanoparticles. The PGM NNm's micro-sized components can further be impregnated with alkali oxides or alkaline earth oxides to form a PNA material. The micro-sized component of the PGM NNm can be cerium oxide. As described above, in all embodiments, the cerium oxide can include zirconium oxide, lanthanum, lanthanum oxide, yttrium oxide, or a combination thereof. In some embodiments, the cerium oxide includes 86 wt %/o cerium oxide, 10 wt % zirconium oxide, and 4 wt % lanthanum and/or lanthanum oxide. In addition, micro-sized cerium oxide that has been impregnated with alkali oxides or alkaline earth oxides can be used as the micro-sized component of the NNm and NNiM particles.

The following discussion will be exemplified using NNm™ particles, but applies equally well to NNiM particles. The composite nanoparticle may include one or more nanoparticles attached to a support nanoparticle to form a “nano-on-nano” composite nanoparticle that may trap or store NOₓ gases. Platinum group metals may be used to prepare the composite nanoparticle. In certain embodiments, the composite nanoparticle may contain palladium. In other embodiments, the composite nanoparticle may contain ruthenium. A suitable support nanoparticle for the composite nanoparticles includes, but is not limited to, nano-sized cerium oxide (which can include zirconium oxide, lanthanum, lanthanum oxide, yttrium oxide, or a combination thereof).

Each composite nanoparticle may be supported on a single support nanoparticle or each support nanoparticle may include one or more composite nanoparticles. The composite nanoparticles on the support nanoparticle may include palladium, ruthenium, or a mixture thereof. In some embodiments, palladium is used alone. In other embodiments, ruthenium may be used alone. In further embodiments, platinum may be used in combination with palladium. For example, the support nanoparticle may contain a mixture of 2:1 to 100:1 platinum to palladium. In some embodiments, the support nanoparticle may contain a mixture of 2:1 to 75:1 platinum to palladium. In some embodiments, the support nanoparticle may contain a mixture of 2:1 to 50:1 platinum to palladium. In some embodiments, the support nanoparticle may contain a mixture of 2:1 to 25:1 platinum to palladium. In some embodiments, the support nanoparticle may contain a mixture of 2:1 to 15:1 platinum to palladium. In some embodiments, the support nanoparticle may contain a mixture of 2:1 to 10:1 platinum to palladium. In some embodiments, the support nanoparticle may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

The composite nanoparticles for use as components of the PNA material can be produced by plasma-based methods as described above. Platinum group metals (such as ruthenium, palladium, or a mixture thereof) can be introduced into the plasma reactor as a fluidized powder in a carrier gas stream. The resulting nano-on-nano particles have similar properties (i.e., diameter or grain size) to that of the oxidative nano-on-nano particles and reductive nano-on-nano particles. In one embodiment, for NOₓ adsorbing composite nanoparticles, ruthenium, palladium, or a mixture of palladium and platinum, can be deposited on nano-sized cerium oxide.

To prepare a PNA material that comprises a nano-on-nano-on-micro particle (NNm), a dispersion of the composite nanoparticles may be applied to porous, micron-sized cerium oxide or aluminum oxide. After the composite nanoparticles are applied to the micron-sized cerium oxide, the micron-sized cerium oxide may be impregnated with alkali oxide or alkaline earth oxide nanoparticles. In some embodiments, the NNm particles are combined with separate alkali oxides or alkaline earth oxides on cerium oxide supports to form the PNA material. The micron-sized cerium oxide may contain zirconium oxide. In some embodiments, the micron-sized cerium oxide is substantially free of zirconium oxide. In other embodiments, the micron-sized cerium oxide contains up to 100% zirconium oxide. In one embodiment, the nanoparticle is a PGM. In one embodiment, the PGM is platinum, palladium, or a mixture thereof. In another embodiment, the PGM is ruthenium. In other embodiments, the nanoparticle is a non-PGM. In some embodiments, the non-PGM is tungsten, molybdenum, niobium, manganese, or chromium.

The micron-sized carrier particles, impregnated with the composite nanoparticles may be prepared as described above for the Nano-on-Nano-on-Micro particles.

In some embodiments, the PNA material comprises multiple types of particles comprising micron-sized cerium oxide particles impregnated with alkali oxide or alkaline earth oxide particles, and separate NNm or NNiM particles comprising ruthenium, platinum, palladium, or mixtures thereof.

In some instances, the weight ratio of nano-sized Ru, Pt, Pd. or Pt/Pd:nano-sized cerium oxide is about 1%:99% to about 40%:60%. In one embodiment, the weight ratio of nano-sized Ru, Pt, Pd. or Pt/Pd:nano-sized cerium oxide is about 10%:90%. In addition, the Ru, Pt, Pd, or Pt/Pd can include their oxides, such as ruthenium oxide.

The PNA NNm™ particles may contain from about 0.1% to 6% Pd, Ru, or ruthenium oxide by weight, or in another embodiment from about 0.5% to 3.5% by weight, or in another embodiment, about 1% to about 2.5% by weight, or in another embodiment about 2% to about 3% by weight, or in another embodiment, about 2.5% by weight, of the total mass of the NNm™ particle. The NNm™ particles can then be used for formulations for coating substrates, where the coated substrates may be used in catalytic converters.

In further embodiments, the NNm™ particles may be comprised of metals such as W, Mo, Nb, Mn, or Cr produced using the plasma-based methods described above.

### Substrates

The initial substrate is preferably a catalytic converter substrate that demonstrates good thermal stability, including resistance to thermal shock, and to which the described washcoats can be affixed in a stable manner. Suitable substrates include, but are not limited to, substrates formed from cordierite or other ceramic materials, and substrates formed from metal. The substrate may be a honeycomb structure. The substrates may include a grid array structure or coiled foil structure, which provide numerous channels and result in a high surface area. The high surface area of the coated substrate with its applied washcoats in the catalytic converter provides for effective treatment of the exhaust gas flowing through the catalytic converter. A corner fill layer, or a buffer layer or adhesion layer such as a thin Boehmite layer, may be applied to the substrate prior to applying any of the active washcoat layers, but is not required.

### Washcoat Compositions and Layers for PNA Systems

Washcoat formulations comprising the PNA material may be used to provide one or more layers on substrates used for catalysis, such as a catalytic converter substrate. Additional washcoats can also be used for improved performance. In some embodiments, the washcoat formulations may include two or more different washcoats formulations that allow for the separation of one or more washcoat layers containing high concentrations of zeolite particles from one or more washcoat layers containing platinum group metal catalyst, such as the NNm particles described above, on a catalytic converter substrate. The formulations may be used to form washcoat layers and catalytic converter substrates that include reduced amounts of platinum group metals and offer better performance when compared to previous washcoat layers and formulations and catalytic converter substrates.

Many of the washcoat compositions disclosed herein can include boehmite. Boehmite can be added to the washcoat compositions as a binder and is converted to aluminum oxide upon calcination.

Some embodiments of washcoat formulations may be formulated to form one or more of the following basic washcoat layer configurations:

### Substrate-Catalytic Layer-PNA Layer-Zeolite Layer (S-C-P-Z)

### Substrate-Catalytic Layer-Zeolite Layer-PNA Layer (S-C-Z-P)

### Substrate-PNA Layer-Zeolite Layer-Catalytic Layer (S-P-Z-C)

### Substrate-PNA Layer-Catalytic Layer-Zeolite Layer (S-P-C-Z)

### Substrate-Zeolite Layer-PNA Layer-Catalytic Layer (S-Z-P-C)

### Substrate-Zeolite Layer-Catalytic Layer-PNA Layer (S-Z-C-P)

### Substrate-Catalytic Layer-(PNA/Zeolite Layer) (S-C-PZ)

### Substrate-(PNA/Zeolite Layer)-Catalytic Layer (S-PZ-C)

### Substrate-(PNA/Zeolite/Catalytic Layer) (S-PZC)

### Substrate-PNA Layer (S-P)

Any of the above configurations can contain a Corner Fill Layer (F) that may be used to fill corners of the substrate prior to deposition of additional layers. In addition, any of the above configurations can have more than one of any layer. In addition, any of the above configurations may remove one or more than one layer. In the configurations above: 1) the Substrate (S) may be any substrate suitable for use in a catalytic converter, 2) the Zeolite Layer (Z) is a washcoat layer that includes zeolite particles, 3) the Catalytic Layer (C) is a washcoat layer that includes catalytic particles (there can be more than one catalytic layer such as a reductive catalytic layer and an oxidative catalytic layer), 4) the PNA Layer (P) is a washcoat layer that includes a NOₓ adsorber, 5) the PNA/Zeolite Layer (PZ) is a washcoat layer that includes a NOₓ adsorber and zeolites and 6) the PNA/Zeolite/Catalytic Layer (PZC) which is a washcoat layer that includes an NOₓ adsorber, zeolites, and catalytic particles.

It should be noted that, in some embodiments, additional washcoat layers can be disposed under, over, on top of, or between any of the washcoat layers indicated in these basic configurations; that is, further layers can be present on the catalytic converter substrate in addition to the ones listed in the configurations above. When a layer (layer Y) is said to be formed “on top of” another layer (layer X), either no additional layers, or any number of additional layers (layer(s) A, B, C, etc.) can be formed between the two layers X and Y. For example, if layer Y is said to be formed on top of layer X, this can refer to a situation where layer X can be formed, then layer A can be formed immediately atop layer X, then layer B can be formed immediately atop layer A, then layer Y can be formed immediately atop layer B. Alternatively, if layer Y is said to be formed on top of layer X, this can refer to a situation where layer Y can be deposited directly on top of layer X with no intervening layers between X and Y. For the specific situation where no intervening layers are present between layer X and layer Y, layer Y is said to be formed immediately atop layer X. or equivalently, layer Y is said to be formed directly on top of layer X.

In other embodiments, additional washcoat layers are not applied; that is, the washcoats listed in the configurations above are the only washcoats present on the catalytic converter substrate. In other embodiments, the washcoats listed in the configurations above might have a layer not present (that is, a layer may be omitted).

In the following washcoat descriptions, the composite nanoparticles are described as a component of the NNm™ particles for illustrative purposes only. However, the composite nanoparticles could equally well be a component of the NNiM particles. In the following descriptions, the percentages of the components of the washcoat compositions are provided in terms of the amount of solids present in the washcoat compositions, as the washcoat compositions can be provided in an aqueous suspension or, in some instances, as dry powder. The “layers” refers to the corresponding washcoat composition after it has been applied to the substrate, dried, and calcined.

### General Washcoat Preparation Procedure

Washcoats are prepared by suspending the designated materials in an aqueous solution, adjusting the pH to between about 2 and about 7, to between about 3 and about 5, or to about 4, and adjusting the viscosity, if necessary, using cellulose, cornstarch, or other thickeners, to a value between about 300 cP to about 1200 cP.

The washcoat is applied to the substrate (which may already have one or more previously-applied washcoats) by coating the substrate with the aqueous solution, blowing excess washcoat off of the substrate (and optionally collecting and recycling the excess washcoat blown off of the substrate), drying the substrate, and calcining the substrate.

### General Drying and Calcining of Washcoats

Once each washcoat is applied to the substrate (which may or may not have already been coated with previous substrates), excess washcoat is blown off and the residue collected and recycled. The washcoat may then be dried. Drying of the washcoats can be performed at room temperature or elevated temperature (for example, from about 30° C. to about 95° C., preferably about 60° C. to about 70° C.), at atmospheric pressure or at reduced pressure (for example, from about 1 pascal to about 90,000 pascal, or from about 7.5 mTorr to about 675 Torr), in ambient atmosphere or under an inert atmosphere (such as nitrogen or argon), and with or without passing a stream of gas over the substrate (for example, dry air, dry nitrogen gas or dry argon gas). In some embodiments, the drying process is a hot-drying process. A hot drying process includes any way to remove the solvent at a temperature greater than room temperature, but at a temperature below a standard calcining temperature. In some embodiments, the drying process may be a flash drying process, involving the rapid evaporation of moisture from the substrate via a sudden reduction in pressure or by placing the substrate in an updraft of warm air. It is contemplated that other drying processes may also be used.

After drying the washcoat onto the substrate, the washcoat may then be calcined onto the substrate. Calcining takes place at elevated temperatures, such as from 400° C. to about 700° C., preferably about 500° C. to about 600° C., more preferably at about 540° C. to about 560° C. or at about 550° C. Calcining can take place at atmospheric pressure or at reduced pressure (for example, from about 1 pascal to about 90,000 pascal, or about 7.5 mTorr to about 675 Torr), in ambient atmosphere or under an inert atmosphere (such as nitrogen or argon), and with or without passing a stream of gas over the substrate (for example, dry air, dry nitrogen gas, or dry argon gas).

### Corner-Fill Washcoat Compositions and Layers

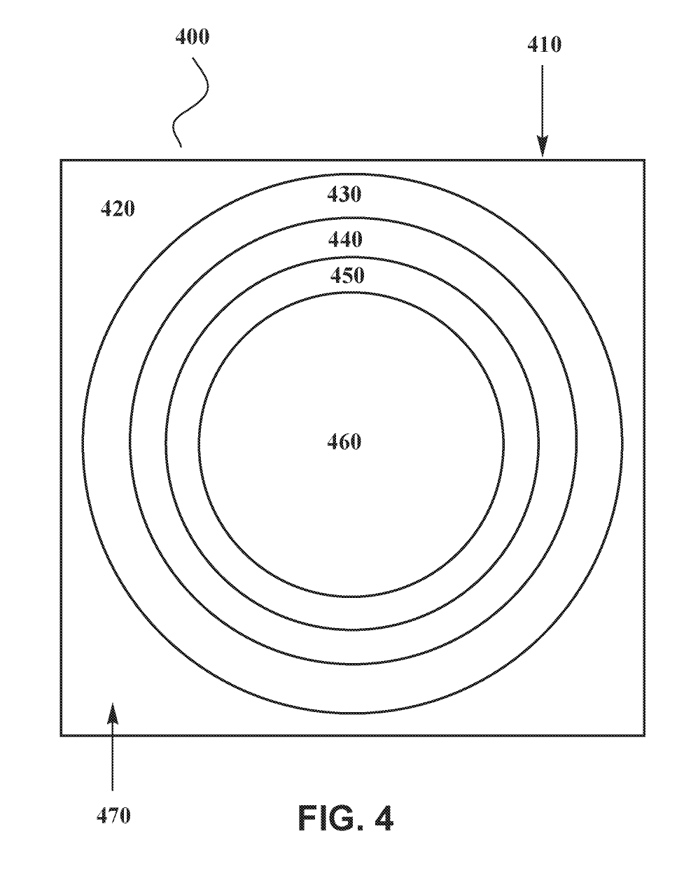

The corner fill washcoat layer (F) may be a relatively inexpensive layer, which can be applied to the substrate to fill up the “corners” and other areas of the substrate where exhaust gases are unlikely to penetrate in significant amounts. Preferably, this layer does not include any PGM, zeolites, or PNA material. The corner fill layer is schematically diagrammed in FIG. 4, which shows a single rectangular channel 400 in a substrate coated in the S-F-C-P-Z configuration. The wall 410 of the substrate channel has been coated with corner-fill washcoat layer 420, then catalyst-containing washcoat layer 430, then PNA material-containing washcoat layer 440, then zeolite particle-containing washcoat layer 450. When the coated substrate is operating in the catalytic converter, exhaust gases pass through the lumen 460 of the channel. The corners of the channel (one of which, 470, is indicated by an arrow) have a relatively thick coating, and exhaust gases will be less likely to contact those regions. In, for example, the S-C-P-Z configuration, the layers 420, 430, and 440 would be a single layer, the catalyst-containing washcoat layer, and significant amounts of expensive platinum group metal would be located in the corners (such as 470) where they are relatively inaccessible for catalysis. Thus, while the S-C-P-Z configuration can be used, it may not be as cost-effective. The corner fill washcoat layer may not provide an equivalent cost savings in the S-Z-P-C configuration, for example, as zeolites are relatively inexpensive.

While a rectangular shape is shown for illustration, an equivalent analysis holds for any substrate with polygonal-shaped channels, or any substrate with channels that are not essentially cylindrical. For substrates with essentially cylindrical channels, which by definition do not have corners, a corner-fill washcoat may not be necessary for economic reasons (although it may still be applied for other reasons, such as to adjust the diameter of the channels).

The corner-fill washcoat compositions may comprise aluminum oxide particles (i.e., alumina). Aluminum-oxide particles such as MI-386 material from Grace Davison, or the like, for example, can be used. The size of the aluminum oxide particles is generally above about 0.2 microns, preferably above about 1 micron. The solids content of the corner-fill washcoat include about 80% to about 98% by weight porous alumina (MI-386 or the like) and about 20% to about 2% boehmite, such as about 90% to 97% alumina and about 10% to 3% boehmite, or about 95% to 97% alumina and about 5% to about 3% boehmite, such as a corner-fill washcoat including about 97% porous alumina and about 3% boehmite.

In some embodiments, each of the aluminum oxide particles or substantially each of the aluminum oxide particles in the corner-fill washcoat composition have a diameter of approximately 0.2 microns to approximately 8 microns, such as about 4 microns to about 6 microns. In some embodiments, the aluminum oxide particles in the corner-fill washcoat composition have an average grain size of approximately 0.2 microns to approximately 8 microns, such as about 4 microns to about 6 microns. In some embodiments, at least about 75%, at least about 80%, at least about 90%, or at least about 95% of the aluminum oxide particles in the corner-fill washcoat composition have a particle size falling within the range of approximately 0.2 microns to approximately 8 microns, such as within the range of about 4 microns to about 6 microns. After a washcoat layer has been applied to a substrate, it may be dried, then calcined, onto the substrate. The corner-fill washcoat may be applied in a thickness of from about 30 g/l up to about 100 g/l; a typical value may be about 50 g/l.

### Zeolite Washcoat Compositions and Zeolite Layers

Zeolite particles may be used to trap hazardous gases, such as hydrocarbons, carbon monoxide, and nitrogen oxides, during cold start of an internal combustion engine. The Zeolite Layer is a washcoat layer, deposited using a washcoat composition that includes a higher percentage of zeolite than the Catalytic layer. In some embodiments, the Zeolite Layer and washcoat includes no catalytic particles.

In some embodiments, the zeolite layer and washcoat compositions comprise, consist essentially of, or consist of zeolite particles, boehmite particles, and metal-oxide particles. The metal-oxide particles are preferably porous. The metal-oxide particles may be aluminum-oxide particles (e.g., MI-386 from Grace Davison or the like). The aluminum-oxide particles may be porous. Different configurations of the weight concentrations of the zeolite particles, boehmite particles, and metal-oxide particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The zeolite layer refers to the zeolite washcoat composition after it has been applied to the substrate, dried, and calcined.

In some embodiments, the zeolite particles comprise at least 50%, comprise more than about 50%, or comprise about 50% to about 100% by weight of the combination of zeolite particles, boehmite particles, and metal-oxide particles in the zeolite washcoat composition or zeolite layer. In some embodiments, the zeolite particles make up approximately 60% to approximately 80%, for example, approximately 65% to approximately 70% or approximately 70% to approximately 80%, by weight of the combination of zeolite particles, boehmite particles, and metal-oxide particles in the zeolite particle-containing washcoat composition or zeolite layer. In some embodiments, the zeolite particles in the zeolite particle-containing washcoat composition or zeolite layer each have a diameter of approximately 0.2 microns to approximately 8 microns, such as about 4 microns to about 6 microns, prior to coating. In some embodiments, at least about 75%, at least about 80%, at least about 90%, or at least about 95% of the zeolite particles in the zeolite particle-containing washcoat composition or zeolite layer have a particle size falling with the range of approximately 0.2 microns to approximately 8 microns, such as within the range of about 4 microns to about 6 microns. In some embodiments, the boehmite particles make up approximately 2% to approximately 5% by weight of the combination of zeolite particles, boehmite particles, and metal-oxide particles in the zeolite particle-containing washcoat composition or zeolite layer. In some embodiments, the boehmite particles make up approximately 3% by weight of the combination of zeolite particles, boehmite particles, and metal-oxide particles in the zeolite particle-containing washcoat composition or zeolite layer. In some embodiments, the metal-oxide particles make up approximately 15% to approximately 38%, for example, approximately 15% to approximately 30%, approximately 17% to approximately 23% or approximately 17% to approximately 22%, by weight of the mixture of zeolite particles, metal-oxide particles, and boehmite particles in the zeolite particle-containing washcoat composition or zeolite layer. In some embodiments, the metal-oxide particles make up approximately 15% to approximately 23% by weight of the mixture of zeolite particles, metal-oxide particles, and boehmite particles in the zeolite particle-containing washcoat composition or zeolite layer. In some embodiments, the metal-oxide particles make up approximately 25% to approximately 35% by weight of the mixture of zeolite particles, metal-oxide particles, and boehmite particles in the zeolite particle-containing washcoat composition or zeolite layer. In some embodiments, the zeolite-particle containing washcoat composition or zeolite layer contains about 3% boehmite particles, about 67% zeolite particles, and about 30% porous aluminum-oxide particles.

In some embodiments, the zeolite particle-containing washcoat composition or zeolite layer does not comprise any platinum group metals. As discussed above, the six platinum group metals are ruthenium, rhodium, palladium, osmium, iridium, and platinum. In some embodiments, the zeolite particle-containing washcoat composition or zeolite layer is characterized by a substantial absence of any platinum group metals. In some embodiments, the zeolite particle-containing washcoat composition or zeolite layer is 100% free of any platinum group metals. In some embodiments, the zeolite particle-containing washcoat composition or zeolite layer is approximately 100% free of any platinum group metals. In some embodiments, the zeolite particle-containing washcoat composition or zeolite layer does not comprise any catalytic particles. In some embodiments, the zeolite particle-containing washcoat composition or zeolite layer is characterized by a substantial absence of any catalytic particles. In some embodiments, the zeolite particle-containing washcoat composition or zeolite layer is 100% free of any catalytic particles. In some embodiments, the zeolite particle-containing washcoat composition or zeolite layer is approximately 100% free of any catalytic particles.

In some embodiments, the zeolite particle-containing washcoat composition or zeolite layer may include by weight about 2% to about 5% boehmite particles, about 60% to about 80% zeolite particles, and the rest porous aluminum-oxide particles (i.e., about 15% to about 38%). In one embodiment, the zeolite particle-containing washcoat composition or zeolite layer includes by weight about 2% to about 5% boehmite particles, about 75% to about 80% zeolite particles, and the rest porous aluminum-oxide particles (i.e., about 15% to about 23%). In another embodiments, the zeolite particle-containing washcoat composition or zeolite layer includes by weight about 2% to about 5% boehmite particles, about 65% to about 70% zeolite particles, and the rest porous aluminum-oxide particles (i.e., about 25% to about 33%). In some embodiment, the zeolite-particle containing washcoat composition or zeolite layer contains about 3% boehmite particles, about 67% zeolite particles, and about 30% porous aluminum-oxide particles. In some embodiments, the zeolite particle-containing washcoat composition or zeolite layer does not contain any catalytic material. In some embodiments, the zeolite particle-containing washcoat composition or zeolite layer does not contain any platinum group metals.

In some embodiments, the zeolite particle-containing washcoat composition or zeolite layer may include PNA material.

In some embodiments, the zeolite particle-containing washcoat composition is mixed with water and acid, such as acetic acid, prior to coating of a substrate with the zeolite particle-containing washcoat composition, thereby forming an aqueous mixture of the zeolite particle-containing washcoat composition, water, and acid. This aqueous mixture of the zeolite particle-containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

In some embodiments, the zeolite layer (that is, the zeolite particle-containing washcoat composition applied to the substrate, or the zeolite-particle containing washcoat layer) has a thickness of approximately 25 g/l to approximately 90 g/l (grams/liter), approximately 50 g/l to approximately 80 g/l, or approximately 70 to approximately 90 g/l. In some embodiments, the zeolite layer has a thickness of approximately 50 g/l, 60 g/l, 70 g/l, 80 g/l, or 90 g/l. In some embodiments, the zeolite layer has a thickness of approximately 80 g/l.

In some embodiments, where the zeolite layer is applied on top of the catalyst-containing layer (i.e., the catalyst-containing layer is closer to the substrate than the zeolite layer), the zeolite layer has a thickness of about 70 g/l to about 90 g/l.

In some embodiments, where the zeolite layer is applied under the catalyst-containing layer (i.e., the zeolite layer is closer to the substrate than the catalyst-containing layer), the zeolite layer has a thickness of about 50 g/I to about 80 g/l.

### Catalytic Washcoat Compositions and Catalytic Layers

The catalytic washcoat composition and the catalytic layer on the substrate contain catalytic material (such as catalytic NNm particles, NNiM particles, or “loose ingredient” catalytic components) and can be formed in a variety of ways. In addition, there can be more than one catalytic layer on the substrate. For example, there can be an oxidative catalytic layer and a reductive catalytic layer. Examples of catalytic washcoats and additional washcoats are disclosed in U.S. Provisional Application 61/894,346, which has been incorporated by reference in its entirety.

Preferred catalytic materials include platinum group metals (PGMs). Platinum group metals are the metals platinum, palladium, rhodium, ruthenium, osmium, and iridium. The individual metals can be used as catalysts, and various combinations of metals can also be used. The catalytic particles may have composite nano-particles, where the composite nanoparticles have a population of support nano-particles bearing catalytic nano-particles comprising platinum and a population of support nano-particles bearing catalytic nano-particles comprising palladium. The micron-sized support particles bearing composite particles may include support nano-particles bearing catalytic nano-particles, where the catalytic nanoparticles include a platinum/palladium alloy, such as a 2:1 Pt/Pd ratio (weight/weight). In some embodiments, the micron-sized carrier particles are alumina (aluminum oxide) particles on which a plurality of composite nano-particles are attached, the composite nano-particles comprising a support nano-particle and a catalytic nano-particle. In one embodiment, MI-386 alumina powder from Grace Davison is used as the micron-sized alumina particles.

In the following descriptions, the percentages of the components of the washcoat compositions are provided in terms of the amount of solids present in the washcoat compositions, as the washcoat compositions can be provided in an aqueous suspension or, in some instances, as dry powder. The catalytic layer (or catalyst-containing layer) refers to the catalytic material-containing washcoat composition after it has been applied to the substrate, dried, and calcined.

The previously described zeolite-particle containing washcoat compositions and zeolite-particle containing layers are preferably free of, or in an alternative embodiment, substantially free of, catalytic particles or platinum group metals. It is preferred that the catalytic washcoat compositions and layers are free of, or substantially free of, zeolites. However, in some embodiments, the catalyst-containing washcoat compositions and catalyst layers can contain an amount of zeolites, such as up to about 20%, up to about 10%, or up to about 5% of the total solids in the catalyst-containing washcoat compositions or catalyst-containing layers.

In some embodiments, the catalyst-containing washcoat composition further includes “spacer” or “filler” particles, where the spacer particles may be ceramic, metal oxide, or metallic particles. In some embodiments, the spacer particles may be silica, alumina, boehmite, or zeolite particles, or any mixture of the foregoing, such as boehmite particles, silica particles and zeolite particles in any proportion.

In some embodiments where the catalytic washcoat composition and catalyst layers are substantially free of zeolites and PNA material, the catalytic washcoat composition comprises, consists essentially of, or consists of silica particles, alumina/sealant particles with or without BaO, boehmite particles, and NNm particles. In some embodiments, the NNm particles make up between approximately 35% to approximately 95% by weight of the combination of the NNm particles, the boehmite particles, and the alumina/sealant and cerium oxide particles in the catalyst-containing washcoat composition or catalytic layer. In some embodiments, the NNm particles make up between approximately 40% to approximately 92% by weight of the combination of the NNm particles, the boehmite particles, and the alumina/sealant and ceria particles in the catalyst-containing washcoat composition or catalyst-containing layer. In some embodiments, the NNm particles make up between approximately 60% to approximately 95% by weight of the combination of the NNm particles, the boehmite particles, and the alumina/sealant and ceria particles in the catalytic washcoat composition or catalytic layer. In some embodiments, the NNm particles make up between approximately 80% to approximately 95% by weight of the combination of the NNm particles, the boehmite particles, and the alumina/sealant and ceria particles in the catalyst-containing washcoat composition or catalyst-containing layer. In some embodiments, the NNm particles make up between approximately 80% to approximately 92% by weight of the combination of the NNm particles, the boehmite particles, and the alumina/sealant and ceria particles in the catalytic washcoat composition or catalytic layer. In some embodiments, the NNm particles make up approximately 92% by weight of the combination of the NNm particles, the boehmite particles, and the alumina/sealant and ceria particles in the catalyst-containing washcoat composition or catalyst-containing layer.

In some embodiments, the NNm™ particles make up between approximately 35% to approximately 75% by weight of the combination of the NNm particles, the boehmite particles, and the alumina/sealant and ceria particles. In some embodiments, the NNm™ particles make up between approximately 40% to approximately 60% by weight of the combination of the NNm particles, the boehmite particles, and the alumina/sealant and ceria particles. In some embodiments, the NNm™ particles make up between approximately 45% to approximately 55% by weight of the combination of the NNm particles, the boehmite particles, and the alumina/sealant and ceria particles. In some embodiments, the NNm™ particles make up about 50% by weight of the combination of the NNm particles, the boehmite particles, and the alumina/sealant and ceria particles.

In some embodiments, the percentage of platinum group metal in the catalyst-containing washcoat composition and catalyst layers ranges from between about 0.25% to about 4%, about 0.5% to about 4%, about 0.5% to about 3%, about 1% to about 3%, about 1% to about 2%, about 1% to about 1.5%, about 1.5% to about 3%, about 1.5% to about 2.5%, about 1.5% to about 2%, about 2% to about 3%, about 2.5% to about 3%, or about 2% to about 2.5%. In some embodiments, the percentage of platinum group metal in the catalyst-containing washcoat composition and catalyst layers is about 0.5%, about 0.75%, about 1%, about 1.25%, about 1.5%, about 1.75%, about 2%, about 2.25%, about 2.5%, about 2.75%, or about 3%. In some embodiments, the percentage of platinum group metal in the catalyst-containing washcoat composition and catalyst layers is about 2.3%.

In some embodiments, the NNm™ particles make up between approximately 50% to approximately 95% by weight of the combination of the NNm particles, the boehmite particles, and the alumina/sealant and ceria particles. In some embodiments, the NNm™ particles make up between approximately 60% to approximately 90% by weight of the combination of the NNm particles, the boehmite particles, and the alumina/sealant and ceria particles. In some embodiments, the NNm™ particles make up between approximately 75% to approximately 85% by weight of the combination of the NNm particles, the boehmite particles, and the alumina/sealant and ceria particles. In some embodiments, the NNm™ particles make up about 80% by weight of the combination of the NNm particles, the boehmite particles, and the alumina/sealant and ceria particles. In some embodiments, the catalytic particle in the NNm™ particles is rhodium at a loading of about 0.3-2 wt % in the NNm™ particles. In some embodiments, the catalytic particle in the NNm™ particles is rhodium at a loading of about 0.3-1 wt % in the NNm™ particles. In some embodiments, the catalytic particle in the NNm™ particles is rhodium at a loading of about 0.3-0.5 wt % in the NNm™ particles. In one embodiment, the catalytic particle in the NNm™ particles is rhodium at a loading of about 0.3 wt % in the NNm™ particles. In another embodiment, the catalytic particle in the NNm™ particles is rhodium at a loading of about 0.4 wt % in the NNm™ particles. Other loadings described previously may also be used.

In some embodiments, the silica particles make up approximately 20% or less by weight of the combination of the NNm particles, the boehmite particles, and the alumina/sealant and ceria particles in the catalytic washcoat composition or catalytic layer; or the silica particles make up approximately 10% or less by weight of the combination of the NNm particles, the boehmite particles, and the alumina/sealant and ceria particles in the catalyst-containing washcoat composition or catalyst-containing layer; in further embodiments, the silica particles make up approximately 5% or less by weight of the combination of the NNm particles, the boehmite particles, and the alumina/sealant and ceria particles in the catalytic washcoat composition or catalytic layer. In various embodiments, the silica particles make up approximately 1% to approximately 20%, approximately 1% to approximately 10%, approximately 1% to approximately 5%, about 20%, about 10%, about 5%, or about 1% by weight of the combination of the NNm particles, the boehmite particles, and the alumina/sealant and ceria particles in the catalytic washcoat composition or catalytic layer.

In some embodiments, the boehmite particles make up approximately 2% to approximately 5% by weight of the combination of the NNm particles, the boehmite particles, and the alumina/sealant and ceria particles in the catalyst-containing washcoat composition or catalyst-containing layer. In some embodiments, the boehmite particles make up approximately 3% by weight of the combination of the NNm particles, the boehmite particles, and the alumina/sealant and ceria particles in the catalytic washcoat composition or catalytic layer.

In some embodiments, the alumina filler/sealant particles make up between approximately 30% to approximately 70% by weight of the combination of the NNm particles, the boehmite particles, and the alumina/sealant and ceria particles. In some embodiments, the alumina filler/sealant particles make up between approximately 40% to approximately 60% by weight of the combination of the NNm particles, the boehmite particles, and the alumina/sealant and ceria particles. In some embodiments, the alumina filler/sealant particles make up between approximately 45% to approximately 55% by weight of the combination of the NNm particles, the boehmite particles, and the alumina/sealant and ceria particles. In some embodiments, the alumina filler/sealant particles make up about 50% by weight of the combination of the NNm particles, the boehmite particles, and the alumina/sealant and ceria particles. The alumina filler/sealant particles may be porous lanthanum-stabilized alumina, for example MI-386. In some embodiments, a different filler particle may be used in place of some or all of the alumina particles.

In some embodiments, the alumina filler/sealant particles make up between approximately 5% to approximately 40% by weight of the combination of the NNm particles, the boehmite particles, and the alumina/sealant and ceria particles. In some embodiments, the alumina filler/sealant particles make up between approximately 10% to approximately 30% by weight of the combination of the NNm particles, the boehmite particles, and the alumina/sealant and ceria particles. In some embodiments, the alumina filler/sealant particles make up between approximately 15% to approximately 20% by weight of the combination of the NNm particles, the boehmite particles, and the alumina/sealant and ceria particles. In some embodiments, the alumina filler/sealant particles make up about 17% by weight of the combination of the NNm particles, the boehmite particles, and the alumina/sealant and ceria particles. The alumina filler/sealant particles may be porous lanthanum-stabilized alumina, for example MI-386. In some embodiments, a different filler particle may be used in place of some or all of the alumina particles.

In the washcoat, from 0 to 100% of the alumina filler/sealant particles may be alumina impregnated with nano-sized BaO particles, alumina mixed with micron-sized BaO particles, or both alumina impregnated with nano-sized BaO particles and admixed with micron-sized BaO particles. In some embodiments, from 1 wt %-100 wt %, from 20 wt %-80 wt %, or from 30 wt %-60 wt % micron-sized BaO may be used in place of non-BaO-impregnated alumina. In some embodiments, a 50:50 mixture of regular MI-386 and BaO-impregnated MI-386 (impregnated with nano-sized BaO particles), or a 50:50 mixture of MI-386 and micron-sized BaO particles, or a mixture of MI-386 impregnated with nano-sized BaO particles and admixed with micron-sized BaO particles, may be used for this component of the washcoat. In some embodiments, the alumina can comprise from 5% to 30% nano-BaO-impregnated alumina and from 70% to 95% non-BaO-impregnated alumina. In some embodiments, the alumina can comprise from 5% to 20% nano-BaO-impregnated alumina and from 80% to 95% non-BaO-impregnated alumina. In some embodiments, the alumina can comprise from 8% to 16% nano-BaO-impregnated alumina and from 84% to 92% non-BaO-impregnated alumina. In one embodiment, 12% or about 12%, nano-BaO-impregnated alumina is mixed with 88%, or about 88%, alumina without impregnated BaO. In one embodiment, 15%, or about 15%, nano-BaO-impregnated alumina is mixed with 85%, or about 85%, alumina without impregnated BaO.

In some embodiments, the alumina can comprise from 5% to 30% micron-sized BaO and from 70% to 95% non-BaO-impregnated alumina. In some embodiments, the alumina can comprise from 5% to 20% micron-sized BaO and from 80% to 95% non-BaO-impregnated alumina. In some embodiments, the alumina can comprise from 8% to 16% micron-sized-BaO and from 84% to 92% non-BaO-impregnated alumina. In one embodiment, 12%, or about 12%, micron-sized BaO is mixed with 88%, or about 88%, alumina without impregnated BaO. In one embodiment, 15%, or about 15%, micron-sized BaO is mixed with 85%, or about 85%, alumina without impregnated BaO.

The ranges for the nano-sized BaO-alumina ratio, that is, the amount of nano-BaO impregnated into the alumina, include 1-25% BaO to 75% to 99% aluminum oxide micron support; 3-20% BaO to 80% to 97% aluminum oxide micron support; 5%-15% BaO to 85% to 95% aluminum oxide micron support; and about 15% BaO to about 85% aluminum oxide micron support, expressed as weight percentages. In one embodiment, the nano-BaO-impregnated aluminum oxide comprises 15%, or about 15%, nano-BaO by weight and 85%, or about 85%, aluminum oxide by weight.

In some embodiments, the c catalytic washcoat composition or catalytic layer further comprises metal-oxide particles, such as the metal oxide particles discussed above (e.g., porous metal-oxides, aluminum-oxides, porous aluminum-oxides, etc.). In some embodiments, these metal-oxide particles further comprise up to approximately 65%, up to approximately 60%, up to approximately 55%, or up to approximately 54%, such as approximately 2% to approximately 54%, by weight of the combination of the nano-on-nano-on-micron particles, the boehmite particles, the silica particles, and the metal-oxide particles in the catalyst-containing washcoat composition or catalyst-containing layer. It is contemplated that the concentration ranges discussed above for the nano-on-nano-on-micron particles, the boehmite particles, and the silica particles can be applied to the combination of those materials with the metal-oxide particles.

In other embodiments, the catalytic washcoat composition or catalytic layer comprises, consists essentially of, or consists of zeolite particles, boehmite particles, and nano-on-nano-on-micron particles. In some embodiments, the nano-on-nano-on-micron particles make up between approximately 35% to approximately 95% by weight of the combination of the nano-on-nano-on-micron particles, the boehmite particles, and the zeolite particles in the catalyst-containing washcoat composition or catalyst-containing layer. In some embodiments, the nano-on-nano-on-micron particles make up between approximately 40% to approximately 92% by weight of the combination of the nano-on-nano-on-micron particles, the boehmite particles, and the zeolite particles in the catalyst-containing washcoat composition or catalyst-containing layer. In some embodiments, the nano-on-nano-on-micron particles make up between approximately 60% to approximately 95% by weight of the combination of the nano-on-nano-on-micron particles, the boehmite particles, and the zeolite particles in the catalyst-containing washcoat composition or catalyst-containing layer. In some embodiments, the nano-on-nano-on-micron particles make up between approximately 80% to approximately 95% by weight of the combination of the nano-on-nano-on-micron particles, the boehmite particles, and the zeolite particles in the catalytic washcoat composition or catalytic layer. In some embodiments, the nano-on-nano-on-micron particles make up between approximately 80% to approximately 92% by weight of the combination of the nano-on-nano-on-micron particles, the boehmite particles, and the zeolite particles in the catalyst-containing washcoat composition or catalyst-containing layer. In some embodiments, the nano-on-nano-on-micron particles make up approximately 92% by weight of the combination of the nano-on-nano-on-micron particles, the boehmite particles, and the zeolite particles in the catalyst-containing washcoat composition or catalyst-containing layer. In some embodiments, the zeolite particles make up less than approximately 20%, less than approximately 10%, or less than approximately 5%, by weight of the combination of the nano-on-nano-on-micron particles, the boehmite particles, and the zeolite particles in the catalytic washcoat composition or catalytic layer. In some embodiments, the zeolite particles make up approximately 1% to approximately 5% by weight, such as about 5% by weight, of the combination of the nano-on-nano-on-micron particles, the boehmite particles, and the zeolite particles in the catalytic washcoat composition or catalytic layer. In some embodiments, the boehmite particles make up approximately 2% to approximately 5% by weight of the combination of the nano-on-nano-on-micron particles, the boehmite particles, and the zeolite particles in the catalytic washcoat composition or catalytic layer. In some embodiments, the boehmite particles make up approximately 3% by weight of the combination of the nano-on-nano-on-micron particles, the boehmite particles, and the zeolite particles in the catalytic washcoat composition or catalytic layer.

In some embodiments, the catalytic washcoat composition or catalytic layer further includes metal-oxide particles, such as the metal oxide particles discussed above (e.g., porous metal-oxides, aluminum-oxides, porous aluminum-oxides, etc.). In some embodiments, these metal-oxide particles make up approximately 0% to approximately 54%, such as approximately 2% to approximately 54%, by weight of the combination of the nano-on-nano-on-micron particles, the boehmite particles, the zeolite particles, and the metal-oxide particles in the catalyst-containing washcoat composition or catalyst-containing layer. It is contemplated that the concentration ranges discussed above for the nano-on-nano-on-micron particles, the boehmite particles, and the zeolite particles can be applied to the combination of those materials with the metal-oxide particles.

In some embodiments, the catalytic washcoat compositions or catalytic layer further includes PNA material.

In one exemplary catalytic washcoat composition, the catalytic materials are provided as “loose ingredients.” For example, in some embodiments, the catalytic washcoat composition comprises composite nanoparticles (such as oxidative composite nanoparticles) and filler particles (such as alumina filler particles, which may be stabilized, for example, by lanthanum). The composite nanoparticles in the loose ingredient catalytic washcoat composition are not attached to the filler particles. In some embodiments, the catalytic washcoat composition further comprises boehmite particles. The composite nanoparticles are those described herein, and comprise an oxidative catalyst nanoparticle attached to a support nanoparticle. The oxidative catalyst nanoparticle comprises one or more platinum group metals. Preferably, the oxidative catalyst nanoparticle comprises platinum and palladium. The oxidative catalyst nanoparticle may comprise platinum and palladium at a ratio of about 1:2 to about 25:1 platinum to palladium (such as about 1:1 to about 10:1 platinum to palladium, about 1:1 to about 5:1 platinum to palladium, or about 2:1 platinum to palladium). The support nanoparticle is preferably an oxide, such as aluminum oxide. The oxidative catalyst nanoparticle and the support nanoparticle may be present at a weight ratio of about 5:95 to about 60:40 platinum group metal to support (such as about 10:90 to about 60:40 platinum group metal to support, about 30:70 to about 50:50 platinum group metal to support, or about 40:60 platinum group metal to support). In some embodiments of the “loose ingredient” catalytic washcoat composition, the composite nanoparticles comprise about 2 wt % to about 10 wt % (such as about 3 wt % to about 7 wt %, or about 4 wt % to about 6 wt %) the total weight of the composite nanoparticles, filler particles, and boehmite. In some embodiments of the “loose ingredient” catalytic washcoat composition, the filler particles comprise about 80 wt % to about 95 wt % (such as about 85 wt % to about 90 wt %) of the composite nanoparticles, filler particles, and boehmite. In some embodiments of the “loose ingredient” catalytic washcoat composition, the boehmite comprises about 3 wt % to about 8 wt % (such as about 4 wt % to about 7 wt %) of the composite nanoparticles, filler particles, and boehmite. In some embodiments of the “loose ingredient” catalytic washcoat composition, the platinum group metal comprises about 0.5 wt % to about 4 wt % (such as about 1 wt % to about 3 wt %, or about 2 wt %) of the composite nanoparticles, filler particles, and boehmite.

The loose ingredient catalytic washcoat composition can be formed, for example, by forming a suspension of the composite nanoparticles, which optionally include a surfactant and/or an antifoaming agent. The composite nanoparticle dispersion is then mixed with the filler particles and boehmite. The pH of the washcoat can be adjusted and thickeners added as described herein.

The loose ingredient catalytic washcoat composition can then be applied to a substrate, dried, and calcined to form the catalytic layer. In some embodiments, the catalytic washcoat is applied to the substrate such that the catalytic layer is about 30 g/L to about 150 g/L (such as about 40 g/L to about 100 g/L, or about 40 g/L to about 60 g/L). In some embodiments, the catalytic washcoat comprises about 0.25 g/L to about 2 g/L PGM (such as about 0.5 g/L to about 1.5 g/L PGM, about 0.5 g/L to about 1.0 g/L PGM, about 0.75 g/L to about 1.25 g/L PGM, or about 1.0 g/L to about 1.5 g/L PGM). In some embodiments, the substrate is also coated by any of the zeolite-containing washcoats and/or any of the PNA materials washcoats, as described herein.

In some embodiments, the catalytic washcoat composition is mixed with water and acid, such as acetic acid, prior to the coating of the substrate with the catalytic washcoat composition, thereby forming an aqueous mixture of the catalytic washcoat composition, water, and acid. This aqueous mixture of the catalytic washcoat composition, water, and acid is then applied to the substrate (where the substrate may or may not already have other washcoat layers applied to it). In some embodiments, the pH of this aqueous mixture is adjusted to a pH level of about 2 to about 7 prior to it being applied to the substrate. In some embodiments, the pH of this aqueous mixture is adjusted to a pH level of about 4 prior to it being applied to the substrate. In some embodiments, the viscosity of the aqueous washcoat is adjusted by mixing with a cellulose solution, with corn starch, or with similar thickeners. In some embodiments, the viscosity is adjusted to a value between about 300 cP to about 1200 cP.

In some embodiments, the catalytic washcoat composition comprises a thickness of approximately 50 g/l to approximately 250 g/l, such as approximately 50 g/l to approximately 140 g/l, approximately 70 g/l to approximately 140 g/l, approximately 90 g/l to approximately 140 g/l, or approximately 110 g/l to approximately 130 g/l. In some embodiments, the catalytic washcoat composition comprises a thickness of approximately 50 g/l, approximately 60 g/l, approximately 70 g/l, approximately 80 g/l, approximately 90 g/l, approximately 100 g/l, approximately 110 g/l, approximately 120 g/l, approximately 130 g/l, or approximately 140 g/l. Preferably, the catalytic washcoat composition comprises a thickness of approximately 120 g/l.

The catalytic washcoat compositions can then be coated onto a substrate, dried and calcined to produce a coated substrate. When the catalytic washcoat includes separately provided materials (that is, when the washcoat comprises micron-sized filler particles and composite nanoparticles not attached to the filler particles), the calcination process after coating may result in a portion of the composite nanoparticles becoming attached to the filler particles. However, a portion of the composite nanoparticles may settle to the bottom of the catalytic layer or may diffuse into adjoining layers, resulting in the coated substrate having composite nanoparticles not attached to the filler particles.

### PNA Material Washcoat Compositions and PNA Layers

PNA material may be used to store nitrogen oxide gases during the cold start of an internal combustion engine. The PNA material can be applied to a substrate of a catalytic converter as part of a washcoat. The PNA material stores nitrogen oxide gases during low temperature engine operation. In some embodiments, the PNA material in the PNA material washcoat can comprise PGM on support particles; alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of alkali oxides and alkaline earth oxides on support particles; PGM on support particles; and alkali oxides and alkaline earth oxides and PGM on support particles in any ratio can be employed, as discussed above.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

Support particles can include, for example, bulk refractory oxides such as alumina or cerium oxide. On example of cerium oxide includes HSA5, HSA20, or a mixture thereof from Rhodia. The cerium oxide particles may contain zirconium oxide. The cerium oxide particles may contain lanthanum and/or lanthanum oxide. In addition, the cerium oxide particles may contain both zirconium oxide and lanthanum oxide. The cerium oxide particles may also contain yttrium oxide. As such, the cerium oxide particles can include cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide particles, or a combination thereof. In some embodiments, the nano-sized cerium oxide particles contain 40-90 t % cerium oxide, 5-60 wt % zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

Support particles can be micron-sized and/or nano-sized. Suitable micron-sized support particles include micron-sized cerium oxide particles including, but are not limited to, HSA5, HSA20, or a mixture thereof. In some embodiments, the support particles may include PGM in addition to alkali oxide or alkaline earth oxide particles or mixture thereof. The PGM can include ruthenium, platinum, palladium, or a mixture thereof. The alkali oxide or alkaline earth oxide particles can be nano-sized or micron-sized, as described above. In some embodiments, PGM are added to the micron-sized support particles using wet chemistry techniques. In some embodiments. PGM are added to the micron-sized support particles using incipient wetness techniques. In some embodiments, PGM are added to nano-sized support particles using incipient wetness and/or wet chemistry techniques. In some embodiments, PGM are added to support particles by plasma based methods described above to form composite PNA nanoparticles. In some embodiments, these PNA composite nanoparticles are added to carrier particles to form NNm PNA particles or are embedded within carrier particles to form NNiM PNA particles. As such, the PGM on support particles can include micro-PGM on micron support particles, nano-PGM on micron support particles, PNA nano-on-nano particles, PNA NNm particles, PNA NNiM particles, or PNA hybrid NNm/wet-chemistry particles described above. In some embodiments, the alkali oxide or alkaline earth oxide particles and PGM are on the same micron-sized support particle. In other embodiments, the alkali oxide or alkaline earth oxide particles and PGM are on different micron-sized support particles.

In some embodiments, the PNA layer and washcoat compositions comprise, consist essentially of, or consist of PNA material and boehmite particles. Different configurations of the weight concentrations of the PNA material and boehmite particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The PNA layer refers to the PNA washcoat composition after it has been applied to the substrate, dried, and calcined.

In some embodiments, the PNA material comprises at least 50% comprise more than about 50%, or comprises about 50% to about 100% by weight of the combination of PNA material and boehmite particles in the PNA washcoat composition or PNA material layer. In some embodiments, the PNA material makes up approximately 60% to approximately 80%, for example, approximately 65% to approximately 70% or approximately 70% to approximately 80%, by weight of the combination of PNA material and boehmite particles in the PNA material particle-containing washcoat composition or PNA material layer. In some embodiments, the PNA material makes up approximately 90% to approximately 100%, for example, approximately 90% to approximately 95% or approximately 95% to approximately 100%, by weight of the combination of PNA material and boehmite particles in the PNA material particle-containing washcoat composition or PNA material layer. In some embodiments, the PNA material makes up approximately 95% to approximately 98% by weight of the combination of PNA material and boehmite particles in the PNA material particle-containing washcoat composition or PNA material layer.

In some embodiments, the PNA material comprises cerium oxide. In some embodiments, cerium oxide (which may include zirconium oxide, lanthanum, lanthanum oxide, yttrium oxide or a combination thereof) makes up approximately 57% to approximately 99% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 59% to approximately 98% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 85% to approximately 97% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 85% to approximately 88% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 90% to approximately 98% by weight of the combination of PNA material and boehmite particles in the PNA washcoat composition or PNA material layer. In some embodiments, cerium oxide (which may include zirconium oxide, lanthanum, lanthanum oxide, yttrium oxide, or a combination thereof) makes up approximately 93% to approximately 95% by weight of the combination of PNA material and boehmite particles in the PNA washcoat composition or PNA material layer.

In some embodiments, the boehmite particles make up approximately 1% to approximately 10% by weight of the combination of PNA material and boehmite particles in the PNA material-containing washcoat composition or PNA material layer. In some embodiments, the boehmite particles make up approximately 2% to approximately 5% by weight of the combination of PNA material and boehmite particles in the PNA material-containing washcoat composition or PNA material layer. In some embodiments, the boehmite particles make up approximately 3% by weight of the combination of PNA material particles and boehmite particles in the PNA material-containing washcoat composition or PNA material layer.

In one embodiment, palladium is used in an amount of from about 0.01% to about 5% (by weight) of the amount of cerium oxide used in the PNA washcoat composition or layer. (As described above, in all embodiments, the cerium oxide can include zirconium oxide, lanthanum, lanthanum oxide, yttrium oxide, or a combination thereof). In one embodiment, palladium is used in an amount of from about 0.5% to about 3% (by weight) of the amount of cerium oxide used in the PNA washcoat composition or layer. In one embodiment, palladium is used in an amount of from about 0.67% to about 2.67% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, Pd is used in an amount of from about 1.5% to about 2.5% (by weight) of the amount of cerium oxide used in the PNA washcoat composition or layer, and the amount of cerium oxide used is from about 100 g/L to about 200 g/L. In another embodiment, Pd is used in an amount of from about 0.5% to about 1.5% (by weight) of the amount of cerium oxide used in the PNA washcoat composition or layer, and the amount of cerium oxide used is from about 250 g/L to about 350 g/L. In another embodiment, Pd is used in an amount of from about 1% to about 2% (by weight) of the amount of cerium oxide used in the PNA washcoat composition or layer, and the amount of cerium oxide used is greater than or equal to about 150 g/L. In another embodiment, Pd is used in an amount of about 2% (by weight) of the amount of cerium oxide used in the PNA washcoat composition or layer, and the amount of cerium oxide used is greater than or equal to about 150 g/L. In another embodiment, Pd is used in an amount of about 1% (by weight) of the amount of cerium oxide used in the PNA washcoat composition or layer, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA washcoat composition or layer is from about 100 g/L to about 350 g/L. In another embodiment, Pd is used in an amount of about 2 g/L to about 4 g/L, and the amount of cerium oxide used in the PNA washcoat composition or layer is from about 100 g/L to about 350 g/L. In another embodiment, Pd is used in an amount of about 3 g/L, and the amount of cerium oxide used in the PNA washcoat composition or layer is from about 150 g/L to about 300 g/L. In another embodiment, Pd is used in an amount of about 1 g/L to about 5 g/L, and the amount of cerium oxide used in the PNA washcoat composition or layer is from greater than or equal to about 150 g/L. In another embodiment, Pd is used in an amount of about 2 g/L to about 4 g/L, and the amount of cerium oxide used in the PNA washcoat composition or layer is from greater than or equal to about 150 g/L. In another embodiment, Pd is used in an amount of about 3 g/L, and the amount of cerium oxide used in the PNA washcoat composition or layer is from greater than or equal to about 150 g/L. The PNA washcoat composition or layer can include Pd in larger (cooler) engine systems (e.g., greater than 2.5 Liters).

In one embodiment, ruthenium is used in an amount of from about 0.01% to about 15% (by weight) of the amount of cerium oxide used in the PNA washcoat composition or layer. (As described above, in all embodiments, the cerium oxide can include zirconium oxide, lanthanum, lanthanum oxide, yttrium oxide, or a combination thereof). In one embodiment, ruthenium is used in an amount of from about 0.5% to about 12% (by weight) of the amount of cerium oxide used in the PNA washcoat composition or layer. In one embodiment, ruthenium is used in an amount of from about 1% to about 10% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, the amount of cerium oxide used in the PNA washcoat composition or layer is greater than or equal to about 300 g/L. In another embodiment, Ru is used in an amount of from about 3% to about 4.5% (by weight) of the amount of cerium oxide used in the PNA washcoat composition or layer, and the amount of cerium oxide used is from about 100 g/L to about 200 g/L. In another embodiment, Ru is used in an amount of from about 1% to about 2.5% (by weight) of the amount of cerium oxide used in the PNA washcoat composition or layer, and the amount of cerium oxide used is from about 250 g/L to about 350 g/L. In another embodiment, Ru is used in an amount of from about 1.67% to about 4% (by weight) of the amount of cerium oxide used in the PNA washcoat composition or layer, and the amount of cerium oxide used is greater than or equal to about 150 g/L. In another embodiment. Ru is used in an amount of from about 1.67% to about 4% (by weight) of the amount of cerium oxide used in the PNA washcoat composition or layer, and the amount of cerium oxide used is greater than or equal to about 300 g/L. In another embodiment, Ru is used in an amount of about 3.33% to about 4% (by weight) of the amount of cerium oxide used in the PNA washcoat composition or layer, and the amount of cerium oxide used is greater than or equal to about 150 g/L. In another embodiment, Ru is used in an amount of about 1.67% to about 2% (by weight) of the amount of cerium oxide used in the PNA washcoat composition or layer, and the amount of cerium oxide used is greater than or equal to about 300 g/L. In another embodiment. Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment, Ru is used in an amount of about 1 g/L to about 20 g/L, and the amount of cerium oxide used in the PNA washcoat composition or layer is from about 100 g/L to about 350 g/L. In another embodiment, Ru is used in an amount of about 3 g/L to about 15 g/L, and the amount of cerium oxide used in the PNA washcoat composition or layer is from about 100 g/L to about 350 g/L. In another embodiment, Ru is used in an amount of about 4 g/L to about 8 g/L, and the amount of cerium oxide used in the PNA washcoat composition or layer is from about 100 g/L to about 350 g/L. In another embodiment, Ru is used in an amount of about 5 g/L to about 6 g/L, and the amount of cerium oxide used in the PNA washcoat composition or layer is from about 150 g/L to about 350 g/L. In another embodiment, Ru is used in an amount of about 1 g/L to about 20 g/L, and the amount of cerium oxide used in the PNA washcoat composition or layer is from greater than or equal to about 150 g/L. In another embodiment. Ru is used in an amount of about 3 g/L to about 15 g/L, and the amount of cerium oxide used in the PNA washcoat composition or layer is from greater than or equal to about 150 g/L. In another embodiment, Ru is used in an amount of about 4 g/L to about 8 g/L, and the amount of cerium oxide used in the PNA washcoat composition or layer is from greater than or equal to about 150 g/L. In another embodiment. Ru is used in an amount of about 5 g/L to about 6 g/L, and the amount of cerium oxide used in the PNA washcoat composition or layer is from greater than or equal to about 150 g/L. In another embodiment, Ru is used in an amount of about 1 g/L to about 20 g/L, and the amount of cerium oxide used in the PNA washcoat composition or layer is from greater than or equal to about 300 g/L. In another embodiment, Ru is used in an amount of about 3 g/L to about 15 g/L. and the amount of cerium oxide used in the PNA washcoat composition or layer is from greater than or equal to about 300 g/L. In another embodiment, Ru is used in an amount of about 4 g/L to about 8 g/L, and the amount of cerium oxide used in the PNA washcoat composition or layer is from greater than or equal to about 300 g/L. In another embodiment, Ru is used in an amount of about 5 g/L to about 6 g/L, and the amount of cerium oxide used in the PNA washcoat composition or layer is from greater than or equal to about 300 g/L. The PNA washcoat composition or layer can include Ru in small (hotter) engine systems (e.g., less than 2 Liters).

In one embodiment, MgO is used in an amount of from about 1% to about 20% (by weight) of the amount of the cerium oxide used in the washcoat or layer. In one embodiment. MgO is used in an amount of from about 1% to about 15% (by weight) of the amount of the cerium oxide used in the washcoat or layer. In one embodiment, MgO is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, MgO is used in an amount of from about 2% to about 8% (by weight) of the amount of the cerium oxide used in the washcoat or layer, and the amount of cerium oxide used is from about 150 g/L to about 350 g/L. In another embodiment, MgO is used in an amount of from about 2% to about 4% (by weight) of the amount of the cerium oxide used in the washcoat or layer, and the amount of cerium oxide used is from about 250 g/L to about 350 g/L. In another embodiment, MgO is used in an amount of from about 6% to about 8% (by weight) of the amount of the cerium oxide used in the washcoat or layer, and the amount of cerium oxide used is from about 150 g/L to about 250 g/L. In another embodiment, MgO is used in an amount of about 3% (by weight) of the amount of the cerium oxide used in the washcoat or layer, and the amount of cerium oxide used is about 350 g/L. In another embodiment, MgO is used in an amount of about 7% (by weight) of the amount of the cerium oxide used in the washcoat or layer, and the amount of cerium oxide used is about 150 g/L. In another embodiment, MgO is used in an amount of about 10.5 g/L, and the amount of cerium oxide used in the washcoat or layer is from about 150 g/L to about 350 g/L.

In one embodiment, Mn₃O₄ is used in an amount of from about 1% to about 30% (by weight) of the amount of the cerium oxide used in the washcoat or layer. In one embodiment, Mn₃O₄ is used in an amount of from about 1% to about 25% (by weight) of the amount of the cerium oxide used in the washcoat or layer. In one embodiment, Mn₃O₄ is used in an amount of from about 1% to about 20% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, Mn₃O₄ is used in an amount of from about 5% to about 20% (by weight) of the amount of the cerium oxide used in the washcoat or layer, and the amount of cerium oxide used is from about 150 g/L to about 350 g/L. In another embodiment, Mn₃O₄ is used in an amount of from about 5% to about 10% (by weight) of the amount of the cerium oxide used in the washcoat or layer, and the amount of cerium oxide used is from about 250 g/L to about 350 g/L. In another embodiment, Mn₃O₄ is used in an amount of from about 15% to about 20% (by weight) of the amount of the cerium oxide used in the washcoat or layer, and the amount of cerium oxide used is from about 150 g/L to about 250 g/L. In another embodiment, Mn₃O₄ is used in an amount of about 8% (by weight) of the amount of the cerium oxide used in the washcoat or layer, and the amount of cerium oxide used is about 350 g/L. In another embodiment, Mn₃O₄ is used in an amount of about 18.67% (by weight) of the amount of the cerium oxide used in the washcoat or layer, and the amount of cerium oxide used is about 150 g/L. In another embodiment, Mn₃O₄ is used in an amount of about 28 g/L, and the amount of cerium oxide used in the washcoat or layer is from about 150 g/L to about 350 g/L.

In one embodiment, calcium oxide is used in an amount of from about 1% to about 20% (by weight) of the amount of the cerium oxide used in the washcoat or layer. In one embodiment, calcium oxide is used in an amount of from about 1% to about 15% (by weight) of the amount of the cerium oxide used in the washcoat or layer. In one embodiment, calcium oxide is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, calcium oxide is used in an amount of from about 2% to about 8% (by weight) of the amount of the cerium oxide used in the washcoat or layer, and the amount of cerium oxide used is from about 150 g/L to about 350 g/L. In another embodiment, calcium oxide is used in an amount of from about 2% to about 4% (by weight) of the amount of the cerium oxide used in the washcoat or layer, and the amount of cerium oxide used in the washcoat or layer is from about 250 g/L to about 350 g/L. In another embodiment, calcium oxide is used in an amount of from about 6% to about 8% (by weight) of the amount of the cerium oxide used in the washcoat or layer, and the amount of cerium oxide used is from about 150 g/L to about 250 g/L. In another embodiment, calcium oxide is used in an amount of about 3% (by weight) of the amount of the cerium oxide used in the washcoat or layer, and the amount of cerium oxide used is about 350 g/L. In another embodiment, calcium oxide is used in an amount of about 7% (by weight) of the amount of the cerium oxide used in the washcoat or layer, and the amount of cerium oxide used is about 150 g/L. In another embodiment, calcium oxide is used in an amount of about 10.5 g/L, and the amount of cerium oxide used in the washcoat or layer is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the washcoat or layer is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the washcoat or layer is from about 150 g/L to about 350 g/L.

In some embodiments, the PNA material-containing washcoat composition or PNA material does not comprise any platinum group metals. As discussed above, the six platinum group metals are ruthenium, rhodium, palladium, osmium, iridium, and platinum. (PGM is often referred to catalyst metals). In some embodiments, the PNA material-containing washcoat composition or PNA material is characterized by a substantial absence of any platinum group metals. In some embodiments, the PNA material-containing washcoat composition or PNA material layer is 100% free of any platinum group metals. In some embodiments, the PNA material containing washcoat composition or PNA material layer is approximately 100% free of any platinum group metals. In some embodiments, the PNA material-containing washcoat composition or PNA material layer does not comprise any catalytic particles. In some embodiments, the PNA material particle-containing washcoat composition or PNA material layer is characterized by a substantial absence of any catalytic particles. In some embodiments, the PNA material particle-containing washcoat composition or PNA material layer is 100% free of any catalytic particles. In some embodiments, the PNA material particle-containing washcoat composition or PNA material layer is approximately 100% free of any catalytic particles.

As discussed above, in other embodiments, the PNA material washcoat may contain PGM. In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

PGM can be added to the support particles using wet chemistry techniques described above. PGM can also be added to the support particles using incipient wetness techniques described above. PGM can be added to support particles using plasma based methods described above. In some embodiments, the PNA material washcoat includes support particles impregnated with alkali oxide or alkaline earth oxide particles and separate PGM particles, including, for example, NNm or NNiM particles. In some embodiments, the micro-sized particles of the PGM NNm and NNiM particles can be the micron-sized supports impregnated with alkali oxide or alkaline earth oxide particles. In some embodiments, the micro-sized particles of the PGM NNm can be impregnated with alkali oxide or alkaline earth oxide particles. In one embodiment, the NNm particles are nano-platinum group metals supported on nano-cerium oxide, wherein the nano-on-nano particles are supported on micron-sized cerium oxide. In another embodiment, the NNiM particles are nano-sized platinum group metals supported on nano-sized cerium oxide. In some embodiments, the platinum group metal is Pt, Pd, Ru, or a mixture thereof. In some embodiments, the alkali oxide or alkaline earth oxide particles and PGM are on the same support particle. In other embodiments, the alkali oxide or alkaline earth oxide particles and PGM are on different support particles. The support particles can also be aluminum oxide.

The composite nanoparticles for use as components of the PNA washcoat or layer can be produced by plasma-based methods as described above.

In some embodiments, the support particles may contain a mixture of 2:1 to 100:1 platinum to palladium. In some embodiments, the support particles may contain a mixture of 2:1 to 75:1 platinum to palladium. In some embodiments, the support particles may contain a mixture of 2:1 to 50:1 platinum to palladium. In some embodiments, the support particles may contain a mixture of 2:1 to 25:1 platinum to palladium. In some embodiments, the support particles may contain a mixture of 2:1 to 15:1 platinum to palladium. In some embodiments, the support particles may contain a mixture of 2:1 to 10:1 platinum to palladium. In some embodiments, the support particles may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the PNA material-containing washcoat composition or PNA material layer may include zeolites.

In some embodiments, the PNA material-containing washcoat composition is mixed with water and acid, such as acetic acid, prior to coating of a substrate with the PNA material-containing washcoat composition, thereby forming an aqueous mixture of the PNA material-containing washcoat composition, water, and acid. This aqueous mixture of the PNA material-containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

The washcoat layers can include materials that are less active or inert to exhausts. Such materials can be incorporated as supports for the reactive catalysts or to provide surface area for the metals. In some embodiments, the catalyst-containing washcoat composition further includes “spacer” or “filler” particles, where the spacer particles may, for example, be ceramic, metal oxide, or metallic particles. In some embodiments, the spacer particles may be boehmite.

In some embodiment, the PNA material is formed by loading platinum group metal into support particles by wet chemistry methods. The platinum group metal is preferably palladium. The support particles are generally micron-sized particles. In some embodiments, the support particles are micron-sized particles comprising ceria, such as HSA20 particles (Rhodia). The platinum group metal is loaded into the support particles by dissolving a platinum group metal salt, such as palladium nitrate, in a solvent (such as water) and mixing the dissolved salt with the support particles. For example, in some embodiments, palladium nitrate is dissolved in water and mixed with micron-sized ceria particles. The platinum group metal content of the PNA material is generally about 0.5 wt % to about 4 wt %/o palladium (such as about 1 wt % to about 3 wt % palladium, or about 2 wt % palladium). In some embodiments, the support particles mixed with the platinum group metal salt are dried and calcined. The calcination process results in the formation of metallic platinum group metal loaded into the support particles.

In some embodiments, the platinum group metal (e.g., palladium) loaded support particles are pre-formed before being combined with additional materials (such as filler particles and/or boehmite) to form the PNA washcoat. In another embodiment, the platinum group metal salt is dissolved and mixed with the support particles to form a dispersion, which is then combined with the additional materials (such as filler particles and/or boehmite) to form the PNA washcoat. In such an embodiment, the PNA washcoat comprising the platinum group metal salt is coated onto the substrate and calcined to form the PNA layer.

### PNA Material/Zeolite Washcoat Compositions and PNA/Zeolite Layers

The PNA material and zeolite particles can be applied to a substrate of a catalytic converter as part of the same washcoat. Both the PNA material and the zeolite particles can be used to trap hazardous gases during cold start of an internal combustion engine.

In some embodiments, the PNA material and the zeolite particles layer (P/Z layer) and washcoat compositions comprise, consist essentially of, or consist of PNA material, zeolite particles, boehmite particles, and metal-oxide particles. The metal-oxide particles are preferably porous. The metal-oxide particles may be aluminum-oxide particles (e.g., MI-386 from Grace Davison or the like) or cerium oxide particles. The aluminum-oxide particles may be porous. Different configurations of the weight concentrations of the PNA material, zeolite particles, boehmite particles, and metal-oxide particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The P/Z layer refers to the P/Z washcoat composition after it has been applied to the substrate, dried, and calcined.

In some embodiments, the PNA material and zeolite particles comprise at least 50%, comprise more than about 50%, or comprise about 50% to about 100% by weight of the combination of PNA material, zeolite particles, boehmite particles, and metal-oxide particles in the P/Z washcoat composition or P/Z I layer. In some embodiments, the PNA material and zeolite particles make up approximately 60% to approximately 80%, for example, approximately 65% to approximately 70% or approximately 70% to approximately 80%, by weight of the combination of PNA material, zeolite particles, boehmite particles, and metal-oxide particles in the P/Z-containing washcoat composition or P/Z layer.

In some embodiments, the boehmite particles make up approximately 1% to approximately 10% by weight of the combination of PNA material, zeolite particles, boehmite particles, and metal-oxide particles in the P/Z-containing washcoat composition or P/Z layer. In some embodiments, the boehmite particles make up approximately 2% to approximately 5% by weight of the combination of PNA material, zeolite particles, boehmite particles, and metal-oxide particles in the P/Z-containing washcoat composition or P/Z layer. In some embodiments, the boehmite particles make up approximately 3% by weight of the combination of PNA material, zeolite particles, boehmite particles, and metal-oxide particles in the P/Z-containing washcoat composition or P/Z layer.

In one embodiment, palladium is used in an amount of from about 0.01% to about 5% (by weight) of the amount of cerium oxide used in the PNA washcoat composition or layer. (As described above, in all embodiments, the cerium oxide can include zirconium oxide, lanthanum, lanthanum oxide, yttrium oxide, or a combination thereof). In one embodiment, palladium is used in an amount of from about 0.5% to about 3% (by weight) of the amount of cerium oxide used in the PNA washcoat composition or layer. In one embodiment, palladium is used in an amount of from about 0.67%/o to about 2.67% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, Pd is used in an amount of from about 1.5% to about 2.5% (by weight) of the amount of cerium oxide used in the PNA washcoat composition or layer, and the amount of cerium oxide used is from about 100 g/L to about 200 g/L. In another embodiment. Pd is used in an amount of from about 0.5% to about 1.5% (by weight) of the amount of cerium oxide used in the PNA washcoat composition or layer, and the amount of cerium oxide used is from about 250 g/L to about 350 g/L. In another embodiment, Pd is used in an amount of from about 1% to about 2% (by weight) of the amount of cerium oxide used in the PNA washcoat composition or layer, and the amount of cerium oxide used is greater than or equal to about 150 g/L. In another embodiment, Pd is used in an amount of about 2% (by weight) of the amount of cerium oxide used in the PNA washcoat composition or layer, and the amount of cerium oxide used is greater than or equal to about 150 g/L. In another embodiment, Pd is used in an amount of about 1% (by weight) of the amount of cerium oxide used in the PNA washcoat composition or layer, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L. and the amount of cerium oxide used in the PNA washcoat composition or layer is from about 100 g/L to about 350 g/L. In another embodiment, Pd is used in an amount of about 2 g/L to about 4 g/L, and the amount of cerium oxide used in the PNA washcoat composition or layer is from about 100 g/L to about 350 g/L. In another embodiment, Pd is used in an amount of about 3 g/L, and the amount of cerium oxide used in the PNA washcoat composition or layer is from about 150 g/L to about 300 g/L. In another embodiment, Pd is used in an amount of about 1 g/L to about 5 g/L, and the amount of cerium oxide used in the PNA washcoat composition or layer is from greater than or equal to about 150 g/L. In another embodiment, Pd is used in an amount of about 2 g/L to about 4 g/L, and the amount of cerium oxide used in the PNA washcoat composition or layer is from greater than or equal to about 150 g/L. In another embodiment. Pd is used in an amount of about 3 g/L, and the amount of cerium oxide used in the PNA washcoat composition or layer is from greater than or equal to about 150 g/L. The PNA washcoat composition or layer can include Pd in larger (cooler) engine systems (e.g., greater than 2.5 Liters).

In one embodiment, ruthenium is used in an amount of from about 0.01% to about 15% (by weight) of the amount of cerium oxide used in the PNA washcoat composition or layer. (As described above, in all embodiments, the cerium oxide can include zirconium oxide, lanthanum, lanthanum oxide, yttrium oxide, or a combination thereof). In one embodiment, ruthenium is used in an amount of from about 0.5% to about 12% (by weight) of the amount of cerium oxide used in the PNA washcoat composition or layer. In one embodiment, ruthenium is used in an amount of from about 1% to about 10% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, the amount of cerium oxide used in the PNA washcoat composition or layer is greater than or equal to about 300 g/L. In another embodiment, Ru is used in an amount of from about 3% to about 4.5% (by weight) of the amount of cerium oxide used in the PNA washcoat composition or layer, and the amount of cerium oxide used is from about 100 g/L to about 200 g/L. In another embodiment, Ru is used in an amount of from about 1% to about 2.5% (by weight) of the amount of cerium oxide used in the PNA washcoat composition or layer, and the amount of cerium oxide used is from about 250 g/L to about 350 g/L. In another embodiment, Ru is used in an amount of from about 1.67% to about 4% (by weight) of the amount of cerium oxide used in the PNA washcoat composition or layer, and the amount of cerium oxide used is greater than or equal to about 150 g/L. In another embodiment, Ru is used in an amount of from about 1.67% to about 4% (by weight) of the amount of cerium oxide used in the PNA washcoat composition or layer, and the amount of cerium oxide used is greater than or equal to about 300 g/L. In another embodiment, Ru is used in an amount of about 3.33% to about 4% (by weight) of the amount of cerium oxide used in the PNA washcoat composition or layer, and the amount of cerium oxide used is greater than or equal to about 150 g/L. In another embodiment, Ru is used in an amount of about 1.67% to about 2% (by weight) of the amount of cerium oxide used in the PNA washcoat composition or layer, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment. Ru is used in an amount of about 5 g/L to about 6 g/L. In another embodiment, Ru is used in an amount of about 1 g/L to about 20 g/L, and the amount of cerium oxide used in the PNA washcoat composition or layer is from about 100 g/L to about 350 g/L. In another embodiment, Ru is used in an amount of about 3 g/L to about 15 g/L, and the amount of cerium oxide used in the PNA washcoat composition or layer is from about 100 g/L to about 350 g/L. In another embodiment, Ru is used in an amount of about 4 g/L to about 8 g/L. and the amount of cerium oxide used in the PNA washcoat composition or layer is from about 100 g/L to about 350 g/L. In another embodiment, Ru is used in an amount of about 5 g/L to about 6 g/L, and the amount of cerium oxide used in the PNA washcoat composition or layer is from about 150 g/L to about 350 g/L. In another embodiment, Ru is used in an amount of about 1 g/L to about 20 g/L, and the amount of cerium oxide used in the PNA washcoat composition or layer is from greater than or equal to about 150 g/L. In another embodiment, Ru is used in an amount of about 3 g/L to about 15 g/L. and the amount of cerium oxide used in the PNA washcoat composition or layer is from greater than or equal to about 150 g/L. In another embodiment, Ru is used in an amount of about 4 g/L to about 8 g/L, and the amount of cerium oxide used in the PNA washcoat composition or layer is from greater than or equal to about 150 g/L. In another embodiment, Ru is used in an amount of about 5 g/L to about 6 g/L, and the amount of cerium oxide used in the PNA washcoat composition or layer is from greater than or equal to about 150 g/L. In another embodiment, Ru is used in an amount of about 1 g/L to about 20 g/L, and the amount of cerium oxide used in the PNA washcoat composition or layer is from greater than or equal to about 300 g/L. In another embodiment, Ru is used in an amount of about 3 g/L to about 15 g/L, and the amount of cerium oxide used in the PNA washcoat composition or layer is from greater than or equal to about 300 g/L. In another embodiment. Ru is used in an amount of about 4 g/L to about 8 g/L, and the amount of cerium oxide used in the PNA washcoat composition or layer is from greater than or equal to about 300 g/L. In another embodiment, Ru is used in an amount of about 5 g/L to about 6 g/L, and the amount of cerium oxide used in the PNA washcoat composition or layer is from greater than or equal to about 300 g/L. The PNA washcoat composition or layer can include Ru in small (hotter) engine systems (e.g., less than 2 Liters).

In one embodiment, MgO is used in an amount of from about 1% to about 20% (by weight) of the amount of the cerium oxide used in the washcoat or layer. In one embodiment, MgO is used in an amount of from about 1% to about 15% (by weight) of the amount of the cerium oxide used in the washcoat or layer. In one embodiment, MgO is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, MgO is used in an amount of from about 2% to about 8% (by weight) of the amount of the cerium oxide used in the washcoat or layer, and the amount of cerium oxide used is from about 150 g/L to about 350 g/L. In another embodiment, MgO is used in an amount of from about 2% to about 4% (by weight) of the amount of the cerium oxide used in the washcoat or layer, and the amount of cerium oxide used is from about 250 g/L to about 350 g/L. In another embodiment. MgO is used in an amount of from about 6% to about 8% (by weight) of the amount of the cerium oxide used in the washcoat or layer, and the amount of cerium oxide used is from about 150 g/L to about 250 g/L. In another embodiment, MgO is used in an amount of about 3% (by weight) of the amount of the cerium oxide used in the washcoat or layer, and the amount of cerium oxide used is about 350 g/L. In another embodiment, MgO is used in an amount of about 7% (by weight) of the amount of the cerium oxide used in the washcoat or layer, and the amount of cerium oxide used is about 150 g/L. In another embodiment, MgO is used in an amount of about 10.5 g/L, and the amount of cerium oxide used in the washcoat or layer is from about 150 g/L to about 350 g/L.

In one embodiment, Mn₃O₄ is used in an amount of from about 1% to about 30% (by weight) of the amount of the cerium oxide used in the washcoat or layer. In one embodiment, Mn₃O₄ is used in an amount of from about 1% to about 25% (by weight) of the amount of the cerium oxide used in the washcoat or layer. In one embodiment, Mn₃O₄ is used in an amount of from about 1% to about 20% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, Mn₃O₄ is used in an amount of from about 5% to about 20% (by weight) of the amount of the cerium oxide used in the washcoat or layer, and the amount of cerium oxide used is from about 150 g/L to about 350 g/L. In another embodiment, Mn₃O₄ is used in an amount of from about 5% to about 10% (by weight) of the amount of the cerium oxide used in the washcoat or layer, and the amount of cerium oxide used is from about 250 g/L to about 350 g/L. In another embodiment. Mn₃O₄ is used in an amount of from about 15% to about 20% (by weight) of the amount of the cerium oxide used in the washcoat or layer, and the amount of cerium oxide used is from about 150 g/L to about 250 g/L. In another embodiment. Mn₃O₄ is used in an amount of about 8% (by weight) of the amount of the cerium oxide used in the washcoat or layer, and the amount of cerium oxide used is about 350 g/L. In another embodiment, Mn₃O₄ is used in an amount of about 18.67% (by weight) of the amount of the cerium oxide used in the washcoat or layer, and the amount of cerium oxide used is about 150 g/L. In another embodiment, Mn₃O₄ is used in an amount of about 28 g/L, and the amount of cerium oxide used in the washcoat or layer is from about 150 g/L to about 350 g/L.

In one embodiment, calcium oxide is used in an amount of from about 1% to about 20% (by weight) of the amount of the cerium oxide used in the washcoat or layer. In one embodiment, calcium oxide is used in an amount of from about 1% to about 15% (by weight) of the amount of the cerium oxide used in the washcoat or layer. In one embodiment, calcium oxide is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, calcium oxide is used in an amount of from about 2% to about 8% (by weight) of the amount of the cerium oxide used in the washcoat or layer, and the amount of cerium oxide used is from about 150 g/L to about 350 g/L. In another embodiment, calcium oxide is used in an amount of from about 2% to about 4% (by weight) of the amount of the cerium oxide used in the washcoat or layer, and the amount of cerium oxide used in the washcoat or layer is from about 250 g/L to about 350 g/L. In another embodiment, calcium oxide is used in an amount of from about 6% to about 8% (by weight) of the amount of the cerium oxide used in the washcoat or layer, and the amount of cerium oxide used is from about 150 g/L to about 250 g/L. In another embodiment, calcium oxide is used in an amount of about 3% (by weight) of the amount of the cerium oxide used in the washcoat or layer, and the amount of cerium oxide used is about 350 g/L. In another embodiment, calcium oxide is used in an amount of about 7% (by weight) of the amount of the cerium oxide used in the washcoat or layer, and the amount of cerium oxide used is about 150 g/L. In another embodiment, calcium oxide is used in an amount of about 10.5 g/L, and the amount of cerium oxide used in the washcoat or layer is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the washcoat or layer is from about 150 g/L to about 350 g/L.

In some embodiments, the metal-oxide particles make up approximately 15% to approximately 38%, for example, approximately 15% to approximately 30%, approximately 17% to approximately 23% or approximately 17% to approximately 22%, by weight of the mixture of PNA material particles, zeolite particles, metal-oxide particles, and boehmite particles in the P/Z-containing washcoat composition or P/Z layer. In some embodiments, the metal-oxide particles make up approximately 15% to approximately 23% by weight of the mixture of PNA material, zeolite particles, metal-oxide particles, and boehmite particles in the P/Z-containing washcoat composition or P/Z layer. In some embodiments, the metal-oxide particles make up approximately 25% to approximately 35% by weight of the mixture of PNA material, zeolite particles, metal-oxide particles, and boehmite particles in the P/Z-containing washcoat composition or P/Z layer. In some embodiments, the P/Z containing washcoat composition or P/Z layer contains about 3% boehmite particles, about 67% PNA material and zeolite particles, and about 30% porous aluminum-oxide particles.

In some embodiments, the P/Z-containing washcoat composition or P/Z does not comprise any platinum group metals. As discussed above, the six platinum group metals are ruthenium, rhodium, palladium, osmium, iridium, and platinum. In some embodiments, the P/Z containing washcoat composition or P/Z is characterized by a substantial absence of any platinum group metals. In some embodiments, the P/Z-containing washcoat composition or P/Z layer is 100% free of any platinum group metals. In some embodiments, the P/Z containing washcoat composition or P/Z layer is approximately 100% free of any platinum group metals. In some embodiments, the P/Z-containing washcoat composition or P/Z layer does not comprise any catalytic particles. In some embodiments, the P/Z particle-containing washcoat composition or P/Z layer is characterized by a substantial absence of any catalytic particles. In some embodiments, the P/Z-containing washcoat composition or P P/Z layer is 100% free of any catalytic particles. In some embodiments, the P/Z containing washcoat composition or P/Z layer is approximately 100% free of any catalytic particles.

In other embodiments, the P/Z washcoat may comprise PGM. In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

PGM can be added to the support particles using wet chemistry techniques described above. PGM can also be added to the support particles using incipient wetness techniques described above. PGM can be added to support particles using plasma based methods described above. In some embodiments, the PNA material washcoat includes support particles impregnated with alkali oxide or alkaline earth oxide particles and separate PGM particles, including, for example, NNm or NNiM particles. In some embodiments, the micro-sized particles of the PGM NNm and NNiM particles can be the micron-sized supports impregnated with alkali oxide or alkaline earth oxide particles. In some embodiments, the micro-sized particles of the PGM NNm can be impregnated with alkali oxide or alkaline earth oxide particles. In one embodiment, the NNm particles are nano-platinum group metals supported on nano-cerium oxide, wherein the nano-on-nano particles are supported on micron-sized cerium oxide. In another embodiment, the NNiM particles are nano-sized platinum group metals supported on nano-sized cerium oxide. In some embodiments, the platinum group metal is Pt, Pd, Ru, or a mixture thereof. In some embodiments, the alkali oxide or alkaline earth oxide particles and PGM are on the same support particle. In other embodiments, the alkali oxide or alkaline earth oxide particles and PGM are on different support particles. The support particles can also be aluminum oxide.

The composite nanoparticles for use as components of the P/Z washcoat or layer can be produced by plasma-based methods as described above.

In some embodiments, the support particles may contain a mixture of 2:1 to 100:1 platinum to palladium. In some embodiments, the support particles may contain a mixture of 2:1 to 75:1 platinum to palladium. In some embodiments, the support particles may contain a mixture of 2:1 to 50:1 platinum to palladium. In some embodiments, the support particles may contain a mixture of 2:1 to 25:1 platinum to palladium. In some embodiments, the support particles may contain a mixture of 2:1 to 15:1 platinum to palladium. In some embodiments, the support particles may contain a mixture of 2:1 to 10:1 platinum to palladium. In some embodiments, the support particles may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the P/Z-containing washcoat composition or P/Z layer may include by weight about 2% to about 5% boehmite particles, about 60% to about 80% PNA material and zeolite particles, and the rest porous aluminum-oxide particles (i.e., about 15% to about 38%). In one embodiment, the P/Z containing washcoat composition or P/Z layer includes by weight about 2% to about 5% boehmite particles, about 75% to about 80% PNA material and zeolite particles, and the rest porous aluminum-oxide particles (i.e., about 15% to about 23%). In another embodiments, the P/Z containing washcoat composition or P/Z 1 layer includes by weight about 2% to about 5% boehmite particles, about 65% to about 70% PNA material and zeolite particles, and the rest porous aluminum-oxide particles (i.e., about 25% to about 33%). In some embodiment, the P/Z containing washcoat composition or P/Z layer contains about 3% boehmite particles, about 67% PNA material and zeolite particles, and about 30% porous aluminum-oxide particles. In some embodiments, the P/Z containing washcoat composition or P/Z layer does not contain any catalytic material. In some embodiments, the P/Z containing washcoat composition or P/Z layer does not contain any platinum group metals.

In some embodiments, the P/Z containing washcoat composition is mixed with water and acid, such as acetic acid, prior to coating of a substrate with the P/Z containing washcoat composition, thereby forming an aqueous mixture of the P/Z containing washcoat composition, water, and acid. This aqueous mixture of the P/Z containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

The washcoat layers can include materials that are less active or inert to exhausts. Such materials can be incorporated as supports for the reactive catalysts or to provide surface area for the metals. In some embodiments, the catalyst-containing washcoat composition further includes “spacer” or “filler” particles, where the spacer particles may, for example, be ceramic, metal oxide, or metallic particles. In some embodiments, the spacer particles may be boehmite.

### PNA Material/Zeolite/Catalytic Washcoat Compositions and PNA/Zeolite/Catalyst Layers

The PNA material, zeolite particles, and catalytic material can be applied to a substrate of a catalytic converter as part of the same washcoat, thereby eliminated the need for excess washcoats. Both the PNA material and the zeolite particles can be used to trap hazardous gases during cold start of an internal combustion engine and the catalytic particles can reduce and oxidize the hazardous particles when they are released from the zeolites and PNA material.

In some embodiments, the PNA material and the zeolite particles layer (P/Z layer) and washcoat compositions comprise, consist essentially of, or consist of PNA material, zeolite particles, boehmite particles, metal-oxide particles, silica particles, alumina/sealant particles with or without BaO, and NNm particles. The compositions of the zeolite particles, PNA material, and catalytic particles can be any of those described above.

### Catalytic Converters and Methods of Producing Catalytic Converters

In some embodiments, the disclosure provides for catalytic converters, which can comprise any of the washcoat layers and washcoat configurations described herein. The catalytic converters are useful in a variety of applications, such as in diesel or gasoline vehicles, such as in light-duty diesel or gasoline vehicles.

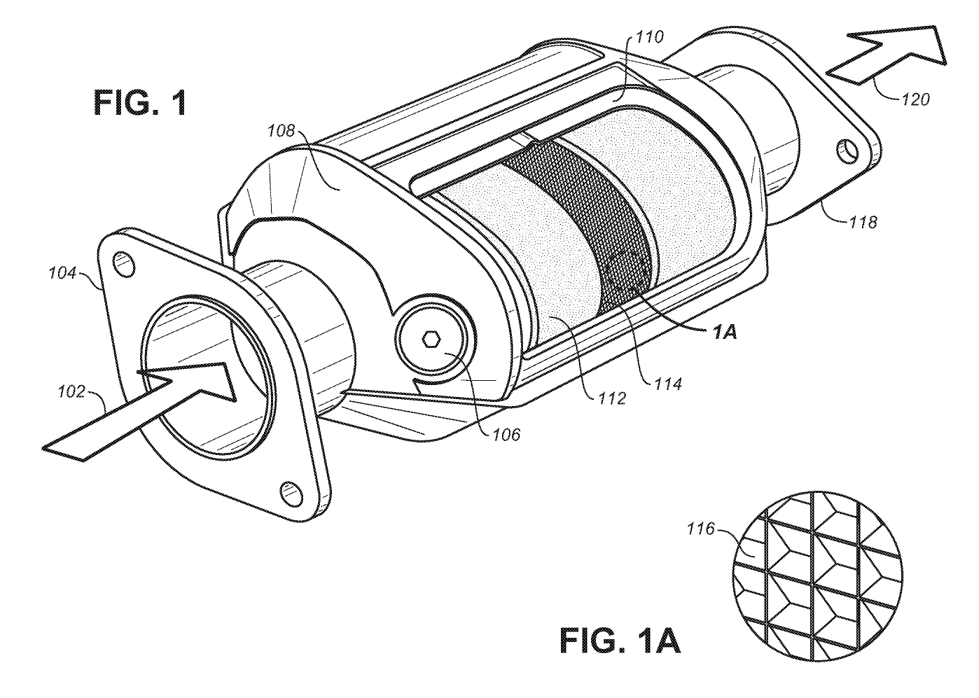

FIG. 1 illustrates a catalytic converter in accordance with some embodiments. Catalytic material is included in a washcoat composition, which is coated onto a substrate to form a coated substrate. The coated substrate 114 is enclosed within an insulating material 112, which in turn is enclosed within a metallic container 110 (of, for example, stainless steel). A heat shield 108 and a gas sensor (for example, an oxygen sensor) 106 are depicted. The catalytic converter may be affixed to the exhaust system of the vehicle through flanges 104 and 118. The exhaust gas, which includes the raw emissions of hydrocarbons, carbon monoxide, and nitrogen oxides, enters the catalytic converter at 102. As the raw emissions pass through the catalytic converter, they react with the catalytic material on the coated substrate, resulting in tailpipe emissions of water, carbon dioxide, and nitrogen exiting at 120. FIG. 1A is a magnified view of a section of the coated substrate 114, which shows the honeycomb structure of the coated substrate. The coated substrates, as described below, may be incorporated into a catalytic converter for use in a vehicle emissions control system.

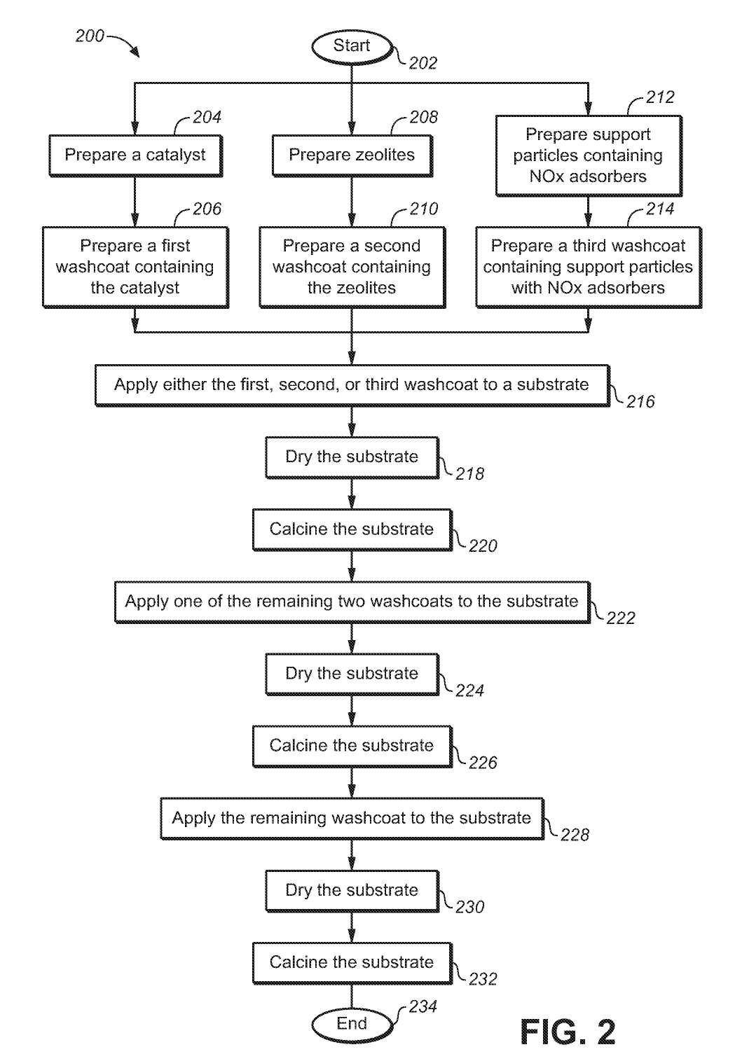

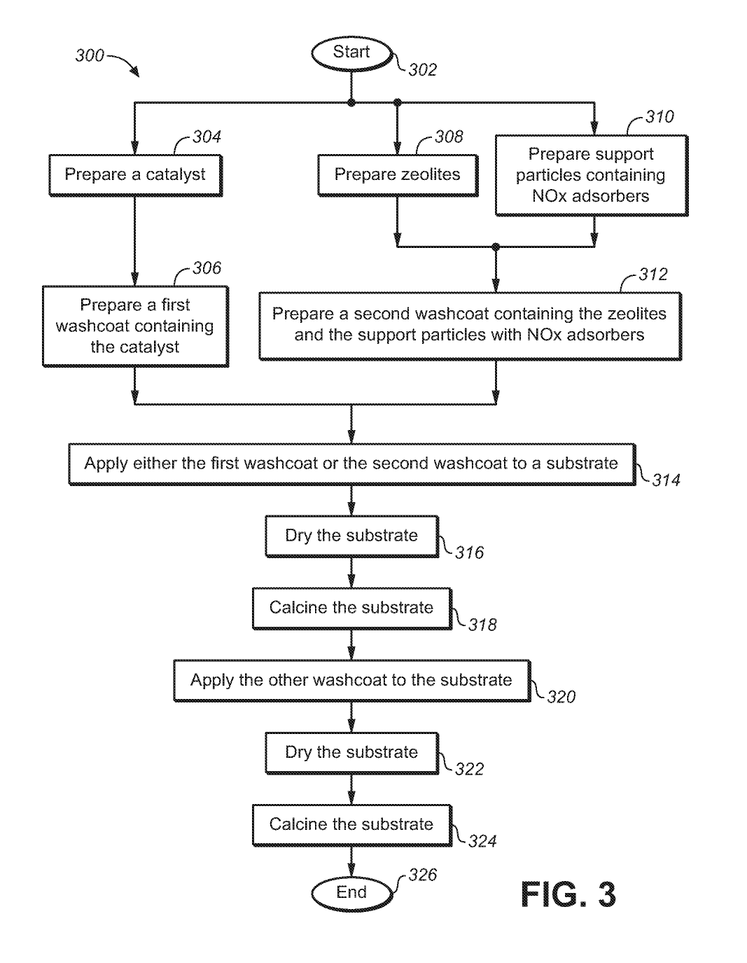

FIGS. 2 and 3 illustrate various methods of forming coated substrates for use in a catalytic converter. Any of the catalyst-containing washcoats, zeolite particle-containing washcoats, and PNA material-containing washcoats disclosed herein can be used in these illustrative methods. In addition, any of the corner-fill washcoats disclosed herein can be used in any of the illustrative methods. In addition, layers or washcoats can be added to or removed from the substrates in any order.

FIG. 2 is a flow chart illustrating a PNA system preparation method 200 in accordance with embodiments of the present disclosure. The PNA system includes catalytic particles, zeolites, and PNA material in separate washcoat layers on a substrate.

The PNA system preparation method 200 can start from Step 202. At Step 204, a catalyst is prepared. At Step 206, a first washcoat containing the catalyst is prepared. At Step 208, zeolite particles are prepared. At Step 210, a second washcoat containing the zeolite is prepared. At step 212, support particles containing NOₓ adsorbers are prepared. At Step 214, a third washcoat containing the support particles containing NOₓ adsorbers is prepared. At Step 216, either the first washcoat, the second, or the third washcoat is applied to a substrate. At Step 218, the substrate is dried. Examples of such drying processes include, but are not limited to, a hot-drying process, or a flash drying process. At Step 220, the washcoat-covered substrate is calcined. It is contemplated that the length and temperature of the calcination process can vary depending on the characteristics of the components in a particular embodiment. At Step 222, one of the remaining two washcoats is applied on the substrate. At Step 224, the substrate is dried. Examples of such drying processes include, but are not limited to, a hot-drying process, or a flash drying process. At Step 226, the washcoat-covered substrate is calcined. It is contemplated that the length and temperature of the calcination process can vary depending on the characteristics of the components in a particular embodiment. At Step 228, the final remaining washcoat is applied on the substrate. At Step 230, the substrate is dried. At Step 232, the washcoat-covered substrate with catalytic particles, zeolite particles, and support particles impregnated with NOₓ storing materials contained in separate layers is calcined. It is contemplated that the length and temperature of the calcination process can vary depending on the characteristics of the components in a particular embodiment. The method 200 ends at Step 234. The oxide-oxide bonds formed during the calcination process firmly retain the nanoparticles, so that the chances for the nanoparticles to move at high temperature and to encounter and react with each other are avoided.

The method 200 can be readily modified to apply additional washcoat layers as desired, before or after any step illustrated. Preferably, a drying process and a calcining process are performed between each coating step.

FIG. 3 is a flow chart illustrating an PNA system preparation method 300 in accordance with embodiments of the present disclosure. The PNA system includes catalytic particles in a washcoat layer on a substrate and zeolites and PNA material contained in a separate single washcoat layer.

The PNA system preparation method 300 can start from Step 302. At Step 304, a catalyst is prepared. At Step 306, a first washcoat containing the catalyst is prepared. At Step 308, zeolites are prepared. At step 310, support particles containing NOₓ adsorbers are prepared. At Step 312, a second washcoat containing the zeolites and the support particles for NOₓ adsorption/storage is prepared. At Step 314, either the first washcoat or the second washcoat is applied to a substrate. At Step 316, the substrate is dried. Examples of such drying processes include, but are not limited to, a hot-drying process, or a flash drying process. At Step 318, the washcoat-covered substrate is calcined. It is contemplated that the length and temperature of the calcination process can vary depending on the characteristics of the components in a particular embodiment. At Step 320, the other washcoat is applied on the substrate. At Step 322, the substrate is dried. Examples of such drying processes include, but are not limited to, a hot-drying process, or a flash drying process. At Step 324, the washcoat-covered substrate with catalytic particles, and zeolite particles and support particles impregnated with NOₓ storing materials contained in the same layer, is calcined. It is contemplated that the length and temperature of the calcination process can vary depending on the characteristics of the components in a particular embodiment. The method 300 ends at Step 326. The oxide-oxide bonds formed during the calcination process firmly retain the nanoparticles, so that the chances for the nanoparticles to move at high temperature and to encounter and react with each other are avoided.

The method 300 can be readily modified to apply additional washcoat layers as desired, before or after any step illustrated. Preferably, a drying process and a calcining process are performed between each coating step.

In addition, a PNA system can include catalytic particles, zeolites, and PNA material contained in a single washcoat layer on a substrate.

FIG. 4 shows a single rectangular channel 400 in a coated substrate coated in the S-F—C-P-Z configuration, without additional washcoat layers. The wall 410 of the substrate channel has been coated with corner-fill washcoat layer 420, then catalyst-containing washcoat layer 430, then PNA material-containing washcoat layer 440, then zeolite particle-containing washcoat layer 450. Exhaust gases pass through the lumen 460 of the channel when the coated substrate is employed in a catalytic converter as part of an emissions control system.

### Exhaust Systems, Vehicles, and Emissions Performance

Emission standards for unburned hydrocarbons, carbon monoxide and nitrogen oxide contaminants have been set by various governments and must be met by older, as well as new, vehicles. In order to meet such standards, catalytic converters containing a PNA system are located in the exhaust gas line of internal combustion engines. PNA systems first store, then reduce, nitrogen oxides to nitrogen.

In some embodiments, a coated substrate as disclosed herein is housed within a catalytic converter in a position configured to receive exhaust gas from an internal combustion engine, such as in an exhaust system of an internal combustion engine. The catalytic converter can be used with the exhaust from a diesel or gasoline engine, such as a light-duty diesel or gasoline engine. The catalytic converter can be installed on a vehicle containing a diesel or gasoline engine, such as a light-duty diesel or gasoline engine. The catalytic converter may even be installed on a vehicle containing a gasoline engine.

The coated substrate is placed into a housing, such as that shown in FIG. 1, which can in turn be placed into an exhaust system (also referred to as an exhaust treatment system) of an internal combustion engine. The internal combustion engine can be a diesel or gasoline engine, such as a light-duty diesel or gasoline engine, such as the engine of a light-duty diesel or gasoline vehicle. The exhaust system of the internal combustion engine receives exhaust gases from the engine, typically into an exhaust manifold, and delivers the exhaust gases to an exhaust treatment system. The catalytic converter forms part of the exhaust system and is often referred to as the diesel oxidation catalyst (DOC). An example of a DOC can be found in U.S. patent application Ser. Nos. 13/589,024, 14/340,351, & 14/521,295 and U.S. Pat. No. 8,679,433, which are hereby incorporated by reference in its entirety. The exhaust system can also include a diesel particulate filter (DPF) and/or a selective catalytic reduction unit (SCR unit) and/or a lean NOₓ trap (LNT); typical arrangements, in the sequence that exhaust gases are received from the engine, are DOC-DPF and DOC-DPF-SCR or in an LNT system. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

“Treating” an exhaust gas, such as the exhaust gas from a gasoline or diesel or gasoline engine, refers to having the exhaust gas proceed through an exhaust system (exhaust treatment system) prior to release into the environment.

The United States Environmental Protection Agency defines a “light-duty diesel vehicle” (“LDDV”) as a diesel-powered motor vehicle, other than a diesel bus, that has a gross vehicle weight rating of 8,500 pounds or less and is designed primarily for transporting persons or property. In Europe, a “light-duty diesel or gasoline engine” has been considered to be an engine used in a vehicle of 3.5 metric tons or less (7,716 pounds or less) (see European directives 1992/21 EC and 1995/48 EC). In some embodiments, a light-duty diesel vehicle is a diesel vehicle weighing about 8,500 pounds or less, or about 7,700 pounds or less, and a light-duty diesel engine is an engine used in a light-duty diesel vehicle.

When used in a catalytic converter, the coated substrates disclosed herein may provide a significant improvement over other catalytic converters. The PNA material or the PNA material and the zeolites in the coated substrate act as an intermediate storage device for the exhaust gases while the exhaust gas is still cold. The undesirable gases (including, but not limited to, hydrocarbons, carbon monoxide, and nitrogen oxides or NOₓ) adsorb to the PNA material or the PNA and zeolites (NOₓ adsorbs to the PNA material) during the cold start phase, while the catalyst is not yet active, and are released later when the catalyst reaches a temperature sufficient to effectively decompose the gases (that is, the light-off temperature). The coated substrates, catalytic converters, and exhaust treatment systems described herein are useful for any vehicle employing an LNT. SCR, or other NSC system.

In some embodiments, catalytic converters and exhaust treatment systems employing the coated substrates disclosed herein display emissions of 3400 mg/mile or less of CO emissions and 400 mg/mile or less of NOₓ emissions; 3400 mg/mile or less of CO emissions and 200 mg/mile or less of NOₓ emissions; or 1700 mg/mile or less of CO emissions and 200 mg/mile or less of NOₓ emissions. The disclosed coated substrates, used as catalytic converter substrates, can be used in an emission system to meet or exceed these standards. In some embodiments, the coated substrate is used in a catalytic converter (diesel oxidation catalyst) in the configuration DOC-DPF or DOC-DPF-SCR or in an LNT system to meet or exceed these standards.

Emissions limits for Europe are summarized at the URL europa.eu/legislation_summaries/environment/air_pollution/128186_en.htm. The Euro 5 emissions standards, in force as of September 2009, specify a limit of 500 mg/km of CO emissions, 180 mg/km of NOₓ emissions, and 230 mg/km of HC (hydrocarbon)+NOₓ emissions. The Euro 6 emissions standards, scheduled for implementation as of September 2014, specify a limit of 500 mg/km of CO emissions, 80 mg/km of NOₓ emissions, and 170 mg/km of HC (hydrocarbon)+NOₓ emissions. The disclosed catalytic converter substrates can be used in an emission system to meet or exceed these standards. In some embodiments, the coated substrate is used in a catalytic converter (diesel oxidation catalyst) in the configuration DOC-DPF or DOC-DPF-SCR or in an LNT system to meet or exceed these standards.

In some embodiments, a catalytic converter made with a coated substrate of the present disclosure, loaded with 4.0 g/L of PGM or less displays a carbon monoxide light-off temperature at least 5° C. lower than a catalytic converter made with wet chemistry methods and having the same or similar PGM loading. In some embodiments, a catalytic converter made with a coated substrate of the present disclosure, loaded with 4.0 g/L of PGM or less, displays a carbon monoxide light-off temperature at least 10° C. lower than a catalytic converter made with wet chemistry methods and having the same or similar PGM loading. In some embodiments, a catalytic converter made with a coated substrate of the present disclosure, loaded with 4.0 g/L of PGM or less, displays a carbon monoxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 4.0 g/L of PGM or less, displays a hydrocarbon light-off temperature at least 5° C. lower than a catalytic converter made with wet chemistry methods and having the same or similar PGM loading. In some embodiments, a catalytic converter made with a coated substrate of the present disclosure, loaded with 4.0 g/L of PGM or less, displays a hydrocarbon light-off temperature at least 10° C. lower than a catalytic converter made with wet chemistry methods and having the same or similar PGM loading. In some embodiments, a catalytic converter made with a coated substrate of the present disclosure, loaded with 4.0 g/L of PGM or less, displays a hydrocarbon light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100.000 miles, about 125,000 km, about 125,000 miles, about 150.000 km, or about 150,000 miles of operation (for both the catalytic converter made with a coated substrate of the present disclosure and the comparative catalytic converter).

In some embodiments, a catalytic converter made with a coated substrate of the present disclosure, loaded with 4.0 g/L of PGM or less, displays a nitrogen oxide light-off temperature at least 5° C. lower than a catalytic converter made with wet chemistry methods and having the same or similar PGM loading. In some embodiments, a catalytic converter made with a coated substrate of the present disclosure, loaded with 4.0 g/L of PGM or less, displays a nitrogen oxide light-off temperature at least 10° C. lower than a catalytic converter made with wet chemistry methods and having the same or similar PGM loading. In some embodiments, a catalytic converter made with a coated substrate of the present disclosure, loaded with 4.0 g/L of PGM or less, displays a nitrogen oxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 3.0 g/L of PGM or less, displays a carbon monoxide light-off temperature at least 5° C. lower than a catalytic converter made with wet chemistry methods and having the same or similar PGM loading. In some embodiments, a catalytic converter made with a coated substrate of the present disclosure, loaded with 3.0 g/L of PGM or less, displays a carbon monoxide light-off temperature at least 10° C. lower than a catalytic converter made with wet chemistry methods and having the same or similar PGM loading. In some embodiments, a catalytic converter made with a coated substrate of the present disclosure, loaded with 3.0 g/L of PGM or less, displays a carbon monoxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 3.0 g/L of PGM or less, displays a hydrocarbon light-off temperature at least 5° C. lower than a catalytic converter made with wet chemistry methods and having the same or similar PGM loading. In some embodiments, a catalytic converter made with a coated substrate of the present disclosure, loaded with 3.0 g/L of PGM or less, displays a hydrocarbon light-off temperature at least 10° C. lower than a catalytic converter made with wet chemistry methods and having the same or similar PGM loading. In some embodiments, a catalytic converter made with a coated substrate of the present disclosure, loaded with 3.0 g/L of PGM or less, displays a hydrocarbon light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100.000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 3.0 g/L of PGM or less, displays a nitrogen oxide light-off temperature at least 5° C. lower than a catalytic converter made with wet chemistry methods and having the same or similar PGM loading. In some embodiments, a catalytic converter made with a coated substrate of the present disclosure, loaded with 3.0 g/L of PGM or less, displays a nitrogen oxide light-off temperature at least 10° C. lower than a catalytic converter made with wet chemistry methods and having the same or similar PGM loading. In some embodiments, a catalytic converter made with a coated substrate of the present disclosure, loaded with 3.0 g/L of PGM or less, displays a nitrogen oxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 2.0 g/L of PGM or less, displays a carbon monoxide light-off temperature at least 5° C. lower than a catalytic converter made with wet chemistry methods and having the same or similar PGM loading. In some embodiments, a catalytic converter made with a coated substrate of the present disclosure, loaded with 2.0 g/L of PGM or less, displays a carbon monoxide light-off temperature at least 10° C. lower than a catalytic converter made with wet chemistry methods and having the same or similar PGM loading. In some embodiments, a catalytic converter made with a coated substrate of the present disclosure, loaded with 2.0 g/L of PGM or less, displays a carbon monoxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50.000 km, about 50.000 miles, about 75,000 km, about 75.000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 2.0 g/L of PGM or less, displays a hydrocarbon light-off temperature at least 5° C. lower than a catalytic converter made with wet chemistry methods and having the same or similar PGM loading. In some embodiments, a catalytic converter made with a coated substrate of the present disclosure, loaded with 2.0 g/L of PGM or less, displays a hydrocarbon light-off temperature at least 10° C. lower than a catalytic converter made with wet chemistry methods and having the same or similar PGM loading. In some embodiments, a catalytic converter made with a coated substrate of the present disclosure, loaded with 2.0 g/L of PGM or less, displays a hydrocarbon light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure, loaded with 2.0 g/L of PGM or less, displays a nitrogen oxide light-off temperature at least 5° C. lower than a catalytic converter made with wet chemistry methods and having the same or similar PGM loading. In some embodiments, a catalytic converter made with a coated substrate of the present disclosure, loaded with 2.0 g/L of PGM or less, displays a nitrogen oxide light-off temperature at least 10° C. lower than a catalytic converter made with wet chemistry methods and having the same or similar PGM loading. In some embodiments, a catalytic converter made with a coated substrate of the present disclosure, loaded with 2.0 g/L of PGM or less, displays a nitrogen oxide light-off temperature at least 15° C. lower than a catalytic converter made with wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±3° C. of the carbon monoxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50.000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±2° C. of the carbon monoxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150.000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±1° C. of the carbon monoxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±3° C. of the hydrocarbon light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±2° C. of the hydrocarbon light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±1° C. of the hydrocarbon light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±5° C. of the nitrogen oxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±4° C. of the nitrogen oxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±3° C. of the nitrogen oxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within ±2° C. of the nitrogen oxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

1 In some embodiments, a catalytic converter made with a coated substrate of the present disclosure displays a carbon monoxide light-off temperature within ±1° C. of the nitrogen oxide light-off temperature of a catalytic converter made with wet chemistry methods, while the catalytic converter made with a coated substrate employing at least about 30% less, up to about 30% less, at least about 40% less, up to about 40% less, at least about 50% less, or up to about 50% less catalyst than the catalytic converter made with wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with United States EPA emissions requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with the same standard. In some embodiments, the coated substrate is used in a catalytic converter (diesel oxidation catalyst) in the configuration DOC-DPF or DOC-DPF-SCR or in an LNT system to meet or exceed these standards. The emissions requirements can be intermediate life requirements or full life requirements. The requirements can be TLEV requirements, LEV requirements, or ULEV requirements. In some embodiments, the catalytic converter made with a coated substrate of the present disclosure demonstrates any of the foregoing performance standards after about 50,000 km, about 50.000 miles, about 75,000 km, about 75.000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA TLEV/LEV intermediate life requirements. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA TLEV/LEV full life requirements. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA ULEV intermediate life requirements. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA ULEV full life requirements. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA TLEV/LEV intermediate life requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with that standard. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA TLEV/LEV full life requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with that standard. In some embodiments, a catalytic converter made with a coated substrate of the present disclosure employed on a diesel or gasoline engine or diesel or gasoline vehicle, such as a light-duty diesel v engine or light-duty diesel or gasoline vehicle, complies with EPA ULEV intermediate life requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with that standard. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with EPA ULEV full life requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with that standard. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75.000 miles, about 100,000 km, about 100,000 miles, about 125.000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with Euro requirements. In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with Euro 6 requirements. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50.000 miles, about 75,000 km, about 75.000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with Euro requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with Euro 5 requirements. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50.000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, complies with Euro 6 requirements, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which complies with Euro 6 requirements. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125.000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel or gasoline engine or diesel or gasoline vehicle, such as a light-duty diesel or gasoline engine or light-duty diesel or gasoline vehicle, displays carbon monoxide emissions of 4200 mg/mile or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 3400 mg/mile or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 2100 mg/mile or less. In another embodiment, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 1700 mg/mile or less. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100.000 miles, about 125,000 km, about 125,000 miles, about 150,000 km, or about 150,000 miles of operation.

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 500 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 375 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 250 mg/km or less. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50.000 miles, about 75,000 km, about 75.000 miles, about 100,000 km, about 100,000 miles, about 125,000 km, about 125,000 miles, about 150.000 km, or about 150,000 miles of operation.

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 180 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 80 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 40 mg/km or less. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100.000 miles, about 125,000 km, about 125,000 miles, about 150,000 km, or about 150,000 miles of operation.

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 230 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 170 mg/km or less. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 85 mg/km or less. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50.000 miles, about 75,000 km, about 75.000 miles, about 100,000 km, about 100,000 miles, about 125,000 km, about 125,000 miles, about 150.000 km, or about 150,000 miles of operation.

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 500 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 375 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays carbon monoxide emissions of 250 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50.000 miles, about 75,000 km, about 75.000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 180 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 80 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ emissions of 40 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 230 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 170 mg/km or less, while using at least about 30% less, up to about 30% less, at least about 40% less, up to about 40% less, at least about 50% less, or up to about 500/o less, platinum group metal or platinum group metal loading, as compared to a catalytic converter made with wet chemistry methods which displays the same or similar emissions. In some embodiments, a catalytic converter made with a coated substrate of the present disclosure and employed on a diesel or gasoline engine or diesel or gasoline vehicle, such as a light-duty diesel or gasoline engine or light-duty diesel or gasoline vehicle, displays NOₓ plus HC emissions of 85 mg/km or less, while using at least about 30% less, up to about 30% less, at least about 40% less, up to about 40% less, at least about 50% less, or up to about 50% less, platinum group metal or platinum group metal loading, as compared to a catalytic converter made with wet chemistry methods which displays the same or similar emissions. In some embodiments, the coated substrate is used in a catalytic converter (diesel oxidation catalyst) in the configuration DOC-DPF or DOC-DPF-SCR or in an LNT system to meet or exceed these standards. In some embodiments, the catalytic converter made with a coated substrate of the present disclosure demonstrates any of the foregoing performance standards after about 50.000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, for the above-described comparisons, the thrifting (reduction) of platinum group metal for the catalytic converters made with substrates of the present disclosure is compared with either 1) a commercially available catalytic converter, made using wet chemistry, for the application disclosed (e.g., for use on a diesel or gasoline engine or vehicle, such as a light-duty diesel or gasoline engine or light-duty diesel or gasoline vehicle), or 2) a catalytic converter made with wet chemistry, which uses the minimal amount of platinum group metal to achieve the performance standard indicated.

In some embodiments, for the above-described comparisons, both the coated substrate according to the present disclosure, and the catalyst used in the commercially available catalytic converter or the catalyst prepared using wet chemistry methods, are aged (by the same amount) prior to testing. In some embodiments, both the coated substrate according to the present disclosure, and the catalyst substrate used in the commercially available catalytic converter or the catalyst substrate prepared using wet chemistry methods, are aged to about (or up to about) 50,000 kilometers, about (or up to about) 50,000 miles, about (or up to about) 75,000 kilometers, about (or up to about) 75,000 miles, about (or up to about) 100,000 kilometers, about (or up to about) 100,000 miles, about (or up to about) 125,000 kilometers, about (or up to about) 125,000 miles, about (or up to about) 150,000 kilometers, or about (or up to about) 150,000 miles. In some embodiments, for the above-described comparisons, both the coated substrate according to the present disclosure, and the catalyst substrate used in the commercially available catalytic converter or the catalyst substrate prepared using wet chemistry methods, are artificially aged (by the same amount) prior to testing. In some embodiments, they are artificially aged by heating to about 400° C., about 500° C., about 600° C., about 700°, about 800° C., about 900° C., about 1000° C., about 1100° C. or about 1200° C. for about (or up to about) 4 hours, about (or up to about) 6 hours, about (or up to about) 8 hours, about (or up to about) 10 hours, about (or up to about) 12 hours, about (or up to about) 14 hours, about (or up to about) 16 hours, about (or up to about) 18 hours, about (or up to about) 20 hours, about (or up to about) 22 hours, or about (or up to about) 24 hours. In some embodiments, they are artificially aged by heating to about 800° C. for about 16 hours.

In some embodiments, for the above-described comparisons, the thrifting (reduction) of platinum group metal for the catalytic converters made with substrates of the present disclosure is compared with either 1) a commercially available catalytic converter, made using wet chemistry, for the application disclosed (e.g., for use on a diesel or gasoline engine or vehicle, such as a light-duty diesel or gasoline engine or light-duty diesel or gasoline vehicle), or 2) a catalytic converter made with wet chemistry, which uses the minimal amount of platinum group metal to achieve the performance standard indicated, and after the coated substrate according to the present disclosure and the catalytic substrate used in the commercially available catalyst or catalyst made using wet chemistry with the minimal amount of PGM to achieve the performance standard indicated are aged as described above.

In some embodiments, for the above-described catalytic converters employing the coated substrates of the present disclosure, for the exhaust treatment systems using catalytic converters employing the coated substrates of the present disclosure, and for vehicles employing these catalytic converters and exhaust treatment systems, the catalytic converter is employed as a diesel oxidation catalyst along with a diesel particulate filter, or the catalytic converter is employed as a diesel oxidation catalyst along with a diesel particulate filter and a selective catalytic reduction unit, to meet or exceed the standards for CO and/or NOₓ, and/or HC described above.

### EXEMPLARY EMBODIMENTS

The invention is further described by the following embodiments. The features of each of the embodiments are combinable with any of the other embodiments where appropriate and practical.

### Embodiment 1

A coated substrate comprising:

a substrate;

a zeolite layer comprising zeolites:

a catalytic layer comprising composite nanoparticles and micron-sized filler particles, wherein the composite nanoparticles are not attached to the micron-sized filler particles prior to the formation of the catalytic layer; and

a PNA material layer comprising a PNA material.

### Embodiment 2

A coated substrate comprising:

a substrate;

a zeolite layer comprising zeolites:

a catalytic layer comprising micron-sized filler particles and composite nanoparticles not attached to the micron-sized filler particles; and

a PNA material layer comprising a PNA material.

### Embodiment 3

The coated substrate of embodiment 1 or 2, wherein the catalytic layer is formed by coating the substrate with a catalytic washcoat, the catalytic washcoat comprising micron-sized filler particles and composite nanoparticles not attached to the micron-sized filler particles.

### Embodiment 4

The coated substrate of embodiment 3, wherein the catalytic washcoat is formed by suspending micron-sized filler particles and composite nanoparticles in a liquid.

### Embodiment 5

The coated substrate of embodiment 3 or 4, wherein the composite nanoparticles are not covalently attached to the micron-sized filler particles prior to coating the substrate with the catalytic washcoat.

### Embodiment 6

The coated substrate of any one of embodiments 3-5, wherein the composite nanoparticles are not attached to the micron-sized filler particles by calcination prior to coating the substrate with the catalytic washcoat.

### Embodiment 7

The coated substrate of any one of embodiments 1-6, wherein the zeolite layer has a thickness of about 40 g/L to about 100 g/L.

### Embodiment 8

The coated substrate according to any one of embodiments 1-7, wherein the zeolite layer comprises about 50 wt % to about 85 wt % zeolites.

### Embodiment 9

The coated substrate according to any one of embodiments 1-8, wherein the composite nanoparticles in the catalytic layer are oxidative composite nanoparticles.

### Embodiment 10

The coated substrate according to any one of embodiments 1-9, wherein the composite nanoparticles in the catalytic layer comprise a catalyst nanoparticle attached to a support nanoparticle.

### Embodiment 11

The coated substrate according to embodiment 10, wherein the catalyst nanoparticle comprises a platinum group metal.

### Embodiment 12

The coated substrate of embodiment 10 or 11, wherein the catalyst nanoparticle comprises an alloy.

### Embodiment 13

The coated substrate of any one of embodiments 10-12, wherein the catalyst nanoparticle comprises platinum or palladium.

### Embodiment 14

The coated substrate of any one of embodiments 10-13, wherein the catalyst nanoparticle comprises platinum and palladium.

### Embodiment 15

The coated substrate of any one of embodiments 10-14, wherein the catalyst nanoparticle comprises platinum and palladium at a ratio of about 1:2 to about 25:1 platinum to palladium.

### Embodiment 16

The coated substrate of any one of embodiments 10-15, wherein the support nanoparticle comprises a metal oxide.

### Embodiment 17

The coated substrate of any one of embodiments 10-16, wherein the support nanoparticle comprises aluminum oxide.

### Embodiment 18

The coated substrate of any one of embodiments 10-17, wherein the catalyst nanoparticle and the support nanoparticle are in a weight ratio of about 10:90 to about 60:40 catalyst nanoparticle to support nanoparticle.

### Embodiment 19

The coated substrate of any one of embodiments 1-18, wherein the catalytic layer has a thickness of about 30 g/L to about 150 g/L.

### Embodiment 20

The coated substrate of any one of embodiments 1-19, wherein the catalytic layer comprises about 0.25 g/L to about 2 g/L platinum group metal.

### Embodiment 21

The coated substrate of any one of embodiments 1-20, wherein the PNA material comprises micron-sized support particles.

### Embodiment 22

The coated substrate of any one of embodiments 1-21, wherein the PNA material comprises a platinum group metal.

### Embodiment 23

The coated substrate of embodiment 22, wherein the platinum group metal comprises palladium.

### Embodiment 24

The coated substrate of any one of embodiments 1-23, wherein the PNA material comprises a platinum group metal attached to a micron sized support particle.

### Embodiment 25

The coated substrate of any one of embodiments 21-24, wherein the micron-sized support particle comprises ceria.

### Embodiment 26

The coated substrate of any one of embodiments 1-26, wherein the PNA material layer comprises an alkali oxide or an alkaline earth oxide.

### Embodiment 27

The coated substrate of any one of embodiments 1-27, wherein the PNA material layer has a thickness of about 100 g/L to about 200 g/L.

### Embodiment 28

The coated substrate of any one of embodiments 1-27, wherein the PNA material layer comprises about 0.5 g/L to about 4 g/L platinum group metal.

### Embodiment 29

The coated substrate of any one of embodiments 1-28, wherein the zeolite layer, the catalytic layer, or the PNA material layer comprise filler particles.

### Embodiment 30

The coated substrate of embodiment 29, wherein the filler particles are micron-sized filler particles.

### Embodiment 31

The coated substrate of embodiment 29 or 30, wherein the filler particles comprise alumina.

### Embodiment 32

The coated substrate of any one of embodiments 1-31, wherein the zeolite layer, the catalytic layer, or the PNA material layer comprise alumina derived from boehmite.

### Embodiment 33

The coated substrate of any one of embodiments 1-32, wherein the zeolite layer comprises about 50 wt % to about 85 wt % filler particles.

### Embodiment 34

The coated substrate of any one of embodiments 1-33, wherein the catalytic layer comprises about 2 wt % to about 10 wt % composite nanoparticles.

### Embodiment 35

The coated substrate of any one of embodiments 1-34, wherein the catalytic layer comprises about 80 wt % to about 95 wt % filler particles.

### Embodiment 36

The coated substrate of any one of embodiments 1-35, wherein the PNA material layer comprises about 80 wt % to about 95 wt % PNA material.

### Embodiment 37

The coated substrate of any one of embodiments 1-36, wherein the PNA material layer comprises about 3 wt % to about 7 wt % filler particles.

### Embodiment 38

A method of forming a coated substrate comprising:

coating a substrate with a zeolite washcoat, wherein the zeolite washcoat comprises zeolites;

coating the substrate with a catalytic washcoat, wherein the catalytic washcoat comprises micron-sized filler particles and composite nanoparticles not attached to the micron-sized filler particles; and

coating the substrate with a PNA material washcoat, wherein the PNA material washcoat comprises a PNA material.

### Embodiment 39

The method of forming a coated substrate according to embodiment 38, wherein the catalytic washcoat is formed by suspending micron-sized filler particles and composite nanoparticles in a liquid.

### Embodiment 40

The method of forming a coated substrate according to embodiment 38 or 39, wherein the composite nanoparticles are not covalently attached to the micron-sized filler particles prior to coating the substrate with the catalytic washcoat.

### Embodiment 41

The method of forming a coated substrate according to any one of embodiments 38-40, wherein the composite nanoparticles are not attached to the micron-sized filler particles by calcination prior to coating the substrate with the catalytic washcoat.

### Embodiment 42

The method of forming a coated substrate according to any one of embodiments 38-41, further comprising drying the substrate after each coating step.

### Embodiment 43

The method of forming a coated substrate according to embodiment 42, further comprising calcining the substrate after each drying step.

### Embodiment 44

The method of forming a coated substrate according to any one of embodiments 38-43, wherein the zeolite layer has a thickness of about 40 g/L to about 100 g/L.

### Embodiment 45

The method of forming a coated substrate according to any one of embodiments 38-44, wherein the zeolite washcoat comprises about 50 wt % to about 85 wt % zeolites.

### Embodiment 46

The method of forming a coated substrate according to any one of embodiments 338-45, wherein the composite nanoparticles in the catalytic washcoat are oxidative composite nanoparticles.

### Embodiment 47

The method of forming a coated substrate according to any one of embodiments 38-46, wherein the composite nanoparticles in the catalytic washcoat comprise a catalyst nanoparticle attached to a support nanoparticle.

### Embodiment 48

The method of forming a coated substrate according to embodiment 47, wherein the catalyst nanoparticle comprises a platinum group metal.

### Embodiment 49

The method of forming a coated substrate according to embodiment 47 or 48, wherein the catalyst nanoparticle comprises an alloy.

### Embodiment 50

The method of forming a coated substrate according to any one of embodiments 47-49, wherein the catalyst nanoparticle comprises platinum or palladium.

### Embodiment 51

The method of forming a coated substrate according to any one of embodiments 47-50, wherein the catalyst nanoparticle comprises platinum and palladium.

### Embodiment 52

The method of forming a coated substrate according to any one of embodiments 47-51, wherein the catalyst nanoparticle comprises platinum and palladium at a ratio of about 1:2 to about 25:1 platinum to palladium.

### Embodiment 53

The method of forming a coated substrate according to any one of embodiments 47-52, wherein the support nanoparticle comprises a metal oxide.

### Embodiment 54

The method of forming a coated substrate according to any one of embodiments 47-53, wherein the support nanoparticle comprises aluminum oxide.

### Embodiment 55

The method of forming a coated substrate according to any one of embodiments 47-55, wherein the catalyst nanoparticle and the support nanoparticle are in a weight ratio of about 10:90 to about 60:40 catalyst nanoparticle to support nanoparticle.

### Embodiment 56

The method of forming a coated substrate according to any one of embodiments 38-55, wherein the catalytic washcoat has a thickness of about 30 g/L to about 150 g/L.

### Embodiment 57

The method of forming a coated substrate according to any one of embodiments 38-56, wherein the catalytic washcoat comprises about 0.25 g/L to about 2 g/L platinum group metal.

### Embodiment 58

The method of forming a coated substrate according to any one of embodiments 38-57, wherein the PNA material comprises micron-sized support particles.

### Embodiment 59

The method of forming a coated substrate according to any one of embodiments 38-58, wherein the PNA material comprises a platinum group metal.

### Embodiment 60

The method of forming a coated substrate according to embodiment 59, wherein the platinum group metal comprises palladium.

### Embodiment 61

The method of forming a coated substrate according to any one of embodiments 38-60, wherein the PNA material comprises a platinum group metal attached to a micron-sized support particle.

### Embodiment 62

The method of forming a coated substrate according to any one of embodiments 58-61, wherein the micron-sized support particle comprises ceria.

### Embodiment 63

The method of forming a coated substrate according to any one of embodiments 38-62, wherein the PNA material layer comprises an alkali oxide or an alkaline earth oxide.

### Embodiment 64

The method of forming a coated substrate according to any one of embodiments 38-63, wherein the PNA material washcoat has a thickness of about 100 g/L to about 200 g/L.

### Embodiment 65

The method of forming a coated substrate according to any one of embodiments 38-64, wherein the PNA material washcoat comprises about 0.5 g/L to about 4 g/L platinum group metal.

### Embodiment 66

The method of forming a coated substrate according to any one of embodiments 38-65, wherein the zeolite layer, the catalytic layer, or the PNA material layer comprise filler particles.

### Embodiment 67

The method of forming a coated substrate according to embodiment 66, wherein the filler particles are micron-sized filler particles.

### Embodiment 68

The method of forming a coated substrate according to embodiment 66 or 67, wherein the filler particles comprise alumina.

### Embodiment 69

The method of forming a coated substrate according to any one of embodiments 38-68, wherein the zeolite washcoat, the catalytic washcoat, or the PNA material washcoat comprise boehmite.

### Embodiment 70

The method of forming a coated substrate according to any one of embodiments 38-69, wherein the zeolite washcoat, the catalytic washcoat, or the PNA material washcoat comprise about 3 wt % to about 7 wt % boehmite.

### Embodiment 71

The method of forming a coated substrate according to any one of embodiments 38-70, wherein the zeolite washcoat comprises about 50 wt % to about 85 wt % filler particles

### Embodiment 72

The method of forming a coated substrate according to any one of embodiments 38-71, wherein the catalytic washcoat comprises about 2 wt % to about 10 wt % composite nanoparticles.

### Embodiment 73

The method of forming a coated substrate according to any one of embodiments 38-72, wherein the catalytic washcoat comprises about 80 wt % to about 95 wt % filler particles.

### Embodiment 74

The method of forming a coated substrate according to any one of embodiments 38-73, wherein the PNA material washcoat comprises about 80 wt % to about 95 wt % PNA material.

### Embodiment 75

The method of forming a coated substrate according to any one of embodiments 38-74, wherein the PNA material washcoat comprises about 3 wt % to about 7 wt %/o filler particles.

### Embodiment 76

A coated substrate formed by the method according to any one of embodiments 38-75.

### Embodiment 77

A catalytic washcoat comprising micron-sized filler particles and composite nanoparticles not attached to the micron-sized filler particles.

### Embodiment 78

A method of forming a catalytic washcoat comprising forming a suspension comprising micron-sized filler particles and composite nanoparticles.

### Embodiment 79

The method of forming a catalytic washcoat according to embodiment 78, further comprising suspending the micron-sized filler particles in a liquid prior to combining the micron-sized filler particles with the composite nanoparticles.

### Embodiment 80

The method of forming a catalytic washcoat according to embodiment 78 or 79, further comprising suspending the composite nanoparticles in a liquid prior to combining the composite nanoparticles with the micron-sized filler particles.

### Embodiment 81

The method of forming a catalytic washcoat according to any one of embodiments 78-80, wherein the composite nanoparticles are oxidative composite nanoparticles.

### Embodiment 82

The method of forming a catalytic washcoat according to any one of embodiments 78-81, wherein the composite nanoparticles comprise a catalyst nanoparticle attached to a support nanoparticle.

### Embodiment 83

The method of forming a catalytic washcoat according to embodiment 82, wherein the catalyst nanoparticle comprises a platinum group metal.

### Embodiment 84

The method of forming a catalytic washcoat according to embodiment 82 or 83, wherein the catalyst nanoparticle comprises an alloy.

### Embodiment 85

The method of forming a catalytic washcoat according to any one of embodiments 82-84, wherein the catalyst nanoparticle comprises platinum or palladium.

### Embodiment 86

The method of forming a catalytic washcoat according to any one of embodiments 78-85, wherein the catalyst nanoparticle comprises platinum and palladium.

### Embodiment 87

The method of forming a catalytic washcoat according to any one of embodiments 78-86, wherein the catalyst nanoparticle comprises platinum and palladium at a ratio of about 1:2 to about 25:1 platinum to palladium.

### Embodiment 88

The method of forming a catalytic washcoat according to any one of embodiments 78-87, wherein the support nanoparticle comprises a metal oxide.

### Embodiment 89

The method of forming a catalytic washcoat according to any one of embodiments 78-88, wherein the support nanoparticle comprises aluminum oxide.

### Embodiment 90

The method of forming a catalytic washcoat according to any one of embodiments 78-89, wherein the catalyst nanoparticle and the support nanoparticle are in a weight ratio of about 10:90 to about 60:40 catalyst nanoparticle to support nanoparticle.

### Embodiment 91

The method of forming a catalytic washcoat according to any one of embodiments 78-90, wherein the micron-sized filler particles comprise alumina.

### Embodiment 92

The method of forming a catalytic washcoat according to any one of embodiments 78-91, further comprising combining boehmite with the suspension.

### Embodiment 93

The method of forming a catalytic washcoat according to any one of embodiments 78-92, wherein the catalytic washcoat comprises composite nanoparticles at about 2 wt % to about 10 wt % of the solids content.

### Embodiment 94

The method of forming a catalytic washcoat according to any one of embodiments 78-93, wherein the catalytic washcoat comprises micron-sized filler particles at about 80 wt % to about 95 wt % solids content.

### Embodiment 95

The method of forming a catalytic washcoat according to any one of embodiments 78-94, wherein the catalytic washcoat comprises composite nanoparticles not attached to the micron-sized filler particles.

### Embodiment 96

The method of forming a catalytic washcoat according to any one of embodiments 78-95, wherein the catalytic washcoat comprises composite nanoparticles not covalently attached to the micron-sized filler particles.

### Embodiment 97

The method of forming a catalytic washcoat according to any one of embodiments 78-97, wherein the catalytic washcoat comprises composite nanoparticles not attached to the micron-sized filler particles by calcination.

### Embodiment 98

A method of forming a coated substrate comprising coating a substrate with a catalytic washcoat formed by the method according to any one of embodiments 78-97.

### Embodiment 99

The method of forming a coated substrate according to embodiment 98, wherein the composite nanoparticles are not attached to the micron-sized filler particles prior to coating the substrate with the catalytic washcoat.

### Embodiment 100

The method of forming a coated substrate according to embodiment 98 or 99, further comprising drying the substrate coated with the catalytic washcoat.

### Embodiment 101

The method of forming a coated substrate according to embodiment 100, further comprising calcining the substrate after the drying step.

### Embodiment 102

A coated substrate formed by the method according to any one of embodiments 98-101.

### Embodiment 103

The coated substrate according to embodiment 102, further comprising:

a zeolite layer comprising zeolites; and

a PNA material layer comprising a PNA material.

### Embodiment 104

A coated substrate comprising:

a catalytic layer comprising micron-sized filler particles and composite nanoparticles not attached to the micron-sized filler particles prior to the formation of the catalytic layer.

### Embodiment 105

A method of forming a coated substrate comprising:

coating the substrate with a catalytic washcoat, wherein the catalytic washcoat comprises micron-sized filler particles and composite nanoparticles not attached to the micron-sized filler particles.

### Embodiment 106

A coated substrate formed by the method according to embodiment 105.

### Embodiment 107

A catalytic converter comprising the coated substrate according to any one of embodiments 1-37, 76, 102-104, and 106.

### Embodiment 108

An exhaust treatment system comprising a conduit for exhaust gas and a catalytic converter according to embodiment 107.

### Embodiment 109

A vehicle comprising a catalytic converter according to embodiment 107.

### Embodiment 110

A diesel vehicle comprising a catalytic converter according to embodiment 107.

### Embodiment 111

The vehicle according to embodiment 109 or 110 wherein the vehicle complies with the European emission standard Euro 5.

### Embodiment 112

The vehicle according to any one of embodiments 109-111, wherein the vehicle complies with the European emission standard Euro 6.

### EXAMPLES

As discussed above, the washcoat compositions can be configured and applied in a variety of different ways. The configurations provide examples of preparing substrates coated with the washcoats.

### Example 1: General Procedure for Preparation of Washcoats

The washcoats are made by mixing the solid ingredients with water. Acetic acid is added to adjust the pH to about 4. The washcoat slurry is then milled to arrive at an average particle size of about 4 μm to about 15 μm. The viscosity of the washcoat is adjusted by mixing with a cellulose solution or with corn starch to the desired viscosity, typically between about 300 cP to about 1200 cP. The washcoat is aged for about 24 hours to about 48 hours after cellulose or corn starch addition. The washcoat is coated onto the substrate by either dip-coating or vacuum coating. The part(s) to be coated can be optionally pre-wetted prior to coating. Excess washcoat is blown off and recycled. The washcoat-coated substrate is then dried at about 25° C. to about 95° C. by flowing air over the coated part, until the weight levels off. The washcoat-coated substrate is then calcined at about 450° C. to about 650° C. for about 1 hour to about 2 hours.

### Example 2: Testing the PNA Material for NOₓ Storage and Release

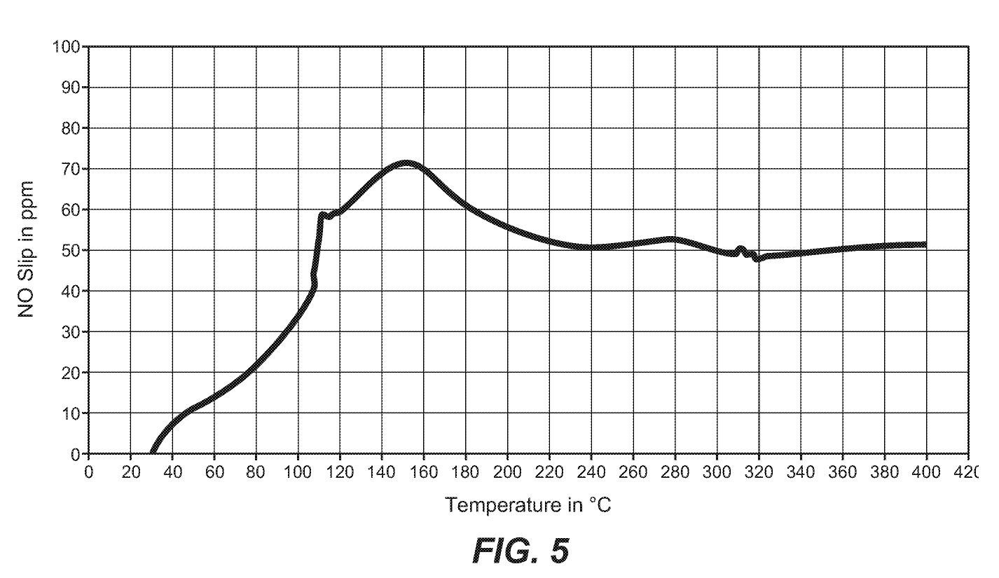

The performance of various PNA materials were tested for NOx storage and release temperatures. In order to test the performance of the various PNA materials, the following process was adhered to: (1) build the actual PNA samples; (2) age the samples hydrothermally; (3) test the samples for NOx emission storage and release using a synthetic gas mixture that mimics the exhaust of a light duty diesel vehicle. The results shown in FIGS. 5-7 are “second runs” (i.e., the PNA samples were run back to back to see whether there was any residual storage effects). Based on the results shown in FIGS. 5-7, there were none and the PNA materials release 100% of the stored NOx emissions.

The following Tables 1 and 2 list the Aging Conditions and Testing Protocol used to test the PNA samples.

TABLE 1
Aging Conditions

| | |
|---|---|
| Heating Rate | 2 hrs (=6.7° C./min) |
| Temperature | 750° C. |
| Holding Period | 20 hrs |
| Cool Down Rate | <3° C./min |
| Atmosphere | H₂O (~5%), O₂ (20%), N₂ |
| | (rest) |
| Volumetric Flow | N/A |

TABLE 2
Testing Protocol

| | |
|---|---|
| Sample Size | 1″ × 1″ core |
| GHSV | 60,000 h⁻¹ |
| Gas Mixture | Propene = 400 ppm |
| | CO = 1,200 ppm |
| | NO = 50 ppm |
| | O₂ = 12.5% |
| | CO₂ = 6% |
| | H₂O = 6.5% |
| | N₂ = Rest |
| Heating Rate | 5° C./min (100° C.-350° C.) |

FIG. 5 is a graph showing the NOx emission adsorption and release for manganese based PNA material across an operating temperature spectrum. As shown in FIG. 5, manganese based PNA material stores NOx emissions efficiently up to about 110° C. At that point, the PNA material stops adsorbing NOx emissions and starts releasing the adsorbed NOx. At about 220° C., all the stored NOx emissions are released. Thus, manganese based oxides are good NOx emission adsorbers from ambient temperature to about 100° C. In addition, the manganese based oxides exhibited a “sharp” release temperature. The slight drop in NO slippage at 110° C. is due to water being turned on.

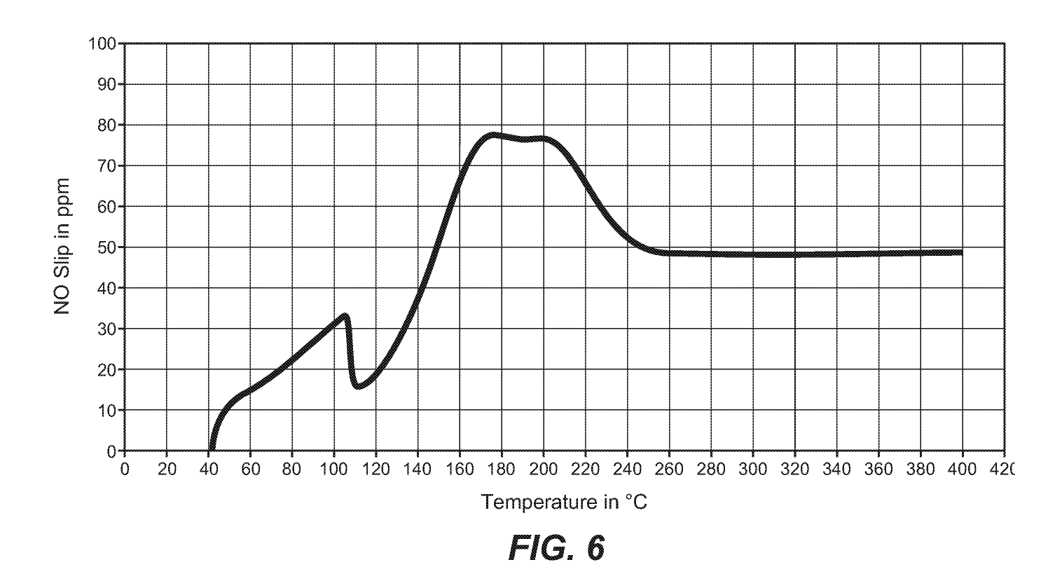

FIG. 6 is a graph showing the NOx emission adsorption and release for magnesium based PNA material across an operating temperature spectrum. As shown in FIG. 6, magnesium based PNA material stores NOx emissions efficiently up to about 150° C. At that point, the PNA material stops adsorbing NOx emissions and starts releasing the adsorbed NOx. At about 240° C. all the stored NOx emissions are released. Thus, magnesium based oxides are good NOx emission adsorbers from ambient temperature to about 150° C. In addition, the magnesium based oxides exhibited a “sharp” release temperature. The sharp drop in NO slippage at 110° C. is due to water being turned on.

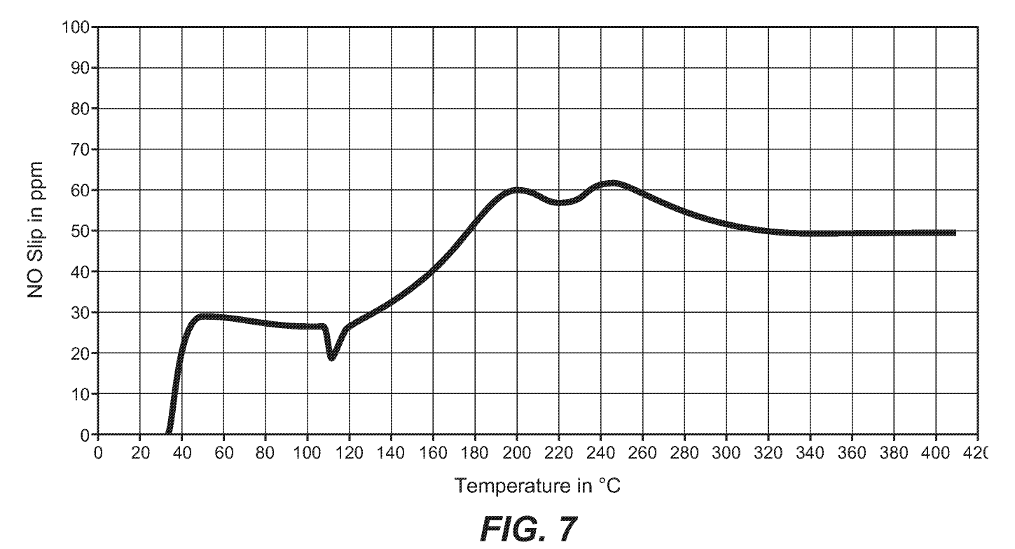

FIG. 7 is a graph showing the NOx emission adsorption and release for calcium based PNA material across an operating temperature spectrum. As shown in FIG. 7, calcium based PNA material stores NOx emissions efficiently up to about 180° C. At that point, the PNA material stops adsorbing NOx emissions and starts releasing the adsorbed NOx. At about 310′C, all the stored NOx emissions are released. Thus, calcium based oxides are good NOx emission adsorbers from ambient temperature to about 150′C. In addition, the calcium based oxides exhibited a “sharp” release temperature. The sharp drop in NO slippage at 110° C. is due to water being turned on.

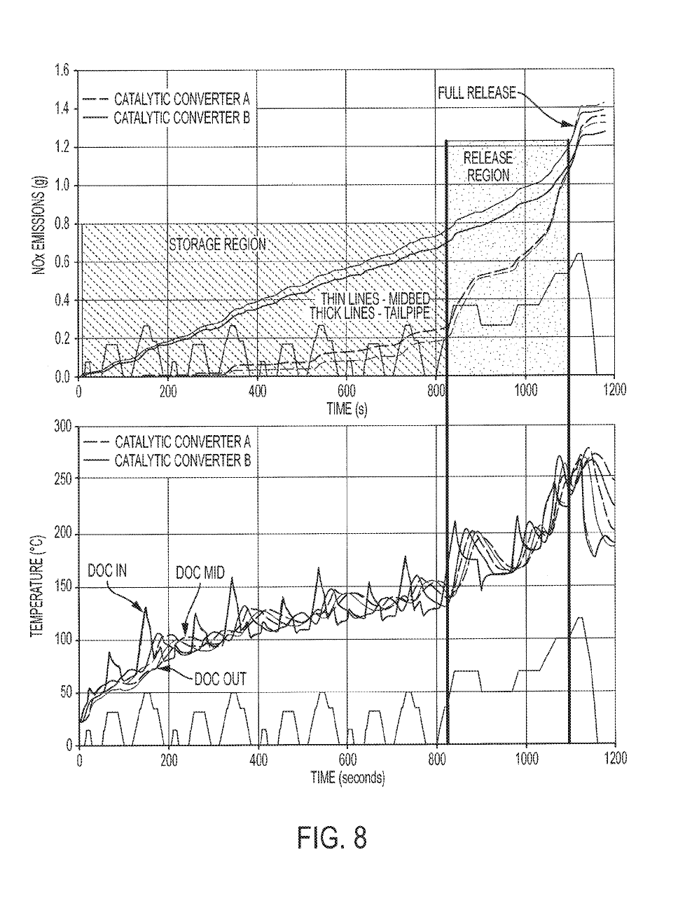

FIG. 8 illustrates NOx emission storage comparison performance of one embodiment of a catalytic converter employing a substrate coated with palladium based PNA material and a platinum group metal loading of the entire catalytic converter of about 2.5 g/l (catalytic converter A, dashed line) to the performance of a commercially available catalytic converter (catalytic converter B, solid line) with a platinum group metal loading of the entire catalytic converter of about 6.4 g/l.

Catalytic converter A (employing PNA material as described herein) was formed by generating a PNA washcoat including palladium on cerium oxide produced by wet chemistry methods and boehmite. The PNA washcoat was coated onto a first zone of the substrate and the substrate was dried and calcined. On a second zone of the substrate downstream the PNA zone, the substrate had a corner fill layer, a catalytic layer (on top of the corner fill layer) including NNm particles and a Pt:Pd weight ratio of 2:1, and a zeolite layer (on top of the catalytic layer), all of which as described herein. Catalytic converter B is a commercially available catalytic converter formed by wet chemistry methods. Both catalytic converters were tested under the same conditions.

As shown in FIG. 8, as the temperature of the catalytic converter B increased, the NOx emissions increased linearly. In contrast, as the temperature of the catalytic converter A increased, the NOx emissions only slightly increased until after a designated time and temperature, wherein the NOx emissions were sharply released. Accordingly, catalytic converter A was able to store NOx emissions from ambient up to about 150° C.

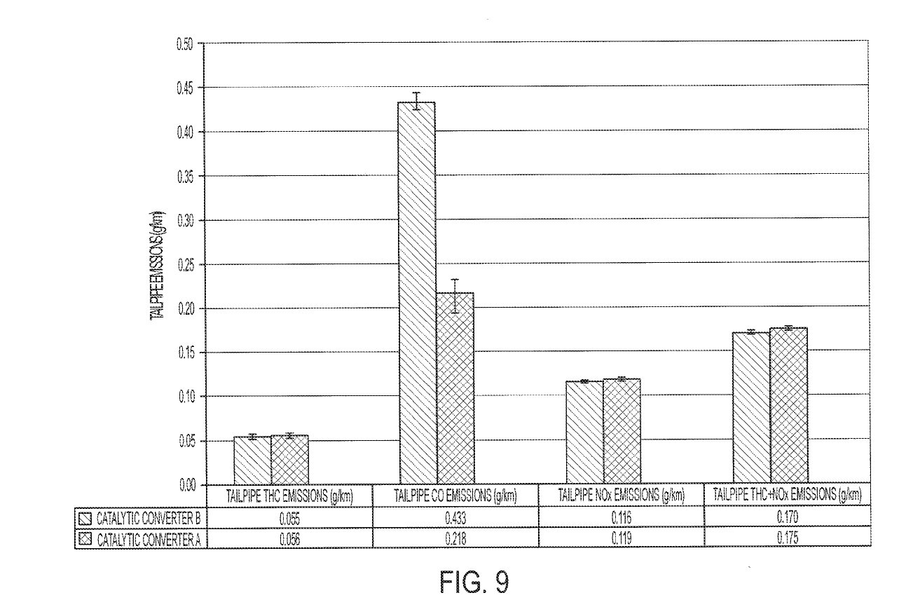

FIG. 9 illustrates a comparison of the tailpipe emissions of the catalytic converter A and the catalytic converter B. As shown in FIG. 9, catalytic converter A can have about 50% less CO emissions than catalytic converter B and use significantly less PGM thereby reducing cost.

The disclosures of all publications, patents, patent applications, and published patent applications referred to herein by an identifying citation are hereby incorporated herein by reference in their entirety.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiments chosen for illustration without departing from the spirit and scope of the invention. Therefore, the description and examples should not be construed as limiting the scope of the invention.

### Example 3: Zeolite Washcoat a

A zeolite washcoat comprising filler particles (such as alumina filler particles), zeolite particles, and boehmite is formed. The filler particles comprise about 10 wt % to about 40 wt % (such as about 15 wt % to about 35 wt %, about 20 wt % to about 30 wt %, or about 25 wt %) of the filler particles, zeolite particles, and boehmite particles in the zeolite washcoat. The zeolite particle comprise about 50 wt % to about 85 wt % filler particles (such as about 60 wt % to about 80 wt % filler particles, about 65 wt % to about 75 wt % filler particles, or about 70 wt % filler particles) of the filler particles, zeolite particles, and boehmite particles in the zeolite washcoat. The boehmite comprises about 3 wt % to about 7 wt % (such as about 4 wt % to about 6 wt %, or about 5 wt %) of the filler particles, zeolite particles, and boehmite particles in the zeolite washcoat. The pH of the zeolite washcoat is adjusted, for example, to about 4, and thickeners can be added.

The zeolite washcoat is applied to a substrate at a thickness of about 40 g/L to about 100 g/L (such as about 50 g/L to about 90 g/L, about 60 g/L to about 80 g/L, or about 70 g/L). The substrate is then dried and calcined to produce a substrate coated with a zeolite layer. The coated substrate may also be coated by a catalytic washcoat and/or a PNA material washcoat, which are each dried and calcined to produce a coated substrate with a zeolite layer, a catalytic layer, and a PNA material layer.

### Example 4: “Loose Ingredient” Catalytic Washcoat

The catalytic washcoat composition comprises composite nanoparticles (such as oxidative composite nanoparticles) and filler particles (such as alumina filler particles, which may be stabilized, for example, by lanthanum). The composite nanoparticles in the loose ingredient catalytic washcoat composition are not attached to the filler particles. In some embodiments, the catalytic washcoat composition further comprises boehmite particles. The composite nanoparticles are those described herein, and comprise an oxidative catalyst nanoparticle attached to a support nanoparticle. The oxidative catalyst nanoparticle comprises one or more platinum group metals. Preferably, the oxidative catalyst nanoparticle comprises platinum and palladium. The oxidative catalyst nanoparticle may comprise platinum and palladium at a ratio of about 1:2 to about 25:1 platinum to palladium (such as about 1:1 to about 10:1 platinum to palladium, about 1:1 to about 5:1 platinum to palladium, or about 2:1 platinum to palladium). The support nanoparticle is preferably an oxide, such as aluminum oxide. The oxidative catalyst nanoparticle and the support nanoparticle may be present at a weight ratio of about 5:95 to about 60:40 platinum group metal to support (such as about 10:90 to about 60:40 platinum group metal to support, about 30:70 to about 50:50 platinum group metal to support, or about 40:60 platinum group metal to support). In some embodiments of the “loose ingredient” catalytic washcoat composition, the composite nanoparticles comprise about 2 wt % to about 10 wt % (such as about 3 wt % to about 7 wt %, or about 4 wt % to about 6 wt %) the total weight of the composite nanoparticles, filler particles, and boehmite. In some embodiments of the “loose ingredient” catalytic washcoat composition, the filler particles comprise about 80 wt % to about 95 wt % (such as about 85 wt % to about 90 wt %) of the composite nanoparticles, filler particles, and boehmite. In some embodiments of the “loose ingredient” catalytic washcoat composition, the boehmite comprises about 3 wt % to about 8 wt % (such as about 4 wt % to about 7 wt %) of the composite nanoparticles, filler particles, and boehmite. In some embodiments of the “loose ingredient” catalytic washcoat composition, the platinum group metal comprises about 0.5 wt % to about 4 wt % (such as about 1 wt % to about 3 wt %, or about 2 wt %) of the composite nanoparticles, filler particles, and boehmite. The pH of the catalytic washcoat is adjusted, for example, to about 4, and thickeners can be added.

The catalytic washcoat is applied to the substrate such that the catalytic layer is about 30 g/L to about 150 g/L (such as about 40 g/L to about 100 g/L, or about 40 g/L to about 60 g/L). In some embodiments, the catalytic washcoat comprises about 0.25 g/L to about 2 g/L PGM (such as about 0.5 g/L to about 1.5 g/L PGM, about 0.5 g/L to about 1.0 g/L PGM, about 0.75 g/L to about 1.25 g/L PGM, or about 1.0 g/L to about 1.5 g/L PGM). The substrate is then dried and calcined to produce a substrate coated with a catalytic layer. The coated substrate may also be coated by a zeolite washcoat and/or a PNA material washcoat, which are each dried and calcined to produce a coated substrate with a zeolite layer, a catalytic layer, and a PNA material layer.

### Example 5: PNA Material Washcoat

A PNA material washcoat comprises filler particles (such as alumina particles), boehmite, and PNA materials. The PNA materials comprise micron-sized ceria particles loaded with palladium, for example by wet-chemistry. The PNA materials can be formed, for example, by dissolving a palladium salt (such as palladium nitrate) in water and mixing it with micro-sized ceria particles (such as HSA20). The particles are then dried and calcined, resulting in metallic palladium impregnated into the micron sized ceria particles. Preferably, the PNA materials comprise about 0.5 wt % to about 4 wt % palladium (such as about 1 wt % to about 3 wt % palladium, or about 2 wt % palladium). The PNA materials are then suspended and mixed with the filler particles and the boehmite to produce the PNA material washcoat. The PNA material washcoat comprises about 80 wt % to about 95 wt % PNA material (micron-sized ceria particles impregnated with palladium) of the filler particles, boehmite, and PNA material. The PNA material washcoat comprises about 3 wt % to about 7 wt % boehmite (such as about 4 wt % to about 6 wt % boehmite, or about 5 wt % boehmite) of the filler particles, boehmite, and PNA material. The PNA material washcoat comprises about 3 wt % to about 7 wt % filler particles (such as about 4 wt % to about 6 wt % filler particles, or about 5 wt % filler particles) of the filler particles, boehmite, and PNA material.

The PNA material washcoat is applied to the substrate such that the PNA material layer is about 100 g/L to about 200 g/L (such as about 120 g/L to about 180 g/L, or about 140 g/L to about 160 g/L). In some embodiments, the PNA material washcoat comprises about 0.5 g/L to about 4 g/L PGM (such as about 1 g/L to about 3 g/L PGM, about 1 g/L to about 2 g/L PGM, about 1.5 g/L to about 2.5 g/L PGM, about 2 g/L to about 3 g/L PGM), or about 2.5 g/L to about 3.5 g/L). The substrate is then dried and calcined to produce a substrate coated with a PNA material layer. The coated substrate may also be coated by a zeolite washcoat and/or a catalytic washcoat, which are each dried and calcined to produce a coated substrate with a zeolite layer, a catalytic layer, and a PNA material layer.

### Example 6: Coated Substrate with Zeolite Layer, Catalytic Layer, and PNA Material Layer

A substrate is coated with a zeolite washcoat, such as the zeolite washcoat described in Example 3. The substrate is then dried and calcined, thereby producing a substrate coated with a zeolite layer. The substrate is then coated with a catalytic washcoat, such as the loose ingredient catalytic washcoat described in Example 4. The substrate is then dried and calcined, thereby producing a substrate coated with a zeolite layer and a catalytic layer. Finally, the substrate is then coated with a PNA material washcoat, such as the PNA material washcoat described in Example 5. The substrate is then dried and calcined, thereby producing a substrate coated with a zeolite layer, a catalytic layer, and a PNA material layer.

1-114. (canceled)

115. A coated substrate comprising:
a substrate;
a zeolite layer comprising zeolites;
a catalytic layer comprising micron-sized filler particles and composite nanoparticles not attached to the micron-sized filler particles; and
a PNA material layer comprising a PNA material.

116. The coated substrate according to claim 115, wherein the zeolite layer comprises about 50 wt % to about 85 wt % zeolites.

117. The coated substrate according to claim 115, wherein the composite nanoparticles in the catalytic layer comprise a catalyst nanoparticle attached to a support nanoparticle.

118. The coated substrate according to claim 117, wherein the catalyst nanoparticle comprises a platinum group metal.

119. The coated substrate according to claim 117, wherein the catalyst nanoparticle comprises platinum and/or palladium.

120. The coated substrate of claim 118, wherein the catalyst nanoparticle comprises platinum and palladium at a ratio of 1:2 to 25:1 platinum to palladium.

121. The coated substrate of claim 117, wherein the support nanoparticle comprises a metal oxide.

122. The coated substrate of claim 117, wherein the support nanoparticle comprises aluminum oxide.

123. The coated substrate of claim 117, wherein the catalyst nanoparticle and the support nanoparticle are in a weight ratio of 10:90 to 60:40 catalyst nanoparticle to support nanoparticle.

124. The coated substrate of claim 115, wherein the catalytic layer comprises 0.25 g/L to 2 g/L platinum group metal.

125. The coated substrate of claim 115, wherein the PNA material comprises a platinum group metal attached to a micron sized support particle.

126. The coated substrate of claim 125, wherein the micron-sized support particle comprises ceria.

127. The coated substrate of claim 115, wherein the PNA material layer comprises an alkali oxide or an alkaline earth oxide.

128. The coated substrate of claim 115, wherein the PNA material layer comprises 0.5 g/L to 4 g/L platinum group metal.

129. A catalytic converter comprising the coated substrate according to claim 115.

130. An exhaust treatment system comprising a conduit for exhaust gas and a catalytic converter according to claim 129.
